(19) United States
(12) Patent Application Publication
(10) Pub. No.: US 2026/0087936 A1
(43) Pub. Date: Mar. 26, 2026

(54) DIALOGUE SYSTEM

(71) Applicant: Amrick Lal Marahta, Wokingham (GB)

(72) Inventors: Amrick Lal Marahta, Wokingham (GB); Michal Tarkowski, Gdynia (PL); Wajid Bin Aqeel, Lahore (PK); Marium Javaid Bajwa, Lahore (PK)

(21) Appl. No.: 19/216,343

(22) Filed: May 22, 2025

(30) Foreign Application Priority Data
May 23, 2024 (PK) 324/2024

(51) Int. Cl. G09B 5/06; G06F 16/3329; G06F 16/334

(52) U.S. Cl. CPC G09B 5/06; G06F 16/33295; G06F 16/3347

(57) ABSTRACT

A dialogue system, comprising:
an input, configured to receive input data from a user, wherein the input data comprises one or more of text data, speech data, image data and motion data; an output, configured to output data to the user; and one or more processors, configured to:
   obtain information identifying a skill and obtain information identifying a proficiency level of the user for the identified skill from stored proficiency level information; and execute at least one iteration of a coaching session, each iteration comprising performing one or more dialogue interactions, wherein each dialogue interaction comprises:
      receiving first input data from the user via the input;
      generating a first language model prompt and providing the first language model prompt to a language model, said first language model prompt comprising the first input data, the information identifying a skill, the information identifying a proficiency level of the user for the identified skill and a request to generate coaching information based on the first input data, the information identifying a skill and the information identifying a proficiency level; and generating first output data based on a first language model response to the first language model prompt and outputting, via the output, the first output data to the user;
wherein the at least one iteration of the coaching session further comprises, after the one or more dialogue interactions:
   generating a second language model prompt and providing the second language model prompt to the language model, said second language model prompt comprising the information identifying a skill, the information identifying a proficiency level of the user for the identified skill, the first input data and the first output data, and a request to generate at least one proficiency update assessment based on the first input data, the first output data, the identified skill and the information identifying a proficiency level; generating second output data based on a second language model response to the second language model prompt and outputting, via the output, the second output data to the user; receiving second input data from the user via the input; determining a revised proficiency level of the user for the identified skill based on the second input data; and
      updating the stored proficiency level information based on the revised proficiency level.

### TECHNICAL FIELD

The present application relates to a dialogue system and a dialogue method. In some examples, the dialogue system presents questions and learning content, assesses the responses provided by the user and presents tailored further questions and content based on the assessment.

### BACKGROUND

Computer implemented dialogue systems can provide a conversational user interface and can allow a user to accomplish various tasks or goals. Such dialogue systems, for example chatbots or voice-based agents, are used in many applications. A dialogue system may comprise a rule based system or may comprise a trained model for example, used to select or generate each system response in a dialogue with a user.

There is a continuing need to improve the process of analysing a user input and selecting or generating an appropriate system response to accomplish a goal. In particular, by more accurately analysing the user response, and selecting or generating a system response that better reflects the context of the dialogue, a more appropriate system response may be provided. As a result, a system goal may be accomplished in fewer interactions with the user.

### BRIEF DESCRIPTION OF THE DRAWINGS

Embodiments will now be described by way of example with reference to the accompanying drawings.

FIG. 1 is a schematic illustration of a system implementing the dialogue system of embodiments herein.

FIG. 2A is an flowchart illustrating an example dialogue method.

FIG. 2B is an flowchart illustrating an example dialogue method

FIG. 3A is a schematic illustration of a language model interface.

FIG. 3B is a schematic illustration of an example first language model.

FIG. 3C is a schematic illustration of an example second model.

FIG. 3D is an example encoder model structure.

FIG. 4 is a schematic illustration of a digital coach module including one or more task modules.

FIG. 5 is a schematic diagram illustrating the process of a curriculum acquisition module.

FIG. 6 is a schematic diagram illustrating a process of a topic content management module.

FIG. 7 is a schematic diagram illustrating a process of a content generation module.

FIG. 8 is a flowchart illustrating a document retrieval process.

FIG. 9 schematically illustrates an example computing system.

### SUMMARY OF INVENTION

Various aspects and embodiments are set out in the appended claims.

In one aspect there is provided a dialogue system, comprising:
an input, configured to receive input data from a user, wherein the input data comprises one or more of text data, speech data, image data and motion data;
an output, configured to output data to the user; and one or more processors, configured to:
   obtain information identifying a skill and obtain information identifying a proficiency level of the user for the identified skill from stored proficiency level information; and
   execute at least one iteration of a coaching session, each iteration comprising performing one or more dialogue interactions, wherein each dialogue interaction comprises:
      receiving first input data from the user via the input;
      generating a first language model prompt and providing the first language model prompt to a language model, said first language model prompt comprising the first input data, the information identifying a skill, the information identifying a proficiency level of the user for the identified skill and a request to generate coaching information based on the first input data, the information identifying a skill and the information identifying a proficiency level; and
      generating first output data based on a first language model response to the first language model prompt and outputting, via the output, the first output data to the user;
wherein the at least one iteration of the coaching session further comprises, after the one or more dialogue interactions:
   generating a second language model prompt and providing the second language model prompt to the language model, said second language model prompt comprising the information identifying a skill, the information identifying a proficiency level of the user for the identified skill, the first input data and the first output data, and a request to generate at least one proficiency update assessment based on the first input data, the first output data, the identified skill and the information identifying a proficiency level;
   generating second output data based on a second language model response to the second language model prompt and outputting, via the output, the second output data to the user;
   receiving second input data from the user via the input;
   determining a revised proficiency level of the user for the identified skill based on the second input data; and
   updating the stored proficiency level information based on the revised proficiency level.

In some embodiments, the at least one proficiency update assessment includes at least one proficiency update question and a template response for each proficiency update question, and wherein determining the revised proficiency level of the user comprises analysing the second input data, the analysing comprising:
determining, from the second input data, a user response to each proficiency update question; and
performing a similarity measurement between the user response to each proficiency update question and the template response for the respective proficiency update question.

In some embodiments, performing the similarity measurement comprises generating a third language model prompt and providing the third language model prompt to a language model, the third language model prompt comprising the user response to a proficiency update question, the template response for the proficiency update question and a request that a similarity measurement be performed for the user response and the template response. In some embodiments, the determining the revised proficiency level of the user is based on a current proficiency level of the user and a skill proficiency update model, wherein one or more parameters of the skill proficiency update model are determined based on the result of the similarity measurement.

In some embodiments, the at least one proficiency update assessment includes at least one proficiency update question and a template response for each proficiency update question;
wherein the determining the revised proficiency level of the user comprises analysing the second input data, the analysing comprising determining, from the second input data, a user response to each proficiency update question; and
wherein the determining the revised proficiency level of the user comprises applying a skill proficiency update model based on a current proficiency level of the user, at least one user response to a respective proficiency update question, and one or more parameters of the skill proficiency update model.

In some embodiments, the one or more parameters of the skill proficiency update model are identified from a stored user information record.

In some embodiments, the skill proficiency update model is a Bayesian Knowledge Tracing model and wherein the one or more parameters are Bayesian Knowledge Tracing model parameters.

In some embodiments, the one or more processors are further configured to:
perform a similarity measurement between the user response to each proficiency update question and a template response for the respective proficiency update question; and
adjust the one or more parameters of the Bayesian Knowledge Tracing model based on the result of the similarity measurement.

In some embodiments, the second language model prompt further comprises a request to generate at least one template response for each proficiency update question
wherein the determining a revised proficiency level of the user comprises analysing the second input data, the analysing comprising generating a fourth language model prompt and providing the fourth language model prompt to the language model, the fourth language model prompt including the information identifying a proficiency level of the user for the identified skill, the second input data, a definition of a statistical model including parameters of the statistical model, and a request to generate a revised proficiency level based on the second input data and the statistical model.

In some embodiments, obtaining the information identifying a proficiency level of the user from stored proficiency level information comprises performing one or more testing processes, wherein each testing process comprises:
identifying a current proficiency level of the user from the stored proficiency level information, wherein the stored proficiency level information is stored in a database;
selecting one or more questions from a plurality of questions stored in the database based on the information identifying a skill and the current proficiency level;
outputting, via the output, the one or more questions to the user;
receiving, via the input, a response to the one or more questions from the user;
analysing the response to determine an updated proficiency level of the user; updating the stored proficiency level information based on the updated proficiency level; and
obtaining the information identifying a proficiency level of the user for the identified skill from the updated stored proficiency level information.

In some embodiments, the analysing the response to determine an updated proficiency level of the user comprises performing Bayesian inference to determine an updated proficiency of the user based on an initial probability distribution for the proficiency of the user and a probability of the user providing the response to the one or more questions, wherein the probability of the user providing the response one or more questions is modelled as a logistic function of the probability of the user having a skill proficiency level providing a response that corresponding to a template response to the one or more questions, the template response being stored in the database.

In some embodiments, the analysing of the response to determine an updated proficiency level of the user comprises applying Bayesian Knowledge Tracing to the current proficiency level determine the updated user proficiency level.

In some embodiments, the coaching session further comprises outputting one or more resources to the user during the coaching session.

In some embodiments, the first language model prompt further comprises a text resource for the identified skill and a request that the coaching information be based on the resource.

In some embodiments, in a dialogue interaction further comprises generating vector embeddings from the first input data;
performing a similarity measurement between the vector embeddings and each of a plurality of stored vector embeddings, wherein each stored vector embedding corresponds to a resource;
selecting a stored vector embedding based on the similarity score and retrieving the resource corresponding to the selected stored vector embedding, wherein the retrieved resource is the text resource.

In some embodiments, the one or more processors are further configured to:
generate a fifth language model prompt and provide the fifth language model prompt to the language model, the fifth language model prompt including a request that the one or more resources be generated; create the one or more resources from a fifth language model response to the fifth language model prompt and storing the one or more resources in a database.

In some embodiments, the one more processors are further configured to determine, from the stored proficiency level information, whether the proficiency level of the user meets a first criterion, and, responsive to determining that the proficiency level of the user meets the first criterion:
output an notification to the user that the resource has been generated;
receive from the user an updated version of the resource; and
store the updated resource in the database.

In some embodiments, the one more processors are further configured to determine, from the stored proficiency level information, whether the proficiency level of the user meets a second criterion, and, responsive to determining that the user proficiency level of the user meets the second criterion:
output a notification that the resource has been generated; and
receive, from the user, validation information for the resource.

In some embodiments, the one more processors are further configured to:
calculate a validation score from validation information received from the user and one or more other users; and
in response to the validation score meeting a validation criterion, authorising the at least one resource for use in a coaching session.

In another aspect there is provided a computer-implemented dialogue method, the method comprising:
obtaining information identifying a skill and obtain information identifying a proficiency level of the user for the identified skill from stored proficiency level information; and
executing at least one iteration of a coaching session, each iteration comprising performing one or more dialogue interactions, wherein each dialogue interaction comprises:
   receiving first input data from the user via an input, wherein the input data comprises one or more of text data, speech data, image data and motion data;
   generating a first language model prompt and providing the first language model prompt to a language model, said first language model prompt comprising the first input data, the information identifying a skill, the information identifying a proficiency level of the user for the identified skill and a request to generate coaching information based on the first input data, the information identifying a skill and the information identifying a proficiency level; and
   generating first output data based on a first language model response to the first language model prompt and outputting, via an output, the first output data to the user;
wherein the at least one iteration of the coaching session further comprises, after the one or more dialogue interactions:
   generating a second language model prompt and providing the second language model prompt to the language model, said second language model prompt comprising the information identifying a skill, the information identifying a proficiency level of the user for the identified skill, the first input data and the first output data, and a request to generate at least one proficiency update assessment based on the first input data, the first output data, the identified skill and the information identifying a proficiency level;
   generating second output data based on a second language model response to the second language model prompt and outputting, via the output, the second output data to the user;
   receiving second input data from the user via the input;
   determining a revised proficiency level of the user for the identified skill based on the second input data; and
   updating the stored proficiency level information based on the revised proficiency level.

In a further aspect there is provided a computer program comprising instructions that, when executed by one or more processors, cause the one or more processors to perform the method above.

In a further aspect there is provided a non-transitory computer readable storage medium comprising computer readable code configured to cause a computer to perform the method above.

In further aspect, there is provided a dialogue system, comprising:
an input, configured to receive input data from a user, wherein the input data comprises one or more of text data, speech data, image data and motion data;
an output, configured to output data to the user; and
one or more processors, configured to:
   obtain information identifying a skill and obtain information identifying a proficiency level of the user for the identified skill from stored proficiency level information; and
   execute a plurality of iterations of a coaching session, each iteration comprising performing one or more dialogue interactions, wherein each dialogue interaction comprises:
      receiving first input data from the user via the input;
      generating a first language model prompt and providing the first language model prompt to a language model, said first language model prompt comprising the first input data, the information identifying a skill, the information identifying a proficiency level of the user for the identified skill and a request to generate coaching information based on the first input data, the information identifying a skill and the information identifying a proficiency level; and
      generating first output data based on a first language model response to the first language model prompt and outputting, via the output, the first output data to the user;
   wherein each iteration of the coaching session further comprises, after the one or more dialogue interactions:
      generating a second language model prompt and providing the second language model prompt to the language model, said second language model prompt comprising the information identifying a skill, the information identifying a proficiency level of the user for the identified skill, and a request to generate at least one proficiency update assessment based on the identified skill and the information identifying a proficiency level;
      generating second output data based on a second language model response to the second language model prompt and outputting, via the output, the second output data to the user;
      receiving second input data from the user via the input;
      determining a revised proficiency level of the user for the identified skill based on the second input data; and
      updating the stored proficiency level information based on the revised proficiency level.

The dialogue system may provide a dynamic interactive coaching session (also referred to as a ‘learning session’) that adapts to a user's improving skill over time. The dialogue system may be able to produce content relevant to a user at a level of complexity appropriate to a user's skill level that, over time, can adapt in complexity alongside a user's changing skill. The system may deploy language models (such as transformer-based large language models) in an optimised manner to provide both higher accuracy in natural language processing (NLP) and higher efficiency in utilisation of hardware resources (e.g. reduced latency, reducing required processing power).

The dialogue system may be used to accomplish a goal of learning a skill. For example, the dialogue system may be queried by the user to provide learning materials related to a skill, to explain skill-related concepts and terminology when asked by the user, and/or to provide questions to the user to allow the user to test their understanding of topics or content related to the skill during the learning session. The dialogue system may use one or more trained algorithms to analyse on-going interactions with the user to generate and/or retrieve personalised questions and resources related to the skill to be learned. The dialogue system receives the responses of the user to the personalised questions and revises the estimated skill proficiency of the user. The revised skill proficiency of the user is then used to tailor subsequent interactions within the dialogue session. As such, improved performance toward the learning goal is provided, for example resulting in reaching of the learning goal with a reduced number of dialogue interactions or turns.

NLP is a computing task with the goal of understanding natural language text. NLP may also allow generating new natural language text in a human-like manner. More accurate NLP models may more accurately capture nuance and context in a block of text to more accurately represent the intended meaning of the text. Through accurate text understanding, the computer system implementing NLP is not only able to extract information from input text more accurately, but may also classify and characterise the text. NLP models may also be used for text generation to generate content that is not only understandable to a human reader, but is presented in a required context. A language model may comprise a computerised model that represents natural language in a statistical or probabilistic manner. There are multiple ways to implement a language model, including neural networks, Hidden Markov models, and maximum entropy models.

Large Language Models (LLMs) are an example of a language model that is suited to NLP tasks. An LLM is implemented through Artificial Intelligence programs employing neural networks. A powerful form of LLM is a transformer-based language model, which may process input text, tokenise the input text into tokens (which may be words or fragments of words) and generate vectors representing the relationships between each token within the subject sentence. These vectors (called “embeddings”) may be generated for each token, and represent statistical dependencies between text fragments (including words) within a text. A transformer model may be trained to recognise the statistical dependencies by observing large amounts of human-written text, such as books, websites, online encyclopaedias or human text-based interactions. Using a transformer model for language modelling may be more powerful than alternative systems such as recurrent neural network models (including the Long Short-Term Memory, or LSTM, neural network) due to the utilisation of attention mechanisms. Attention mechanisms may allow context to be derived for each token at any point in the input sequence, with respect to the entire sequence. Each token in the sentence may also be processed independently. As such, a well-trained transformer model can provide a more accurate context for each token within the input text (producing more accurate NLP results), as well being highly parallelizable (resulting in faster training times).

Through the use of language models such as transformer-based LLMs, the embodiments described herein may provide more effective online learning sessions. For example, by using transformer models the answers of a user may be provided within a much wider context that enables the generation of questions that are more targeted toward the user's interactions with the LLM, based on free-form text answers, and thus provide a more accurate assessment of any changing skill level of the user and thus generate targeted questions to accurately assess that change in skill level. This allows for a focused assessment during the digital coaching session that can quickly and accurately track the user's change in skill with minimal interruption to the user's learning experience. This expands the range of skill assessment options available for the user.

Furthermore, transformer-based LLMs can provide generative Artificial Intelligence. This means that some transformer-based LLMs may be used to generate additional content independently. As such, additional learning resources may be dynamically generated that is specifically targeted toward the user of the system to address any skills gap that may be present at any particular point in time.

### DETAILED DESCRIPTION

A variety of skilled roles exist in the modern workplace that demand high levels of knowledge and skill in complex tasks. This may include knowledge and competence in written and spoken language as well as expertise in engineering and scientific principles. Individuals are invested in improving the knowledge and skillset of themselves as well as other individuals that they employ, or are otherwise within their responsibility. However, in order to effect improvement one must first identify existing skills and knowledge, gaps in that knowledge, and appropriate tools and resources to help address those gaps to advance personal and career development.

In order to assess current competence and provide quantitative feedback, individuals may undertake assessments, either of another individual's skills and knowledge, or their own skills and knowledge. This may include critical assessment of written work, the setting and marking of examinations or quizzes, or assessment of questions and answers during person-to-person or person-to-machine interactions. However, such assessments are time-consuming, may be unreliable, and may be inconsistent in terms of results. Traditional learning systems are also incapable or slow to adapt to a user's change in skill level, requiring the user to perform significant personal research to identify resources and content that accurately tracks that person's developing skill level.

There is a need for an automated knowledge and skill assessment platform that is capable of accurately assessing the abilities of a user and providing feedback and recommendations to improve those abilities.

Embodiments described herein may provide a platform, in the form of a dialogue system, for the performance of tasks to aid a user in knowledge discovery and digital learning sessions. Various different implementations of the dialogue system are described below, alongside tasks to be performed by the dialogue system.

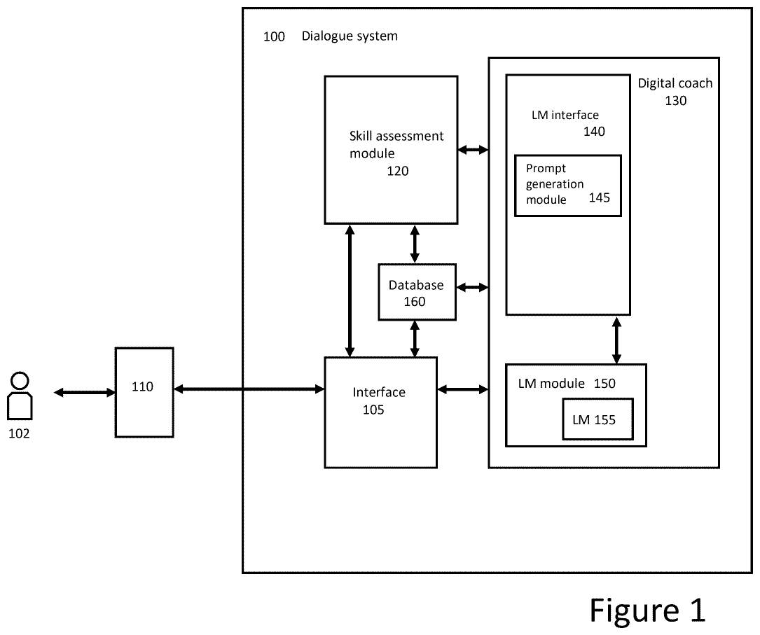

FIG. 1 illustrates a system 100 comprising a user device 110 and a dialogue system 100 in accordance with an embodiment. FIG. 1 illustrates some functional components of the dialogue system 100, including an interface module 105, a skill assessment module 120, and a digital coach module 130. The digital coach module 130 includes additional components, including an LM interface 140 and a prompt engineering module 145 (which may also be referred to as a prompt generation module 145). As depicted in FIG. 1, the prompt engineering module 145 may form part of the LM interface 140, but in other examples the prompt engineering module 145 is a separate component to the LM interface 140. The dialogue system further comprises a Language Model (LM) module 150 and a database 160. The LM module 150 comprises one or more language models 155, such as a Large Language Model (LLM).

Each of the interface module 105, skill assessment module 120, and digital coach module 130 may be represented in the form of interchangeable physical hardware, may be physically separate to each other and from other components of the dialogue system 100, and include one or more processors that execute program instructions to perform required tasks. Alternatively, each module may represent a software module that is executed by the same core processor/processors of a single component. The steps taken by module described herein may be embodied in the form of computer-executable instructions that are performed when executed by a processor of a computing device. Each module may access or write to a database. These may be separate databases maintained for use by each module, or may refer to the same database (e.g. database 160).

In this example, the dialogue system 100 is a server, and the user device 110 is configured to receive speech and/or text from a user 102. The dialogue system 100 receives input data from the user device 110, via the interface module 105, and provides output data to the user device 110, via the interface module 105. The input data may be text data or speech data (such as recorded by a microphone of the user device). The input data may also include image/visual data (e.g. such as a photo, video or image data from a camera of the user device), historical data and/or motion data (such as from a motion sensor on the user device to track an object, such as the user's hands, eyes or other body part), where historical data can include previously submitted input data of any type, received output data or any type or other form of information received by the user from the dialogue system 100. The input data may be processed by the dialogue system 100 to enable the user to interact with the components of the dialogue system (e.g. through speech-to-text recognition processes, or by the motion being processed to recognise a user input, such as text input via eye gaze direction). The output data may include text data, audio data and/or visual data. The dialogue system 100 may communicate with the user device 110 over a communication network such as the Internet. In other examples however, the dialogue system 100 is a user device that provides outputs and receives inputs directly from the user 102. The user device 110 may execute a user interface with text input or with voice recognition software. The user device 110 may be a mobile device, desktop computer or other electronic device.

In this example, each of the skill assessment module 120, digital coach 130 and interface 105 are provided on the same server of the dialogue system 100. In other examples, each of the skill assessment module 120, digital coach 130 and interface 105 are located on a separate server and configured to communicate with each other over a communication network such as the Internet. The LM module 150 may form part of the digital coach module 130, but in alternative examples the LM module 150 may be remote from the digital coach module 130 and the digital coach module 130 is configured to communicate with the LM module 150. The database 160 may be located on the server of the dialogue system 100, but alternatively may be located remotely from the dialogue system 100 and accessible over a communication network such as the Internet.

The dialogue system 100 is configured to assist users in developing expertise in one or more skills. Each skill may be defined by one or more ‘topics’ about which knowledge is required for understanding the skill. For example, in computer programming, a skill may be “the C++ programming language”, and topics may include items such as “Classes and Objects; Functions; Pointers; Exception Handling; Multithreading”. The dialogue system functions to respond to user queries in a dynamic manner, providing chat-like responses, displaying learning resources to the user, and presenting assessments to assess the user's knowledge. The user responses to the assessments are analysed by the dialogue system 100 to guide the dialogue system 100 in future interactions with the user, including the responses to user queries and further assessment. The dialogue system 100 may also display additional, non-graded assessments only as part of the digital coaching process to aid the user's understanding.

The skill assessment module 120 is a component of the dialogue system 100 configured to estimate the skill level of the user in a selected skill through interactions with the user in a skill assessment process. The skill assessment process comprises presenting questions (for example, Multiple Choice Questions (MCQs)) to the user and receiving responses from the user and analysing the answers using one or more statistical methods to estimate the user skill level, such as logistic models and Bayesian Knowledge Tracing (BKT), to be described later. The output skill level estimation may be stored in the database 160 for later use, or may be provided directly to the prompt engineering module 145 for use in guiding user interactions with the digital coach, through creation of custom prompts to the LM module 150.

The digital coach module 130 is a component of the dialogue system 100 configured to establish and execute a coaching session for the user 102, by receiving information from the interface and utilizing components of the digital coach module 130, including the LM interface 140. The digital coach 130 references a repository or database of learning materials, including learning resources (articles, videos, etc.) and questions with associated answers. In a digital learning session, the user queries the digital coach module 130 to review learning resources, and request or be provided testing on the learning resources or other subject-matter related to the topic. The learning materials may be stored in database 160. The learning materials may be presented to the user during the digital coaching session according to a skill curriculum, specifying a plurality of topics associated with a selected skill, with recommended material and questions with answers. During the coaching session, the digital coach module 130 functions as a central conduit or hub through which communication with the user is processed. The digital coach also includes real-time chatbot functionality, provided by querying an language model such as an LLM. The LLM-based chatbot is configured to provide dialogue with the user that caters to the user proficiency (e.g. beginner, intermediate, and expert), and the specific topic the user is presently learning. Functioning as a coach aligned with the predefined criteria, it addresses user queries on a designated topic and provides explanations akin to how a tutor guides a student. Users can pose questions related to their skill quest and engage in meaningful conversations.

For example, a user may wish to learn the skill “Calculus”, which can include topics such as “Integration” and “Differentiation”. The user may engage with the digital coach module 130 to learn each topic. The digital coach module may present learning materials to the user in relation to the topic, such as an article explaining the definition of the Taylor expansion and its use in series approximation. To seek clarification on the subject-matter of the topic, the user may engage with the chatbot to ask questions. For example, the user may ask: “Please provide a derivation for the Taylor expansion”, or “what is the chain rule?”. The digital coach module 130 would respond, via a query to the LLM, with a generated text response to the question. When querying the LM, the digital coach includes context information regarding the user that allows the response to be tailored to the user's needs. For example, the LM query may identify that the user is “Beginner” in Differentiation, but “Intermediate” in “polynomials”, allowing for the generated text to be tailored to a level of understanding of the user. The skill level of the user is dynamically adjusted as the user engages with more content, ensuring that the LLM responses evolve as the skill of the user evolves.

The LM interface 140 functions as an interface between the digital coach 130 and the LM module 150, allowing the digital coach to leverage the functionality of a language model 155 (e.g. an LLM) when conducting a digital learning session/digital coaching session. The interface is achieved through the use of the prompt engineering module 145, which is configured to generate custom prompts to be provided to the LM module 150. The custom prompts are created from queries provided to the digital coach 130 from the user, where additional information is added to the query to provide additional context to frame responses to the queries that are tailored to the current skill level of the user. As such, the learning content provided by the digital coach is tailored for the user and thus minimising the number of LLM queries required and maximising the efficiency of the learning process.

For example, the prompt engineering module 145 may retrieve a prompt template from a database of prompts, where the prompt template includes fields to be populated with information. The prompt engineering module populates the fields with text from the user query, together with information of the skill level of the user from the skill assessment module 120. As such, the prompt given to the LM module is tailored to the user to include information identifying a skill the user wishes to learn and a current skill level of the user in that skill, thereby improving the relevance of the response.

Interface module 105 is configured to communicate with the user device 110, the skill assessment module 120 and the digital coach module 130. The interface module may function as a launch pad or hub for the dialogue system to allow a user to specify a skill to be learned or to access feedback metrics, including information relating to the progress of a user in a learning pathway. The interface 105 may also communicate with the database 160 to retrieve feedback information for presentation to the user. The interface 105 also allows the user to choose between performing a skill assessment at the skill assessment module or engaging with a digital learning session at the digital coach. At the interface 105 the user may modify elements of their learning requirements, including selecting changes to a recommended learning pathway or curriculum.

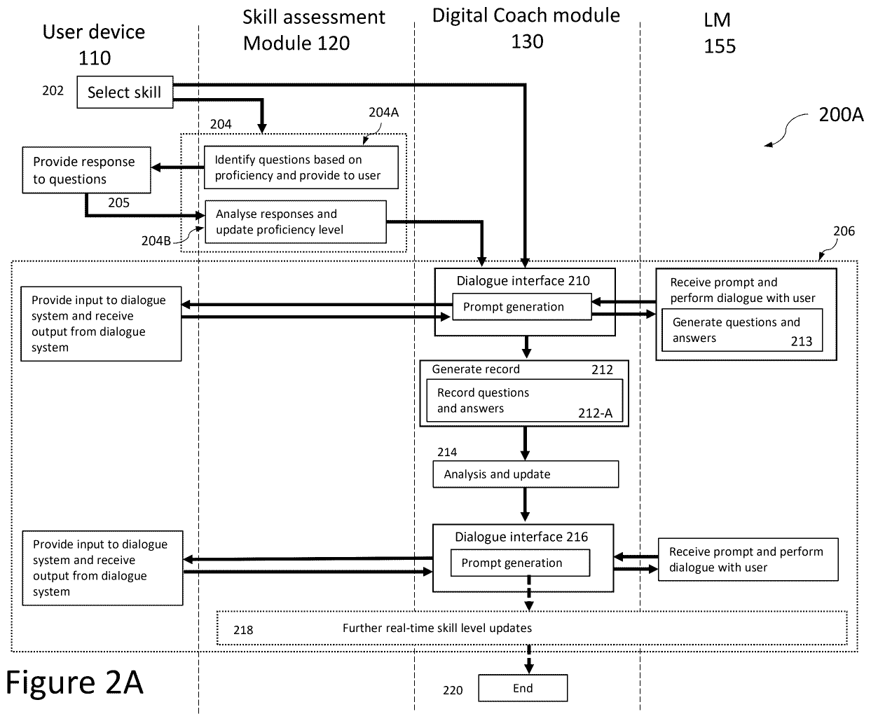

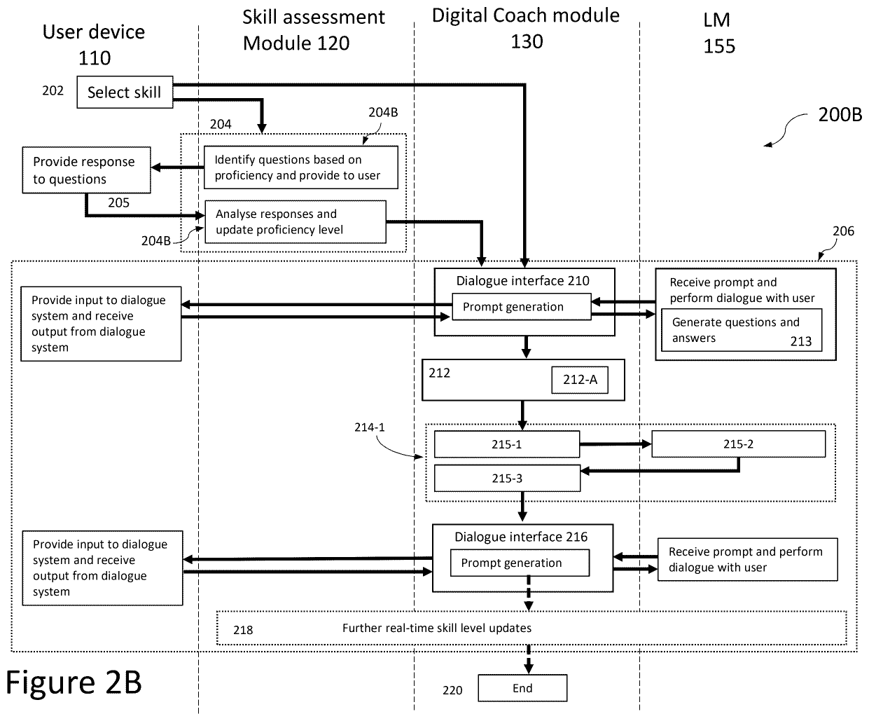

FIG. 2A illustrates a dialogue method 200A in accordance with an embodiment. The method shown in FIG. 2A comprises steps performed a user device 110, steps performed by the skill assessment module 120, steps performed by the digital coach module 130 and steps performed by the language model 155. The method of FIG. 2A may be performed by a dialogue system 100 such as that described in relation to FIG. 1. The method 200A may be performed to include a coaching session, where each coaching session is provided to assist a user with learning a single skill. The coaching session includes multiple iterations, wherein within each iteration the user 102 engages in one or more dialogue interactions with the LLM 155 and the user is presented with assessment questions for real-time skill level updates during the coaching session.

In some embodiments, the dialogue method 200A may be initiated by the dialogue system 100 by listing available skills to be learned and presenting the list to the user. For example, the skill list may be a list that is maintained to include all the skills for which topics and content is available for access by the digital coach module 130, and for which assessments are available at the skill assessment module 120. The skill list may be maintained by a data record on the database 160 that forms part of the dialogue system 100 or is external to the dialogue system 100. In these embodiments, at step 202, the user is presented with the option, via an input to the user device 110, to select a skill. The selected skill thereafter forms the subject of the dialogue method 200A and digital coaching session. As an alternative to the user being provided with a list of skills and selecting from the list, a skill may be automatically selected for the user by the dialogue system. For example, if a skill exists as part of a structured training pathway for the user (e.g. a specified list of skills in a given order), the dialogue system 100 may review user profile data, determine the user's location on the structure training pathway, and automatically select the skill currently being learned or the next skill to be learned on the pathway.

After selecting the skill, the user may either attempt a skill assessment or execute a digital coaching session for the skill. In some embodiments, the user is presented with the choice to attempt the skill assessment or execute the digital coaching session, but alternatively one option may be automatically selected for the user. For example, if the dialogue system 100 has determined that the time since the user's last skill assessment has exceeded a pre-set threshold, the user may be required to attempt a skill assessment, or a skill assessment option may be recommended. In another example, if the user has recently attempted a skill assessment, the dialogue system 100 may default to selecting a digital coaching session, or a digital coaching session may be recommended.

If it is determined that the user is to attempt a skill assessment, the dialogue method proceeds to perform skill assessment operation 204 at the skill assessment module 120. Skill assessment operation 204 comprises identification step 204A, in which an assessment is identified based on the user's proficiency in the skill and the assessment is output to the user via an output of the user device 110 (for example, proficiency update questions are identified and output to the user). To perform step 204A, the skill assessment module 120 may identify a current proficiency level of the user, which may include communicating with database 160 to obtain information indicating the proficiency level of the user for the selected skill. For example, the database may store a user record including information about the user including the proficiency level. The proficiency level may be a proficiency level stored in the database at the conclusion of a previous skill assessment session and indicates the current skill level of the user as known to the skill assessment module 120. The proficiency level information may include a proficiency level score in addition to a proficiency level category/classification corresponding to the score. Step 204A may also include retrieving assessments from the database that have been identified as assessments associated with a particular skill level or range of skill levels.

In response to being presented with the identified assessments, the user 102 provides a response to the assessments at step 205. The responses of the user 102 are returned to the skill assessment module 120.

Skill assessment operation 204 further comprises, at step 204B, analysing the responses provided by the user 102 and, based on the analysis, generating an updated proficiency level of the user. The analysis may be performed using one or more statistical methods, to be described below. The skill assessment module 204 may update the user record of the user to update the information identifying the proficiency level of the user with information identifying the revised proficiency level of the user 102.

In some examples, the database might not contain a user record associated with the user 102, or the user profile may not include any information identifying the proficiency level of the user. In these examples, the current proficiency level of the user is identified as “unknown”, and the skill assessment module 120 is configured to retrieve a set of initialization assessments form database 160 to perform an initial estimation of the skill level of the user.

In embodiments described herein, the skill assessment module 120 is configured to present assessments and analyse answers for different forms of assessments in order to generate user response data in a Boolean format that indicates whether the user has successfully completed the assessment (e.g. answered a question correctly) or not (e.g. “1” indicates the user has accurately completed the assessment, and “0” indicates the user has not accurately completed the assessment).

The assessments may take different forms. In some embodiments, an assessment may be a question to be answered. In one example, the questions include Multiple Choice Questions (MCQs), where to answer the user selects an answer from a plurality of possible answers. In another example, the questions are True or False questions, where the user answers either True or False in response to the question. In another example, the questions are “Fill-in-the-Blanks” questions, in which the question includes a block of text (including prose and equations) with missing parts as blank spaces. The user answers the question by selecting one or more items from a list of options to fill in one or more of the blanks. The answer assessment for this example may be performed for the entire block of text or for portions or fragments of the text (e.g. on the sentence level). In another example, the user is presented with a question with an invitation to type an answer into an answer field. The skill assessment module 120 is further configured to compare the typed answer string to a string corresponding to the correct answer (for example, in a test requesting an exact numerical response to a mathematics question). In some examples, MCQs, True-or-False or Fill-in-the-Gap questions may be answered by a user typing in one of the provided options and a string comparison process is performed. Alternative assessments may be provided in which it may be determined if the user has correctly/accurately completed the assessment. For example, the assessment may take the form of a skill-based task such as a logic exercise, or may take the form of a translation task. The responses to the assessments may be analysed to generate Boolean data as described above. Examples herein are discussed in the context of questions and answers, but it is understood that other forms of assessment may equally be implemented.

Performing the initial estimation of the skill level may include executing an initial proficiency finding session, to generate an initial user proficiency level. In the proficiency finding session, the skill assessment module 120 functions as described above in connection with a proficiency level update. However, instead of identifying a plurality of assessment questions based on the user proficiency level, the skill assessment module 120 instead identifies a plurality of initialisation questions for the selected skill. The plurality of initialisation questions may include a plurality of assessment questions having a range of difficulty levels. The plurality of initialisation questions may include a plurality of questions for each of a plurality of topics across a range of difficulty levels. The initialisation questions may be specified in a pre-determined list of questions, specified by validators of the dialogue system. Alternatively, the initialisation questions may include a plurality of assessment questions in a single category, such as a “beginner” category.

The skill assessment module 120 may provide each initialisation question in an order and updates an initial user proficiency score as the answer to each question is evaluated. The user proficiency score may be calculated using the methods described above. After all the questions have been asked, the initial user proficiency level is finalised and stored in a user record as the user proficiency level for the selected skill, and is also optionally output to the user as feedback. In some embodiments, the assessment questions are not asked in a particular order, but a may be selected from the list of initialization questions based on the performance of the user to the initialization questions asked thus far. For example, BKT may be utilized to dynamically select questions to arrive at an approximate user skill level more quickly. Once the initial skill level has been set, the skill assessment module 120 can proceed as previously described to perform one or more additional assessments with the initial skill level as the skill proficiency level used to select the assessment questions.

In alternative embodiments, when a proficiency level for a skill is not present (e.g. the user is a new user), the skill assessment module 120 assigns a default skill level (e.g. “beginner” skill level), stores that skill level in the data record and initiates the digital coaching session using the newly stored user proficiency level.

After completion of the skill assessment operation 204, the user may then proceed to execute a digital coaching session 206. To initiate the digital coaching session 206, the dialogue method 200A may initiate a dialogue interface at step 210. When initiated, the user is able to engage in interactions with the digital coach module 130, and receive coaching information from the digital coach module. For example, an interface window is presented on the user device 110 allowing the user to enter and receive information from the digital coach (text, images, documents, audio, etc.). Thus, through the variety of information that may be included in the digital coach information, the digital coach module 130 is able to support a plurality of learning modalities in which the user may be coached in the selected skill through different media and types of content suited to the learning task.

If it is determined, after operation 202, that the user is to proceed directly to a digital coaching session 206 and not attempt a skill assessment, the dialogue method 200A may proceed directly from step 202 to initiate a dialogue interface at step 210.

During execution of the dialogue interface 210, the digital coach 130 facilitates a dialogue session between the user 102 and the LM 155, where from the perspective of the user, inputs can be provided at the user device 110 and responses are received from the digital coach module 130. The responses are based on outputs of the LM 155, and are provided to the user 102 via the output of the user interface 110. The digital coach module 130 processes each interaction between the user and the LM 155 via the LM interface 140, which includes generating prompts for the LM 155 using the prompt engineering module 145. The prompt engineering module 145 generates a custom language model prompt for the user input (e.g. a request for a response to text presented by a user), incorporating information regarding the proficiency level of the user. The proficiency level of the user may be obtained from the database 160 by the prompt engineering module 145, or may be provided to the prompt engineering module by the skill assessment module 120 at the conclusion of a skill estimation process 204 in preparation for the digital coaching session 206. Each custom prompt generated by the prompt engineering module is a request for generation of coaching information that is tailored to the skill being used, the user's proficiency in the skill. The prompt may also include additional information to contextualise the request for coaching information, as described below.

During a digital coaching session 206, the user may be presented with a variety of content relevant to the skill that they are learning, and having a difficulty level that corresponds to the skill level of the user. This content includes custom text free-generated by the generative LM 155, but may also include pre-generated resources or questions and answers retrieved from a database (e.g. database 160). The resources and questions/answers are flagged as related to the skill and/or topic and being at an appropriate skill level. The resources and questions/answers may be content previously generated by the LM, and/or may be content that has been validated by subject-matter experts in a manner to be detailed below.

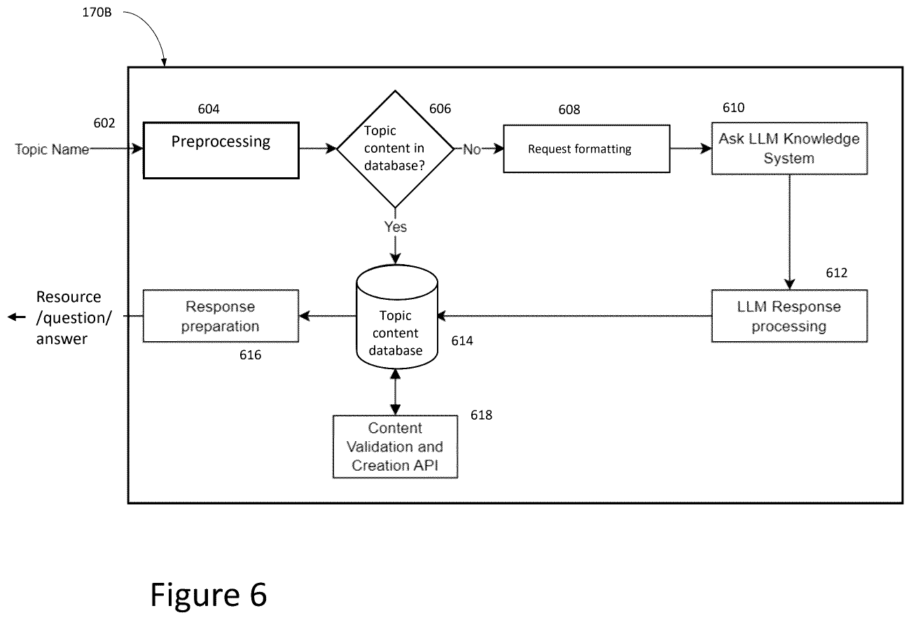

Every input from the user device 110 and every output to the user device 110 may be recorded by the digital coach module 130, which generates an interaction record, containing the inputs and outputs, at step 212. In step 214, the interaction information is analysed to determine an updated proficiency level of the user for the selected skill. In some embodiments, the method 200A includes the generation of assessments and model responses (e.g. questions and model answers) by the LM module 150 at step 213. The method 200A further includes the output of the assessment questions to the user 102, and the receipt at the LM module 150 of answers to the assessment questions from the user 102. These questions may be generated as part of the dialogue session between the user 102 and LM, or alternatively the LM may be tasked by the digital coach module 130 to generate the assessment questions and model answers, through providing the LM module 150 (and thus LM 155) with a custom prompt generated by the prompt generation module 145. The assessments and model responses may be generated by the digital coach module 130 providing an input to topic content management module 170B (described below in connection with FIG. 6).

The prompt to request the LM 155 generate the assessment questions and model answers/responses comprises the information identifying the skill to be learned and the skill proficiency level of the user and the request is to generate the questions based on the current skill level of the user. Thus, the generated questions are tailored specifically to the user's skill level. The prompt may further comprise the current data record 212, and the request that the assessment questions and model answers be generated includes a request that the questions and model answers be generated based on the content of the dialogue session. In some embodiments, the prompt to request questions be generated include question parameters retrieved from a database (such as logistic model parameters and BKT parameters, to be defined below) used to define question properties (e.g. difficulty). For example, the retrieved question parameters may be the parameters for a plurality of update questions stored for use by the skill assessment module 120. The assessments, model responses and user responses 212-A to the questions are then included in the record 212, or alternatively, the assessments, model responses and user responses 212-A may be maintained in a separate record to record 212.

The assessment questions may be generated and presented to the user at any point during the dialogue session. For example, the assessment questions may be presented to the user as a compulsory exercise during the digital coaching session in order for the session to continue, may be generated at the conclusion of study of a topic, or generated after a certain amount of time has been spent studying. The analysis and update step 214 may be triggered by the receipt of answers to a generated set of assessment questions, or may be triggered periodically and analysis performed on all assessment questions stored during the session 206 up until the trigger point. In some embodiments, the update is suspended until the dialogue session 206 is suspended by the user, at which point the update step 214 is performed in preparation of the resumption of the dialogue session 206 by the user.

As shown in the embodiment of FIG. 2A, the questions and answers recorded during the digital coaching session 206 may then be analysed to perform a dynamic skill proficiency update in step 214, according to one or more statistical models. In some examples, the dynamic skill proficiency update 214 may include analysis of user responses and model answers to determine a similarity score between the responses provided by the user and the model answer (e.g. cosine similarity score). The similarity score is then used in the analysis using the one or more statistical models. The similarity score may be determined by providing a language model prompt to the LM 155 with the answer of the user, the model answer, and a request that a cosine similarity be performed.

The updated skill proficiency level may be stored in the user record in the database 160. Following update of the proficiency level, a dialogue session continues as described before. For example, the digital coach module 130 can suspend the first dialogue session 210 during update 214, and can re-initiate a new dialogue interface 216 after the update. Alternatively, the dialogue interface 210 continues uninterrupted during update. However, in both cases, as soon as the skill proficiency level is updated, each subsequent prompt generated during the dialogue session is generated using the updated skill proficiency information (and thus dialogue interface 216 is a continuation of dialogue interface 210). Thus, the responses of the language model 155 being used can dynamically evolve as the user continues to interact with the language model 155 during the digital coaching session. Correspondingly, the digital coaching session 206 can dynamically adapt to the progress made by the user during the session to provide content and responses targeted to the updated skill level, without the need to interrupt the user to perform a further skill assessment process.

From the perspective of the user, the handover from the first dialogue session 210 to the second dialogue session 216 is not noticeable and is seamless, forming part of the same digital coaching session 206. The digital coach module 130 continues to generate interaction information records, including the generation of assessment questions and answers, and the dialogue system 100 can perform additional real-time skill level updates 218, each update as described above in step 214. The skill level may be dynamically updated multiple times during an interactive coaching session 206. The coaching session 206 continues until the end 220 of the session, initiated either by the user or the digital coach module 130.

While the content of the data record 212 is used to perform dynamic skill assessment updates as described above, the content can also be used to tailor the on-going dialogue between the user 102 and the LM 155. In these embodiments, content of the data record 212 may be included in each custom prompt given to the user. For example, the prompt may include a field: “The last <X> characters of the user-language model dialogue are: <Y>”, with <Y> being the dialogue text and <X> being the number of characters in the dialogue text. It will be understood that this prompt is an example only and alternative prompt templates may be used to provide the data record content. The use of the data record provides personalised guidance and feedback during the digital coaching session.

During the digital coaching session, the LM 155 may also generate feedback to be presented to the user to aid the user with on-going learning objectives. The feedback may include, for example, suggested learning resources, areas for improvement, motivational feedback and current strengths and achievements. For example, when the user proficiency level is updated during a real-time skill level update, the digital coach module may instruct the prompt generation unit to customise the prompt to request that the LM 155 generate feedback according to the changed level. The prompt engineering module 145 may include within the prompt a request that feedback be generated based on the content of the data record 212. For example, the digital coach module 130 may be configured to periodically instruct the prompt engineering module to include within a prompt a request for feedback according to the data record. Thus, not every prompt includes a request for feedback to avoid inundating the user with unrequested feedback. The user may also request feedback themselves as part of the input data.

FIG. 2B illustrates a dialogue method 200B in accordance with an embodiment. The method shown in FIG. 2B comprises steps performed a user device 110, steps performed by the skill assessment module 120, steps performed by the digital coach module 130 and steps performed by the language model 155. The method of FIG. 2B may be performed by a dialogue system 100 such as that described in relation to FIG. 1. The method 200B includes the steps 202-213 and 216-220 that are the same as steps 202-213 and 216-220 of FIG. 2A above. For conciseness, a description of these features will not be repeated.

The difference between the interactive coaching session 200B of FIG. 2B and the interactive coaching session 200A of FIG. 2A is how a dynamic skill proficiency update may be performed during the digital coaching session. In method 200A of FIG. 2A, the recorded assessments, model responses and user responses 212-A were analysed by the digital coach module 130, with the digital coach executing analysis utilising one or more statistical models. In method 200B of FIG. 2B, the recorded questions and answers are analysed by providing a prompt to the language model 155 with a request to perform the analysis. Method 200B comprises step 214-1, which includes prompt generation step 215-1, LM analysis step 215-2 and proficiency level update step 215-3. In prompt generation step 215-1, the prompt engineering module may generate a natural language prompt that includes the recorded assessments and model responses 212-A, statistical parameters for prior skill assessments of the user, a complete definition of a statistical model to be used, including model parameters and equations to be used, and a request that the LM 155 perform a skill assessment of the user based on the statistical data and recorded questions, model answers and user answers 212-A, and based on the statistical model definition. The skill proficiency level determined by the LM 155 is provided to the LM interface 140 of the digital coach module 130 to update the skill proficiency level in the database, such that further prompts generated in subsequent dialogue sessions include the revised skill proficiency level. As described above, the real-time skill update 214-2 may be performed multiple times during a digital coaching session.

In the above-described methods of FIGS. 2A and 2B, the digital coach module 130 performs the dynamic skill update calculation, with optional reference to the LM 155 of the language model module 150. However, in alternative examples, the digital coach module 130 may query the skill assessment module 120 to perform the dynamic skill update. In these examples, the skill assessment module 120 then performs analysis of the received question and answer record 212-A using one or more statistical models to update the skill proficiency level of the user for the skill, in the manner to be described below.

As mentioned above, the dialogue system 100 is configured to assist users in developing expertise in one or more skills, and each skill may be defined by one or more ‘topics’ about which knowledge is required for understanding the skill. Each topic may be relevant to one or more skills, and each question may be suitable to test the knowledge of one or more topics. In this manner, the relationship between skill and topic may be many-to-many and the relationship between questions and topics may be many-to-many. In some embodiments, topic groupings are not used and the skills are directly associated with the questions used to test the knowledge of the user. In these embodiments, the questions may be grouped by other parameters (for example, difficulty level), and may be related to skills in a many-to-many manner. In some embodiments, question grouping by topic is not used and each skill entity may be mapped directly to questions. The relationship between questions and skills may be many-to-many. The dialogue system 100 may track the user proficiency level for each topic within the selected skill, and conduct a dialogue session accordingly. The user can have expertise in multiple skills monitored by the dialogue system 100, and each skill may be related to one or more other skills in a many-to-many relationship to define skills that are relevant to the skill being learned (e.g. the “Economics” skill may be related to the “Calculus” skill). In some embodiments, the prompt provided to the LM 155 also includes proficiency information on each skill related to the current skill being learned. This may assist in the presentation of additional relevant resources tailored to an appropriate skill level of the user.

During the dynamic updates of the skill proficiency level as described above, the dialogue system 100 is configured to update a skill proficiency score, which may be a continuous variable, and a skill proficiency category/classification based on the change to the score. This may be performed by the digital coach module 130 or the skill assessment module 120. The dialogue system 100 may determine whether to change the skill proficiency category according to the relationship between the score and category for a given skill. For example, the score may be compared to the thresholds/ranged that classify the categories (e.g. when the score threshold for “beginner” to “intermediate” is 0.33, a proficiency score change from 0.25 to 0.3 will not change the category from “beginner” to “intermediate”, but a change from 0.3 to 0.35 will change the category from “beginner” to intermediate”). As a result, a revised skill proficiency indication may or may not change. This assessment ensured that the dialogue continues to be adapted to the user's current proficiency level, while also maintaining a record of any changes in the proficiency.

The skill assessment module 120 is configured to test the user ability based on assessment questions. As mentioned above, the skill assessment module 120 is configured to perform a skill assessment session 204, in which questions are presented to the user and answers are provided for assessment.

The purpose of the skill assessment module 120 is to analyse user responses to assessment questions or processes for a skill and/or topic and to generate/update an estimate of the proficiency of the user in the skill and/or topic. The proficiency of the user can include a score and one of a plurality of skill level classifications, with each classification defined according to the user score. The score and classification may be stored as information indicating the skill proficiency of the user, within the database. The score may be a numerical score, such as a continuous variable (e.g. “3.2” or “4.8”). As will be described below, the score may be a logit value (for logistical model) or a probability value (such as in Bayesian Knowledge Tracing models). The classification may be a textual classification such as “Beginner”, “Intermediate” or “Advanced”, which may be used by the prompt generation module to generate a custom prompt to tailor responses of the LM 155 as described herein.

It is understood that alternative classifications for user ability may be deployed, such as when learning a language learning, the Common European Framework (CFER) levels may be used, where the levels are A, B1, B2, C1 and C2, indicating progressive ability in language learning. Similarly, other skill proficiencies may be assessed against other standards, such as Regular Qualifications Framework (RQF), Key Stage levels, Secondary education levels and grades within those levels (e.g. grades or value ranges within qualifications such as GCSE, A-level, or International Baccalaureate, or the SAT). The skill standard chosen may describe expected proficiency of a test taker in an objective manner due to pre-defined topics that fall within those skills—e.g. in mathematics, calculus is a topic at A-level but not GCSE, so the dialogue system being configured to test and present content for the skill “Mathematics” at proficiency “A-level” would include questions (and/or study materials for a digital coaching session) on calculus. Any skill may have associated skill level classifications for said skill, and the algorithms defined herein may be configured to group the skill levels accordingly. The classification of the assessment questions may be grouped into corresponding difficulty levels accordingly. In some embodiments, the classification may be a continuous classification, such as SAT scores. In these embodiments, the proficiency score (e.g. the logit value) can be directly mapped to an SAT score and the prompt generation module 145 may generate a prompt accordingly. Whenever a particular proficiency level classification scheme is to be used, assessments are selected that correspond to that classification scheme (in which the questions may be benchmarked against any standardised assessment of the classification scheme).

The skill classifications may be related to the skill scored by selecting score boundaries/thresholds and classifying scored within each boundary/threshold. For example, if the skill score runs a range from 0 to 1, then “beginner” might be the skill category for all scores between 0 and 0.33, “intermediate” for all scores between 0.33 and 0.66 and “advanced” for all scores between 0.66 and 1.

The skill assessment module 120 may perform skill assessments utilizing a plurality of assessment questions that have been stored within a database, such as database 160. For example, the assessment questions may be stored in a file within the database. Each assessment question includes the question and associated information to identify correct answers. For example, when the assessment question is an MCQ, the information includes a plurality of answers, with one or more answers being correct and one or more answers being incorrect. In the embodiments described herein, whether or not an answer is “correct” can be confirmed by subject-matter experts, as described below, to confirm/validate the accuracy of answers to questions in the skill assessments.

In embodiments described herein, “correct” answers can also be considered as template answers, which are answers provided for the purpose of skill assessment and considered to be correct for the purpose of, and within the context of, the current skill assessment. The answers may be defined by a data structure in a Boolean format, such that each response is flagged as either “0” or “1” (“1” being correct, and “0” being incorrect). Each assessment question is flagged as being associated with one or more skills, and where topics are used, one or more topics. The user's answers to these questions are also structured in a Boolean format, resulting in a data file with a series of “1”s and “0”s indicating whether the user has answered a question or not. Thus, when a user is attempting a skill assessment for a particular skill (or a particular topic of the skill), the user is presented with a plurality of assessment questions relevant to the skill (and topic) and the answers to which are used to indicate the user's ability in the skill (and topic). Namely, for a series of questions, the skill assessment module will be presented with a series of Boolean datapoints corresponding to the responses of the user (indicating whether that person got the answer correct or not).

The skill assessment module 120 will estimate the user's proficiency level in a skill/topic based on a statistical model. The statistical model may be a scoring model where aggregate scores and/or average scores across a skill/topic is used to indicate an approximate proficiency level. However, such models may not accurately or precisely capture the true proficiency of the user. For example, correct answers to more difficult questions may be a better indication than correct answers to easy questions, some answers may be guessable, some questions may be better at discriminating between different abilities and some users who are skilled may unintentionally incorrectly answer a question. Furthermore, the past performance of a user provides valuable context for the current performance of a user.

In embodiments to be described below, the skill assessment module 120 may deploy statistical models that account for the above. These models may incorporate Bayesian estimation methods that base a skill proficiency estimation on past performance of a user, and furthermore may incorporate advanced information processing to account for different question types to provide more precise assessment of the skills of a user. For example, the statistical models may include Bayesian Knowledge Tracing (BKT), and Bayesian Expected Posteriori (EAP) estimates utilising logistic models such as the Rasch model and Item Response Theory (IRT), but examples are not limited thereto. Alternative skill estimation methods may be deployed in which a user's answers to a series of questions with correct/incorrect answers are used to infer the user's ability as a latent variable.

Bayesian estimation methods treat the learner's ability as a random variable, θ, with a probability distribution (i.e. P(θ)), rather than a single point estimate. After each question, Bayesian inference is used to update the estimate of the learner's ability, incorporating the evidence from the latest response. This results in a more personalized assessment, as the difficulty of the questions adapts to the test-taker's estimated ability level in real time. Namely, an assessment for θ may be made based on the user's answers to one or more assessment questions, as well as information on previous estimates for θ from prior assessment questions.

The Bayesian estimation methods may include performing Bayesian inference to determine a Posterior Probability Distribution for θ. The posterior probability P(θ|D) is determined as:

$$P ( θ \vert D ) = \frac{P ( D \vert θ ) \cdot P ( θ )}{P ( D )}$$

Where D is the data describing the user responses, P(θ) is the probability distribution of the latent variable θ describing the skill proficiency, P(D|θ) is the probability of observing the data D given the value for θ, and P(θ|D) is the posterior probability, being the probability distribution of θ given the observed data D. P(D) represents the probability of generating the observed data D, and does not change between different values for θ. For example, the probability P(D) may be taken to be 1.

Thus, a prior probability for θ, P(θ), can be updated based on new data, D (e.g. new answers to questions). Test items (data D) will be entered into the analysis with respective codes identifying the item (e.g., item 1, item 2, item 3). The responses of test items (input data) will be in the Boolean format. (1 for correct, 0 for incorrect answers) from test items. The P(D|θ) value may be defined by a chosen statistical model, such as IRT as to be described below. The prior probability P(0) may be set to an initial distribution, or estimated via IRT methods, also described below.

Thus, for P(θ) having a probability distribution, a revised probability distribution can be determined based on the above by multiplying, across all θ values and for each θ value, the P(θ) value for the θ value by the P(D|θ) for that theta value (i.e. the probability that the user will give the observed answer(s) if the user were to have a proficiency of θ).

Posterior Probability Distribution output will provide a distribution of probable ability levels for each person, offering a more detailed view of their skills. This will help in understanding not just a point estimate of ability but the range and uncertainty associated with it. Output from Posterior Probability Distribution Analysis will show continuous updates of the estimated ability level (θ) for each test-taker as they progress through the test. This will help to select subsequent questions that are most appropriate for the test-taker's current ability level in a Computer Adaptive Testing environment. Such Bayesian inference provides a more accurate and precise estimation of a user's skill proficiency over time than methods that do not take into account prior information. The posterior probability distribution may be determined for each answer in an assessment, meaning the posterior probability distribution can be continually updated to more accurately reflect the progress of the user.

Posterior probability distribution posterior probability distribution provides a full picture of all the possible values of an ability parameter and their associated probabilities. For use within the dialogue system 100, this information is condensed into a point value for θ that represents the “most likely”, or “best guess” or expected value for θ. The θ point value may be determined by performing maximum likelihood estimation on the posterior probability distribution (i.e. Maximum Posterior Probability).

Alternatively, Expected A Posteriori (EAP) Estimates may be performed, which output average estimate of the ability levels of a person, taking into account the posterior probability. This will be useful for summarizing a person's performance in a single metric that accounts for uncertainty and variability in responses. An EAP estimate is performed by taking the expectation value for the random variable θ, which is the arithmetic mean of possible value for θ multiplied/weighted by the probability for that value.

As discussed above, the skill proficiency θ may be modelled as a random variable having a probability distribution. This model reflects the understanding that the user answering a question correctly does not always mean that the user knows the answer/understands the material (for example, the user could have guessed, or have selected the correct answer for the wrong reasons), nor does an incorrect answer mean that the user does not know the answer/does not understand the material (for example, a knowledgeable student may have misread the answer or had a momentary lapse in concentration). In each model, the user's ability is defined as a latent parameter, θ, and the model defines a function that is the probability of the user getting the answer correct for a given ability of the user. The function can also include further parameters to describe the given probability, such as a question difficulty parameter, as well as a discrimination parameter and a guessing parameter.

In the Rasch model, the probability function is defined as:

$${P}_{ni} = \frac{{e}^{( {θ}_{n} - {b}_{i} )}}{1 + {e}^{( {θ}_{n} - {b}_{i} )}}$$

Where Pₙᵢ=the probability of user n answering item i correctly, θₙ is the ability parameter for user n, and bᵢ is the difficulty parameter for item i. In the Rasch model, a difficulty is assigned to each question, with the higher the number the more difficult the question. The difficulty parameter may be inferred by analysing response patterns to the assessment questions during set up of the skill assessment module. The responses may be real or simulated responses. The difficulty parameter is calibrated for each question across all skills and topics within the skill assessment module, creating a standardized measure across different topics and skills.

Unlike traditional scoring, the Rasch model isn't a sum of correct answers, but a measure that takes into account the difficulty of each question answered.

Thus, the Rasch model estimates the probability that a person with a certain ability will correctly answer a specific question. This probability takes into account both the person's ability and the questions difficulty.

The skill assessment module uses the answers provided by the user to a series of questions, together with the known difficulty levels for each question, to determine a likelihood function for θₙ (i.e. P(θ)).This may be done by means of the Bayesian inference methods described above, given a known current likelihood function for θₙ and taking for P(D|θ) either the probability function for the question (if answered correctly) or the quotient of the probability function (if answered incorrectly), where the quotient corresponds to the probability that a user having proficiency θ will get the answer incorrect. Alternatively, the likelihood function may be determined by multiplying together the probability functions Pₙᵢ and Qₙᵢ (where Qₙᵢ is the quotient of Pₙᵢ and corresponds to the probability that a user having proficiency θ will get the answer incorrect) for each answered question, with the product including either P and Q for each question according to whether the user answered the question correct or incorrectly. For example, if a user answered a first item correctly and a second item incorrectly, the likelihood function can be obtained by multiplying Pₙ₁ and Qₙ₂. Thus, the likelihood of a person's θ given their responses to multiple items is computed by multiplying the probabilities of each individual response (both correct and incorrect). This multiplication aggregates the evidence from all responses to estimate θ accurately.

Thus, there are multiple ways in which the likelihood function P(θ) may be estimated.

This likelihood function may be used to determine an estimate for θₙ, such as performing maximum likelihood estimation or determining an expectation value for θₙ. As described above, multiple answers may be sequentially applied in a Bayesian model, as described above, to determine P(θₙ), and a point value for θₙ may derived.

The output for θₙ will be on the logit scale, which is a logarithmic scale derived from the odds of a test-taker getting an item correct. For example, a test-taker might have an ability estimate of 1.5 logits, suggesting a higher-than-average ability level. The logit scale may be mapped into an ability scale for use by the skill estimation system and output to the digital coach for prompt preparation and a digital coaching session. The output information for θₙ may also be the random variable representation of On, including its probability distribution. This information may later be referenced during subsequent skill assessment processes.

The Rasch model may also be used to estimate the difficulty levels for assessment questions within the database. For example, across many test takers of known abilities, a maximum likelihood function can be performed to estimate bᵢ. Similar to ability estimates, item difficulty is also expressed on a logit scale. For example, an item with a difficulty estimate of 2.0 logits would be considered more difficult than average.

The IRT model is a more generalised case of the Rasch model. The Rasch model may be considered a “one parameter logistic model” (1PL), where b is the one parameter. IRT may take the form of a two parameter logistic model (2PL) or a three parameter logistic model (3PL), where for 3PL the probability function is defined as:

$${P}_{ni} = {c}_{i} + \frac{1 - {c}_{i}}{1 + {e}^{- {a}_{i} ( {θ}_{n} - {b}_{i} )}}$$

As before, Pₙᵢ=the probability of user n answering item i correctly, θₙ is the ability parameter for user n, and bᵢ is the difficulty parameter for item i. In addition, at is a “discrimination” parameter, that measures how effective the question is at differentiating between users of different abilities (conceptually, this parameter affects the slope of the logit function at the midpoint, meaning as aᵢ increases, the logit function trends toward a step function, meaning the test is highly discriminatory between abilities). cᵢ is a “guessing” parameter, which modifies the probability function to take into account the chances of a user getting an answer correct by guessing. For example, in a multiple choice question of four options, a random guess will give a 25% chance of getting the question correct. However, this may deviate depending on the question (e.g. some wrong answers may be obviously wrong and/or other wrong answers may be more likely to “seem” correct and thus more likely to be guessed).

As with the Rasch model, the discrimination, difficulty and guessing parameters are assigned to each question. The IRT parameters may be inferred by analysing response patterns to the assessment questions during set up of the skill assessment module. The responses may be real or simulated responses. The parameters are calibrated for each question across all skills and topics within the skill assessment module, creating a standardized measure across different topics and skills.

Thus, the IRT model estimates the probability that a person with a certain ability will correctly answer a specific question. This probability takes into account both the person's ability and the question parameters.

As with the Rasch model, using IRT the skill assessment module uses the answers provided by the user to a series of questions, together with the known difficulty levels for each question, to perform an estimate for θₙ. For example, Bayesian inference may be used to determine a likelihood function for θₙ, or the likelihood function may be determined by multiplying together, for each question, the probability function or its quotient according to whether the user answered each question correctly or not (e.g. according to a Boolean vector describing whether the user correctly answered the plurality of questions), as described above. The value for θₙ may be obtained by taking the expected value, for example. The output for θₙ will be on the logit scale, which is a logarithmic scale derived from the odds of a test-taker getting an item correct. For example, a test-taker might have an ability estimate of 1.5 logits, suggesting a higher-than-average ability level. The logit scale may be mapped into an ability scale for use by the skill estimation system and output to the digital coach for prompt preparation and a digital coaching session.

Independent of which model is used, the output of the skill estimation process is a skill proficiency value that may be used in the digital coaching session as described elsewhere herein.

In some embodiments, the skill proficiency update may be performed by applying Bayesian Knowledge Tracing (BKT), which is a hidden Markov model where the student proficiency level is modelled as a latent variable. Input to the BKT process includes a series of responses (correct or incorrect) to questions relating to specific skills, encoded as Boolean values (1 for correct, 0 for incorrect). Each question will be tagged with a specific skill or topic, enabling skill tracing at a skill-specific or topic-specific level. BKT includes the parameters P(L₀), P(T), P(G) and P(S), where P(L₀) is the initial probability of mastery of the skill (where if someone has mastered the skill they will be able to answer all questions correctly), P(T) is the transition probability, being the probability that the user will master the skill during consideration of the question, P(G) is the guess probability, being the probability that the person will guess the correct answer without having mastered the skill and P(S) is a slip probability, being the probability that the user will incorrectly answer the question despite having mastered the relevant skill. The probability of mastery P(L) is an indication of the ability level θ of the user (for example, with P(L) taking a value between 0 and 1 that can be mapped to a θ value range between a minimum and maximum value). P(L₀) indicates an initial ability level θ₀, and changes to P(L) tracing the changes in θ over time. BKT may thus be initialised with an initial P(L₀) value determined from a θ value as stored on the database. Changes to the mastery probability P(L) may analogously be fed back into the database with a corresponding update to the information identifying the skill proficiency level for the skill.

In the BKT process, the initial probability of the user m having mastery of skill N is set at the initialization value, and thus

$${P ( {L}_{1} )}_{m}^{N} = {P ( {L}_{1} )}^{N} .$$

The BKT process is applied iteratively to update the probability of skill mastery after every response to a question. The update is generated by calculating conditional probabilities:

$$p {( {L}_{t + 1} \vert answer = correct )}_{m}^{N} = \frac{P {( {L}_{t} )}_{m}^{N} \cdot ( 1 - {P ( S )}^{N} )}{P {( {L}_{t} )}_{m}^{N} \cdot ( 1 - {P ( S )}^{N} ) + ( 1 - P {( {L}_{t} )}_{m}^{N} ) \cdot {P ( G )}^{N}}$$

$$p {( {L}_{t + 1} \vert answer = correct )}_{m}^{N} = \frac{P {( {L}_{t} )}_{m}^{N} \cdot {P ( S )}^{N}}{P {( {L}_{t} )}_{m}^{N} \cdot {P ( S )}^{N} + ( 1 - P {( {L}_{t} )}_{m}^{N} ) \cdot ( 1 - {P ( G )}^{N} )}$$

Where

$$p {( {L}_{t + 1} \vert answer = correct )}_{m}^{N}$$

is the probability, after the question has been answered, that the user m has mastered the skill N, given that the user answered the question correctly, and

$$p {( {L}_{t + 1} \vert answer = incorrect )}_{m}^{N}$$

is the probability, after the question has been answered, that the user m has mastered the skill N, given that the user answered the question incorrectly.

Finally, the transition probability is applied (which accounts for the probability that the student acquired the skill mastery during answering the question) to field the final updated probability of mastery:

$$P {( {L}_{t} )}_{m}^{N} = P {( {L}_{t + 1} \vert answer )}_{m}^{N} + ( 1 - {P ( {L}_{t + 1} \vert answer )}_{m}^{N} ) \cdot {P ( T )}^{N}$$

Where

$$P {( {L}_{t + 1} \vert answer )}_{m}^{N} is either {P ( {L}_{t + 1} \vert answer = correct )}_{m}^{N} or {( {L}_{t + 1} \vert answer = incorrect )}_{m}^{N}$$

depending on the user's answer to the question. This current mastery may be used to predict the performance of the user at the next skill assessment or learning activity, by estimating

$${P ( {C}_{t + 1} )}_{m}^{N} ,$$

where

$${P ( {C}_{t + 1} )}_{m}^{N} = {P ( {L}_{t + 1} )}_{m}^{N} \cdot ( 1 - {P ( S )}^{N} ) + ( 1 - {P ( {L}_{t + 1} )}_{m}^{N} ) \cdot {P ( G )}^{N}$$

The skill assessment module 120 may provide a correspondence between probability of mastery and skill proficiency level. For example, cut-off values for the proficiency mastery may dictate the overall proficiency, such as if

$${P ( {C}_{t + 1} )}_{m}^{N} > 0.8 ,$$

the user is classified as “Advanced” (and thus “Hard” questions may be provided to the user in the next stage of BKT), and if

$${P ( {C}_{t + 1} )}_{m}^{N} < 0.3$$

the user is classified as “Beginner” (and thus only “Easy” questions may be provided to the user in the next stage of BKT).

Thus, the next question that is provided to the user may be a question having a difficulty level corresponding to

$${P ( {C}_{t + 1} )}_{m}^{N} .$$

Furthermore, the skill level output by the skill assessment module 120 corresponds to the classified skill level and is thus consistent with the previously described logistic models. There may also be a defined correspondence between the logit values for θ and the BKT probability of mastery score, allowing for skill estimation to switch between different statistical models. Thus, through BKT, the skill levels may dynamically assessed and allows personalised testing and coaching.

The parameters for BKT (e.g. probability values P(T), P(G) and P(S)) may be stored for each question in the database 160 and retrieved by the skill assessment module 120. The values may be set independently of each question based on validated values for each question, may be set to fixed values (e.g. different fixed values for different groups of questions), or may be inferred from statistical analysis of past user performance. For example, a BKT model fitting procedure may be followed to fitting a dataset comprising historical answers of the user to a BKT model to determine best-fit BKT parameters for the user. Different BKT parameters may be given for each user and be stored within the user record within the database. For example, the inferred values from statistical analysis may be stored and/or the values of questions previously used in BKT may be stored in the user record.

In summary, Bayesian Knowledge Tracing (BKT) performs a skill update for each of a plurality of questions based on an initial user proficiency level (as an initial probability of mastery), a plurality of BKT parameters (e.g. the parameters P(T), P(G) and P(S)) for each question and an indication, for each question, of whether or not the user has correctly answered the question. BKT thus helps to predict how well a person will perform on future tasks by continuously tracking performance. It addresses the challenge of personalizing learning based on the person's evolving knowledge state.

To perform the skill assessment, the skill assessment module 120 identifies a plurality of questions. The identification comprises selecting a set of questions from a plurality of stored sets of questions. The plurality of stored sets of questions are maintained in a data record accessible to the skill assessment module 120 (e.g. database 160). The skill assessment module 120 is configured to select the set of questions based on information identifying a skill to be learned by a user (e.g. the skill indication received from the user at step 202) and the information identifying a proficiency level of the user. For example, the dialogue system 100 maintains a data record with a list of skills available to be learned, with each set of questions identified as being related to one or more skills. Each question can be stored in a file with parameter information defining the question, including the difficulty level. For example, each question may be stored alongside the a, b and c parameters for the logistic models as identified above, or with the probabilities to be referenced in BKT.

Each of the assessment questions may be classified in difficulty by reference to the b parameter, as described above. The b parameters takes the form of a logit scale, centred around 0, with possible values spanning negative and positive numbers. The skill assessment module 120 is configured to present questions to the user of a difficulty that is appropriate to the skill level of the user. For example, the system categorizes the assessment questions into three predefined difficulty levels: “Easy”, “Medium”, and “Hard”.

This categorization will be based on fixed cut-off points on the difficulty scale (e.g., logits), and relative distribution of item difficulties to divide items into tertiles of logit value where the bottom third is ‘easy’, the middle ‘medium’, and the top third ‘hard’. For example, an entire body of questions may be analysed to classify the tertiles and the cut-off logit points determined from the classification. Assessment questions can then be classified based on the logit value. When BKT is used, the questions may be classified in difficulty according to a ranges of values within 0 and 1 to correspond to the skill proficiency classifications defined by ranges within the probability of mastery score P(L). Thus, a question may be selected according to the probability of mastery score of the user at the time of taking the BKT assessment question.

The classification may be performed, for example, using machine-learning classification algorithms, such as a Support Vector Machine (SVM). The classification may be structured or unstructured.

The assessment questions may be assigned difficulty levels through application of multiple statistical models as described above. For example, initial difficulty estimates for the questions are obtained using the Rasch model (e.g. using maximum likelihood estimation). A second, more refined algorithm (e.g. the IRT algorithm) may then be deployed to further refine these estimates.

The assessment question classification allows for dynamic adjustment of the difficulty categories based on ongoing data collection. As more individual responses are gathered, the algorithms enable the system to update its understanding of item difficulties and potentially re-categorize items as needed.

The user proficiency level may be scaled to the difficulty level across all assessment questions, to ensure consistency of the skill estimation process. For the logistic models, when the proficiency level of the user, θ, equals the difficulty level of the question, the probability of the user answering the question correctly is 50%. When the logit value for θ is higher than the logit value for b, this indicates the user is performing above average ability for the question and indicative of the user being of more advanced skill.

The skill assessment model 120, utilizing a statistical model such as IRT, will score three skill levels of individuals and the user may be classified in one of three categories “Beginner”, “Intermediate” and “Advanced”. Given the correspondence between the difficulty and the user proficiency, the same cut off points for the logit level for the user may be used to identify the skill proficiency for the user. Thus, “Beginner”, “Intermediate” and “Advanced” may correspond to “Easy”, “Medium” and “Hard” questions for the user, thus allowing for consistent selection of questions for individual users. The skill assessment module 120 may thus select a set of questions by identifying a set of questions that match the skill selected and having a difficulty level corresponding to the identified user proficiency level. In some embodiments, the skill assessment module 120 selects a set of questions having a skill level at or below the skill proficiency level of the user. For example, if the user skill level is “Medium”, then the digital coach module 130A may select a set of questions with a difficulty level of “Beginner” or “Medium”.

Based on the learners' performance on test items, the skill assessment module 120 dynamically adjusts their assigned skill level. For instance, if a learner consistently performs well on medium-difficulty items, the algorithm might elevate their skill level to ‘advanced’. Conversely, if a learner struggles with medium items, they might be reassigned to ‘beginner’ to reinforce foundational skills through the adaptive learning process of the dialogue system 100. The skill level of a user transitions between the different levels (e.g. beginner, immediate, advanced) when their skill proficiency level value (e.g. θ) passes the threshold between different levels.

As mentioned above, a skill may include multiple topics. At the output of the proficiency estimation process, an estimated proficiency level for a user, θ, is generated. The proficiency level may be for the skill as a whole, or may be for one topic within the skill. Each topic proficiency may be estimated by applying the above-described statistical methods for the responses for all assessment questions flagged as being relevant to the topic. Each skill proficiency may be estimated by applying the above-described statistical methods for the responses for all assessment questions flagged as being relevant to the skill, across all topics.

In embodiments described herein, estimated skill proficiency levels may be precisely determined. The skill level proficiency level comprises a determining an initial skill level estimation based on the user answers to a plurality of assessment questions and applying a statistical model, such as those described above. Each assessment is tagged according to a topic and according to a skill, and has been categorized into one of a plurality of difficulty levels.

In adaptive learning systems, where item selection is often influenced by a learner's previous responses, traditional methods may introduce bias in the assessment of abilities and difficulties. The algorithms described above effectively corrects for this potential distortion, ensuring that the ratings remain accurate and reflective of true performance, even in highly adaptive environments.

As mentioned above, the assessment questions and associated parameters may be stored in a database 160 for use by the skill assessment module 120. The questions and parameters may be validated questions and answers with pre-specified parameters. In some embodiments, the skill assessment module 120 is configured to generate a plurality of questions and determine the parameters of said questions, utilising a language model (such as LM 155).

For example, the skill assessment module 120 may be configured to generate test items by prompt engineering of prompts supplied to a language model (such as a GPT-3.5-Turbo, or Bard AI), including responses, scoring information, and relevancy of test items with topics and skill levels. These test items are generated to meet specified educational standards and defined difficulty levels. This may involve adapting existing questions or creating new ones from scratch. For example, to create a maths test, the skill assessment module 120 might ask the LM 155 to generate problems that align with certain mathematics standards at different grade levels. The LM 155 will also generate scoring rubrics based on the expected answers, detailing how points should be allocated for correct or partial answers. In addition to this, the LM 155 will also help create scoring guidelines and determine skill levels for each item, based on the difficulty and the skills required to answer correctly. To ensure that the generated questions are relevant to the specified topics and skill levels, the LM 155 may also cross-reference with educational standards databases by using natural language processing (NLP) techniques to assess content validity. This systematic approach leverages the LM 155 capabilities in language understanding and generation to create educational content that is both rigorous and tailored to specific learning objectives.

In these embodiments, prompt generation module 145 may be used to generate the required prompt, receiving instructions from the skill assessment module or an external user device (not shown in FIG. 1) configured to interface with the dialogue system 100 to perform question generation and validation. For example, the content generation module 170B and content creation/validation module 170C (to be described later) may be used to generate the assessment questions and correct responses.

As defined above, the assessment items will vary according to the type, for example, Multiple-Choice Questions (MCQs), fill-in-the-blanks, and true-false statements used in assessments. The primary objective is to guarantee the accuracy, relevance, and fairness of test items through rigorous double-checking processes. To cold start the skill assessment module 120, the skill assessment module 120 can leverage prompt engineering techniques to instruct LLM 155 to generate a diverse array of test items, as described above. These prompts will be crafted to align with specific skills, topics, and proficiency levels (e.g. beginner, intermediate, advanced), to generate assessment items to match the identified proficiency levels, ensuring that each test item is appropriately challenging and relevant. The expected outputs from the above process can be the following:
A set of test items with clearly defined questions, structured to challenge students at appropriate skill levels.
Detailed instructions on how to award points for each question, which helps standardize grading and provides feedback mechanisms.
Each test item comes with metadata, including its relevancy to certain topics, the skills it tests, its difficulty level, and any alignment with educational standards.
Analytical reports summarizing the coverage of skills, difficulty distribution, and potential gaps in the test.

Each test item can be structured as a JSON object, which is a flexible, text-based format that's easy to read and widely used for data interchange. Scoring guidelines can either be included within each test item's JSON or stored separately if the structure is complex.

Metadata associated with each test item is crucial for analysis and reporting. It can include fields such as:
Date when the item was generated.
Identifier for the user or system that created the item.
Data on how often the item has been used and performance statistics like average scores.
Support for API endpoints for CRUD operations (Create, Read, Update, Delete) on test items.
Use standards that provide compatibility with learning management systems (LMS) and other educational software.
Include measures to protect sensitive data, especially when integrating with external systems.

After the assessment items have been generated, the parameters for each test item can be determined. This may be performed by presenting the assessment items to users as a test and retrieving answers from the user. The users may be existing users enrolled with the dialogue who have a user record, and/or the contributors/validators to be described below. Alternatively, the users may have an unknown skill level, or the answers may be simulated.

The parameters can be determined using the 3-Parameter Logistic (3PL) model, in which the purpose is to simultaneously estimate the item parameters (discrimination aᵢ, difficulty bᵢ, and guessing cᵢ and the ability levels (θ) of the test-takers from the dataset of responses. For example, a parameter determining algorithm might include:
1. For each ability level (e.g. beginner, intermediate advanced), start with the raw score proportions from the user for the test items or standard scores if no prior information is available. Also, initial estimations are acquired for each of the test items (e.g. parameters generated alongside the questions or default parameters for questions of each difficulty level)
2. Use Expectation-Maximization Algorithm to: (a) calculate the expected frequencies of the correct and incorrect responses using the current parameter estimates. (b) Update the parameter estimates to maximize the likelihood of the observed data given the expected frequencies calculated in the step (a).
3. Use the results from the step 2 to refine the estimates of the item parameters. For each item, this involves finding the values of 3 parameters that maximise the likelihood of the observed responses given the current estimates of the test-taker abilities.
4. Assess the quality of the item parameter estimates using goodness-of-fit measures to the user answer scores, item information functions, and/or possibly test characteristic curves.
5. Repeat the refinement processes of steps 2-3 until a best-fit parameter has been optimised. The test item is thereafter ready for inclusion in an assessment.

For each question, an estimate of each of the a, b and c parameters for each question is acquired. Based on these estimates, some of the questions may be deemed unsuitable for use in an assessment process. For example, questions with a, b and/or c parameters that are outside pre-set ranges may be discarded from the plurality of questions (e.g. each value must lie above a pre-set minimum and below a pre-set maximum). If any one parameter value lies outside the range, the question is discarded. For example, an a parameter that is too low does not sufficiently distinguish between test takers to be useful in a skill assessment. A b parameter that is too high indicates that the question is very difficult and not useful for most users of the dialogue system. A c value that is too high means that the question is too easy to guess.

The above-described parameter estimation process may be also performed for other logistic models, including the Rasch model and the 2PL IRT model, in order to estimate the logistic function parameters for each question for the respective model.

With the set of validated questions with determined IRT parameters, the IRT model can be used to estimate the probability that a person with a certain ability will correctly answer a specific question. This probability takes into account both the person's ability θ and the question parameters a, b and c.

As with the Rasch model, using IRT, the skill assessment module uses the answers provided by the user to a series of questions, together with the known difficulty levels for each question, to perform an estimate for θn. For example, maximum likelihood estimation process may be performed on the answer data. The output for θn will be on the logit scale, which is a logarithmic scale derived from the odds of a test-taker getting an item correct. For example, a test-taker might have an ability estimate of 1.5 logits, suggesting a higher-than-average ability level. The logit scale may be mapped into an ability scale for use by the skill estimation system and output to the digital coach for prompt preparation and a digital coaching session.

By employing the IRT 3PL model, the skill assessment module 120 can achieve a highly nuanced and precise assessment of test-taker abilities, ensuring that their testing instruments are both fair and effective in measuring the intended skills and knowledge areas. The system may continue to refine estimates for the IRT question parameters during question assessment. For example, in one application of the Item Response Theory (IRT) 3-Parameter Logistic (3PL) model, the description of the system is as follows:
The primary input to the IRT 3PL model will include test-taker responses to selected test items. The responses are coded as Boolean values (1 for correct, 0 for incorrect).
The IRT 3PL model will then process the inputs. The model starts with initial guesses for each test taker, the model estimates a latent trait value (theta, θ), which represents their ability based on their pattern of responses across test items.
Using the collected data, refine estimates for difficulty, discrimination, and guessing parameters for each item. This refinement might be iterative, adjusting parameters as more data becomes available.
Then it will identify items that do not perform as expected (e.g., items with low discrimination that do not differentiate well between different ability levels).
Then it will flag items for high guessing probabilities that may compromise the assessment's integrity.
The system will then update the values for difficulty, discrimination, and guessing for each item based on the analysis.
A report on item performance, including items flagged for potential removal or revision will be then generated.
A detailed report summarizing the performance of test items may then be generated, including their ability to differentiate between test takers of varying skills, recommendations for improving the test, such as revising or removing poorly performing items, insights into the overall test structure, suggesting modifications to better capture the skills and abilities being assessed will be generated.

As explained above, the skill assessment module 120 will have a set of assessment questions grouped under different factors or components, each representing a different skill/construct. Reliability analysis is then applied to these subsets to evaluate if the grouped items reliably measure the same underlying construct/skill. The reliability and validity of test items be analysed through applying Cronbach's Alpha.

Cronbach's Alpha is a measure of internal consistency reliability. Cronbach's Alpha value ranges from 0 to 1, with higher values indicating greater internal consistency among the assessment questions. The skill assessment module 120 may utilize reliability analyses to test how well the items in a test measure the same construct or skill. The primary goal of reliability analysis in this context is to assess the internal consistency of assessment questions within each factor or component.

The Primary Input will involve responses of individuals to a set of test items, as described above, these responses are represented by Boolean values indicating correct or incorrect answers. The data will be in a numerical format, where each response is quantified according to a scoring rubric.

The skill assessment module 120 will then calculate Cronbach's Alpha based on the variance of individual test items and the total variance of all test scores. This involves statistical computation where the consistency among item responses is assessed, using the formula:

$$α = \frac{k}{k - 1} ( 1 - \frac{{\sum }_{i = 1}^{k} {σ}_{{y}_{i}}^{2}}{{σ}_{y}^{2}} )$$

where k is the number of items in the assessment,

$${σ}_{{y}_{i}}^{2}$$

is the variance associated with each item i, and

$${σ}_{y}^{2}$$

is the variance associated with the total scores

$$( y = {\sum }_{i = 1}^{k} {y}_{i} ) .$$

Alternative methods to determine Cronbach's Alpha may also be performed.

Output from Cronbach's Alpha Calculation will show a single numerical value ranging from 0 to 1, representing the internal consistency reliability of the test items. Higher values (closer to 1) indicate greater internal consistency among the test items, suggesting that they reliably measure the same underlying construct. Generally, an alpha value above 0.7 is considered acceptable, though this can be varied. Based on the alpha values, the skill assessment module may assess the quality of the test items determine whether to revise one or more of the assessment questions, including adjusting the MCQ or removing the MCQ.

The skill assessment module 120 thus provides an accessible interface for a user to test their knowledge, and does so in a manner that can identify and present only the most relevant questions to the user in a manner that is flexible and adaptable to allow for quick updates to a user's estimated skill level with the minimal number of interactions with the skill estimation system.

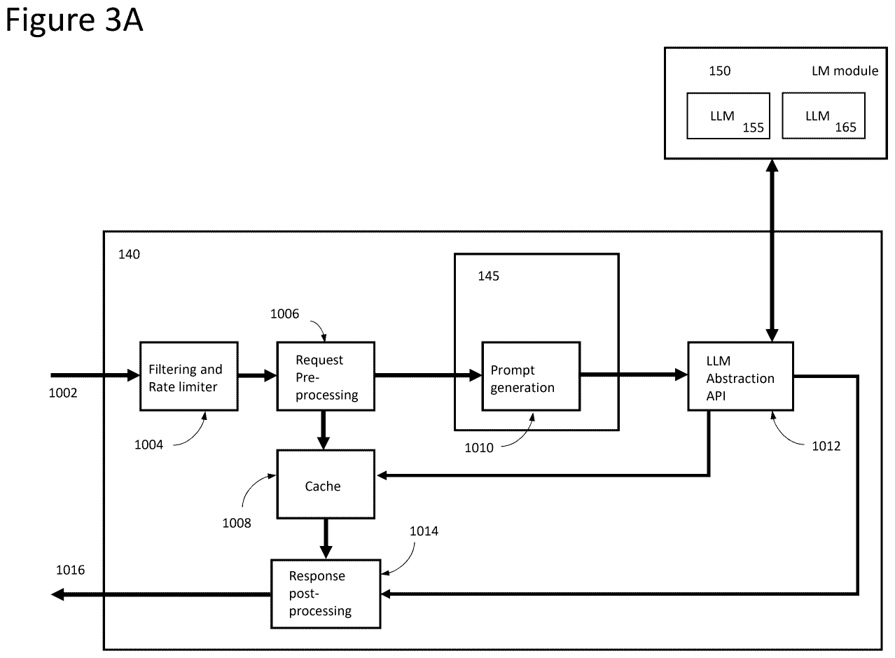

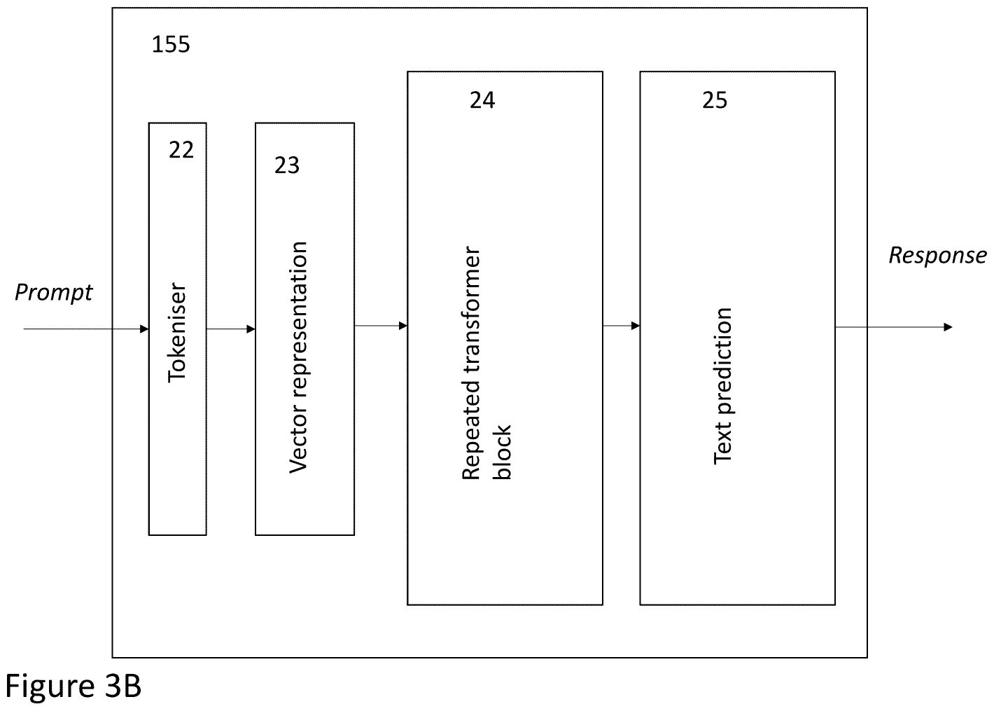

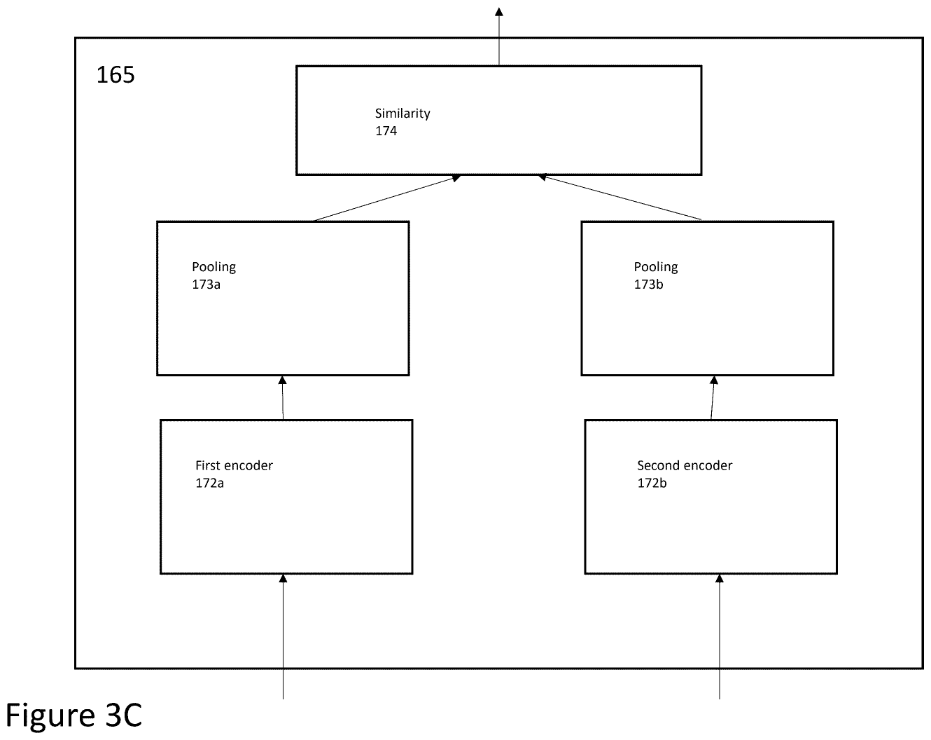

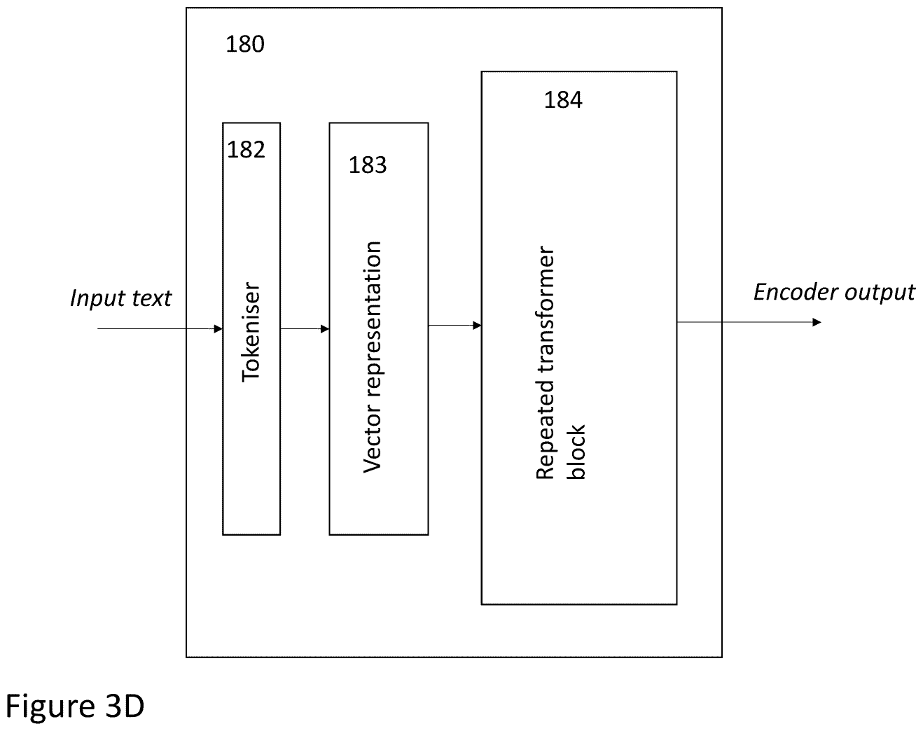

As stated above, the user interacts with the LLM via the LM interface 140. FIG. 3A shows a schematic of the LLM interface 140, in accordance with some embodiments. The LLM interface 140 is configured to receive input from other components of the digital coach module 130, such as an Input/output interface receiving input from the interface 110, or one or more additional task modules to be described below, or any other component wishing to query the LM 155. The input may be in the form of a request 1002. A request may include, for example, information indicating a task to be performed, text content (including a question and/or an answer, alongside a context resource), a skill, a topic of the skill, a complexity of the topic, the user's current skill proficiency level. Additional information may be provided to assist in formatting the response, such as preferred manner of address, preferred pronouns and short/long formatting preferences.

The LLM interface 140 is configured to perform a plurality of sequential processing steps. As illustrated in FIG. 3, these steps may each be performed by a module of a plurality of modules that are arranged in stages, but the steps may alternatively be carried out in sequence by a single processing module. As shown in FIG. 3, the LLM interface 140 may comprise a filtering and rate limiter module 1004. The module 1004 represents a security layer of the whole LLM interface 140 and functions to filter the request and rate limit the requests. As such, the module 1004 serves to protect the LLM interface 140 from request flooding or abusive use of the LM interface 140. Requests can be filtered by the sender address, authentication and encryption can be performed, as well as other security mechanisms (e.g. biometric authentication) as needed and specified by the system operator. The rate limiter acts as a throttle gate to limit the number of requests (e.g. prompts) by the sender, including a particular user. The request received by the module 1004 can be represented in various forms including binary (protobuf) or text (json), and may only operate on transport layer properties.

The LM interface 140 may further comprise a request pre-processing module 1006. This module 1006 works on a data context level of the request. Module 1006 is configured to recognize a particular task, keywords and/or session identification. For example, the task indicated by the request may be compared to a stored table as part of a text-matching algorithm. If a request is identified as similar to or identical to a previous request, the module 1006 may pass the request to cache 1008 and thus be served by a cache mechanism to bypass the LLM itself. The preprocessing performed by the module 1006 may include processing to clean and format the text, such as correcting grammar, correcting typos, removing line or page breaks.

The LM interface 140 may include the prompt engineering module 145. The module 145 is configured to perform prompt generation 1010 in which the request is processed and a prompt is generated for the LLM. Part of the prompt generation process includes generating the prompt according to formatting rules and/or structure for the LLM. Thus, module 1014 ensures that the prompt is tailored to the LLM.

The LM interface 140 further comprises an LLM abstraction API 1012. The API 1012 represents the abstraction layer between a prompt/request and an LLM. The purpose of the API 1012 is to connect and retrieve prompt responses from a model. The API 1012 is configured to receive a language model request and will format a request to the language model so as to interface with the indicate language model. For example, if the LLM is located externally to the server, the LLM may be queried via a HTTP request to the language model. The formatting of the language model request thus includes the embedding of an appropriate HTTP request. API design can include implementation of object-oriented programming implementing object-oriented principles including inheritance, abstract classes and dependency inversion. Such implementations of abstraction allows for the easy interchange and update of API parameters as the LLM is updated, or if a different LLM is selected for use. The abstraction API 106 can be updated separate to the other components LM interface 140 to account for changes to the language models utilised by the system, and to account for the inclusion of additional language models that may be used by the system. Thus, the LM interface 140 is able to provide an interface with language models in a manner that is flexible, efficient and up-to-date without requiring significant modifications to the components of the LM interface 140.

By providing a dedicated abstraction layer between the LM interface 140 and the LLM, the system is provided with modularity. To change between LLM models, the system simply needs to replace the implementation of the abstraction layer, leaving the API untouched. The API 1012 may comprise libraries and modules that connect to a particular LLM, libraries and modules to connect to a particular model, external LLM API authentication and session mechanisms, Internal LLM API endpoints information, and connection management with error handling.

In this example, the LLM abstraction API 1012 provides the output to the cache 1008, and stores the output in the cache alongside the original request used to select the model.

Thus, if the same request is made of the system at some point in the future, the response of the LLM may instead be retrieved from the cache, thus bypassing the LLM and saving time, computational power and resources. This is an optional feature. The LLM abstraction API 1012 may also trim or clean the data prior to output (for example, some LLMs attach a “RESPONSE:” string header, which can be removed by the API 1016).

The LM interface 140 further comprises a response post-processing module 1014. The module 1014 is configured to receive the output from the LLM abstraction API 1012, which may be the direct output of the LLM, and process the output into a desired format. The desired format may be, for example, output data interpretable by the user interface to present a natural language response to the user. In another example, the format may be a table of embeddings suitable for passing to another LLM. The module 1014 may alternatively receive a cached response from the cache 1008, and process the cached response into the appropriate format.

The LM interface 140 provides output 1016, which is subsequently provided to components external to the LM interface 140 (e.g. the output 1016 is provided as a response to the digital coach module 130, which forwarded the original request 1002 to the LM interface 140).

The LM interface 140 is configured to communicate with LM module 150, as shown in FIG. 3A. In some embodiments, the language model module 150 may execute on a single server. However, it will be understood that the language model module 150 may be executed across multiple servers or computing devices. For example, the first language model 155 may be hosted and executed in one server system and the second model 165 may be hosted and executed in another server system.

The language model module 150 comprises a first model 155 and a second model 165. The language model module may comprise further models. The first model 155 comprises a large language model. The first model 155 is a generative model. The first model 155 is configured for text generation. The second model 165 comprises a large language model. The second model 165 is configured to compute embeddings. The second model 165 is configured to determine a similarity score between two input texts.

FIG. 3B is a schematic illustration of an example first language model 155.. Although specific model functionality is described here as an example, it is understood that various pre-trained large language models are known and available, such as GPT based language models, and these may be used as the language model 155 without further training.

The language model 155 comprises a large language model. In particular, the language model 155 comprises a language model that demonstrates emergent properties as a result of the number of trained model parameters, which may be in the region of tens of millions to hundreds of billions for example. In one example, the language model 155 comprises more than 1 billion trained parameters. The language model 155 is pre-trained using large amounts of general text data. The language model 155 is pre-trained by predicting the next word in a sentence. The language model 155 is a generative model. The language model 155 is configured for text generation.

The language model 155 in this example is a decoder model, in other words the language model 155 comprises the decoder part of a transformer model but not the encoder part. The language model 155 in this example is an auto-regressive model. For a given word, the attention layers only access previous words.

In this example, the language model 155 comprises a transformer decoder. The language model 155 comprises a plurality of attention layers.

As has been described previously, in dialogue interface step 210, language model requests are generated to comprise a prompt including the user input and information describing the user, including a user proficiency level, and a request for a response to the user input. The prompt is taken as input to the language model 155.

In the language model 155, the prompt is taken as input to a tokeniser 22. The tokeniser 22 takes the input text and outputs a sequence of tokens representing the text, from a vocabulary of possible tokens. For example, the vocabulary may comprise a first set of tokens each corresponding to a different word. Special tokens, such as tokens representing a start or end, may also be included in the vocabulary. Each token may be represented by a different positive integer number for example. The tokeniser 22 outputs a sequence of numbers corresponding to the input system prompt. The number of tokens in the sequence will vary between different input prompts.

The sequence of tokens is taken as input to a vector representation module 23. The vector representation module comprises stored token representations. Each token representation is a stored vector, where each vector corresponds to a token from the vocabulary. For each token in the input sequence of tokens, the corresponding token representation is retrieved. The vector representation module may further comprise stored positional representations. For example, each positional representation may be a stored vector corresponding to an absolute position in the sequence of tokens. The vector representations are trainable parameters of the language model 155.

For each token in the input sequence, addition of the token representation and the positional representation is performed, to produce a single vector corresponding to the token. This sequence of vectors is taken as input to a repeated set of transformer blocks 24. In particular, the sequence of vectors populates an input matrix, where each vector from the sequence populates a row (any remaining rows being populated with zero values).

Each transformer block comprises an attention module, followed by an addition and layer normalisation, a feed forward neural network and a second addition and layer normalisation. The attention module may be a self-attention module. The attention module may be a multi-headed attention module.

Each attention module comprises three stored matrices of weights. These are trainable parameters of the language model 155. In particular, each attention module comprises a key weight matrix, a query weight matrix and a value weight matrix. When the input matrix is taken as input to the first transformer block, a key matrix is calculated as the matrix product of the input matrix with the key weight matrix, a query matrix is calculated as the matrix product of the input matrix with the query weight matrix, and a value matrix is calculated as the matrix product of the input matrix with the value weight matrix. For a multi-headed attention layer, each of the query matrix, key matrix and value matrix is then split into separate matrices, one for each attention head, along the column dimension.

Scores are then calculated for each attention head. A matrix product is calculated between the query matrix and the transposed key matrix for each attention head. The scores represent, for the token being processed (the score matrix row), the attention of the model on each other token in the sequence (the score matrix columns). A higher score corresponds to more focus on the token.

An attention mask is then applied to the output score matrix for each attention head, to mask out the scores corresponding to future tokens. A softmax function is applied to the result, giving a final score matrix for each attention head. The matrix product of the score matrix with the value matrix is then taken for each attention head. The outputs from the attention heads are then merged. The matrix product with a stored projection matrix is taken, to give the output of the attention layer.

This output is taken as input to a first addition and layer normalisation module, in which an element wise addition is performed with the input matrix and a layer normalisation performed on the result. The feed forward neural network is then applied. Each row (corresponding to a token) from the output of the addition and layer normalisation module is taken as input separately to the neural network, so that a sequence of vectors is output from the neural network. A nonlinear activation is applied in the feed forward layer. The output from the neural network module is taken as input to the second addition and layer normalisation module, which performs an element-wise addition with the input to the feed forward neural network module, and then a layer normalisation. The output of the second addition and layer normalisation module is formed into an input matrix and taken into the next transformer block.

The language model 155 is run to predict the next word in a sequence of text. A vector comprising the values from the row corresponding to the last token in the input text in the final matrix output from the repeated transformer block 24 is thus taken as input to the text prediction module 25, in order to predict the next token in the sequence.

In the text prediction module 25, the matrix product of this vector with a matrix of the stored token representations is taken. The result corresponds to a score for each token in the vocabulary. A softmax function is applied to the output, to produce a vector of probability values, each value corresponding to a token in the vocabulary. This represents the probability that the next token in the sequence corresponds to each token in the vocabulary. The next token in the sequence is predicted based on the output probabilities. For example, the token having the highest probability may be selected, or a token may be sampled based on the probabilities.

The predicted token is then appended to the sequence of tokens corresponding to the input prompt text, and the result is taken again as input to the language model 155, to predict the next token in the sequence. This process is repeated, until a pre-defined maximum number of tokens is reached, or until an end token is outputted. The tokens are then converted into the corresponding sequence of text. The generated text corresponds to the a language model response.

An example method of training the language model 155 will be described. However, various other methods may be used. Furthermore, various pre-trained large language models are known and available, such as GPT based language models, and these may be used without further training.

Various datasets for training language models are known. For example, the language model may be trained using a dataset comprising text data taken from a large number of web pages. The dataset may further comprise data from other text sources. The training data is general text data.

During the training process, sequences of text from the training dataset are processed by the language model 155 in the same manner as described above. The language model 155 comprises a number of trainable parameters, which can be expressed as a vector θ. The parameters include the token representation vector values, the position representation vector values, the attention layer weights and the neural network layer weights for example.

The parameters are randomly initialised. The update process searches for a parameter vector θ so that the difference between the next token in the sequence extracted from the dataset and the prediction of the next token made by the language model 155 is minimised. A process of updating θ sequentially by computing the gradient of a loss function and updating θ using the computed gradient and an optimiser function is performed. A cross entropy loss may be used, in which:

$$L = - {\sum }_{v = 1}^{V} {y}_{v} log \hat{{y}_{v}}$$

where yᵥ is the vth entry from a one hot encoding representing the next token in the sequence and ŷᵥ is the vth entry from the vector of probability values output from the language model 155. The gradient of the loss L with respect to each of the trainable parameters of the language model 155 is determined through back-propagation. The gradient is then used to determine the updated parameters, using an optimiser function. This family of update methods is known as gradient descent (GD), generally defined iteratively as:

$$θ = θ - μ \frac{\partial L}{\partial θ}$$

where μ is the learning rate, which defines how quickly the parameters are updated. An Adam based optimization algorithm may be used for example. This process is performed for each sequence extracted from the training corpus. The update may be performed in batches, based on a batch average.

Although in the above described example, an example language model 155 is described, the LLM interface 140 may be configured communicate with a wide variety of LLMs. Example LLMs can include OpenAI GPT-3.5-turbo and OpenAI GPT-4. For example, the OpenAI GPT 3.5 family of LLMs can understand and generate natural language or code. For example, OpenAI GPT-3.5-turbo is available as an external API, is updated with new iterations and is optimized for chat-like tasks. It can be used interchangeably with the GPT-4 model. The OpenAI GPT-4 model has a broader knowledge and domain expertise. GPT-4 is more advanced than GPT 3-50-turbo, with linguistic finesse, multimodal capabilities (e.g. text and images), improved information synthesis and a large number of supported tokens (compared with GPT-3.5-turbo's 3096 tokens, GPT-4 supports 8192, and GPT-4-32k supports 32768 tokens supported for GPT-4-32k). The GPT-4 family may be suited to advanced tasks with context and advanced Natural Language Understanding (NLU) tasks.

FIG. 3C is a schematic illustration of an example second language model 165. Although a specific model is described here as an example, it is understood that various pre-trained large language models are known and available, such as SBERT, and these may be used as the model of the second language model without further training.

The second model 165 comprises a large language model. In particular, the second model 165 comprises a first encoder based large language model 172a and a second encoder based large language model 172b. The first encoder based large language model 172a may be a pre-trained model such as BERT. The second encoder based large language model 172b may be a pre-trained model such as BERT. These language models demonstrate emergent properties as a result of the number of trained model parameters, which may be in the region of tens of millions to hundreds of billions for example. In one example, the second model 165 comprises more than 100 million trained parameters. The first encoder based large language model 172a and second encoder based large language model 172b are pre-trained using large amounts of general text data.

The first encoder based large language model 172a and second encoder based large language model 172b each comprise the encoder part of a transformer model but not a decoder part. For a given word, the attention layers can access all the words in the input text. The attention layers have bi-directional attention.

In this example, the first encoder based large language model 172a and second encoder based large language model 172b each comprise a transformer encoder. The first encoder based large language model 172a and second encoder based large language model 172b each comprise a plurality of attention layers.

The second language model is configured to receive a language model request that may include a prompt generated to comprise two texts to compare (e.g. a first user response to an assessment and a correct response to the assessment). The language model request is taken as input to the second model 165. In particular, the first user response is taken as input to the first encoder 172a and the correct response is taken as input to the second encoder 172b. The first encoder 172a and second encoder 172b will be explained in more detail below.

The encoder output from the first encoder 172a comprises an output vector corresponding to each token in the first user response. This output sequence of vectors is taken as input to a first pooling layer 173a. In this example, the pooling layer 173a performs mean pooling, and calculates the mean of the output vectors, resulting in a single vector representing the first user response. The encoder output from the second encoder 172b comprises an output vector corresponding to each token in the correct response. This output sequence of vectors is taken as input to a second pooling layer 173b. In this example, the pooling layer 173b performs mean pooling, and calculates the mean of the output vectors, resulting in a single vector representing the correct response. The vector output from the first pooling layer 173a and the vector output from the second pooling layer 173b are taken as input to a similarity calculation operation 174. In this example, a cosine similarity value is calculated between the two vectors. This value is output as the answer evaluation score.

The task performed by the second model 165 includes the following steps:
a. Tokenize and generate sentence embeddings based on the transformer models. This process can comprise a mean pooling step, where word embeddings are transformed into sentence embeddings.
b. Compute cosine similarity between the user's input and first LLM's output. This calculation is a base for an evaluation metric—the perfect answer should have “1” cosine similarity.

In one example, the second model 165 may be sBERT (https://www.sbert.net/) which is available in a Hugging Face transformer library (https://huggingface.co/sentence-transformers).

As described previously, the first encoder 172a and the second encoder 172b may be pre-trained. A further training step may be performed on the second model 165. In this further training process, the output from the first pooling layer 173a, the output from the second pooling layer 173b and the element-wise difference between the two outputs are concatenated. The resulting vector is then taken as input to a softmax classification layer. The training is then performed using a cross-entropy loss function and an Adam optimizer. The first encoder 172a and the second encoder 172b have tied weights. A labelled training dataset comprising a large number of sentence pairs across various genres is used. As described previously, various pre-trained large language models are known and available, such as SBERT, and these may be used as the second model 165 without further training however.

An example encoder model structure 180 which may be used for the first encoder 172a and the second encoder 172b is shown in FIG. 3D. The input text (e.g. the first user response for the first encoder 172a or the correct response for the second encoder 172b) is taken as input to a tokeniser 182. The tokeniser 182 takes the input text and outputs a sequence of tokens representing the text, from a vocabulary of possible tokens. For example, the vocabulary may comprise a first set of tokens each corresponding to a different word. Special tokens, such as tokens representing a start or end, may also be included in the vocabulary. Each token may be represented by a different positive integer number for example. The tokeniser 182 outputs a sequence of numbers corresponding to the input system prompt. The number of tokens in the sequence will vary between different inputs.

The sequence of tokens is taken as input to a vector representation module 183. The vector representation module comprises stored token representations. Each token representation is a stored vector, where each vector corresponds to a token from the vocabulary. For each token in the input sequence of tokens, the corresponding token representation is retrieved.

The vector representation module 183 may further comprise stored segment representations. A segment vector representation indicates whether the token corresponds to a first segment of the input text or a second segment of the input text.

The vector representation module 183 may further comprise stored positional representations. For example, each positional representation may be a stored vector corresponding to an absolute position in the sequence of tokens.

These vector representations are trainable parameters.

For each token in the input sequence, addition of the token representation, the segment representation and the positional representation is performed, to produce a single vector corresponding to the token. This sequence of vectors is taken as input to a repeated set of transformer blocks 184. In particular, the sequence of vectors populates an input matrix, where each vector from the sequence populates a row (any remaining rows being populated with zero values). The output of the set of transformer blocks 24 is a sequence of vectors, each corresponding to a token in the input sequence.

Each transformer block comprises an attention module, followed by an addition and layer normalisation, a feed forward neural network and a second addition and layer normalisation. The attention module may be a self-attention module. The attention module may be a multi-headed attention module.

Each attention module comprises three stored matrices of weights. These are trainable parameters. In particular, each attention module comprises a key weight matrix, a query weight matrix and a value weight matrix. When the input matrix is taken as input to the first transformer block, a key matrix is calculated as the matrix product of the input matrix with the key weight matrix, a query matrix is calculated as the matrix product of the input matrix with the query weight matrix, and a value matrix is calculated as the matrix product of the input matrix with the value weight matrix. For a multi-headed attention layer, each of the query matrix, key matrix and value matrix is then split into separate matrices, one for each attention head, along the column dimension.

Scores are then calculated for each attention head. A matrix product is calculated between the query matrix and the transposed key matrix for each attention head. The scores represent, for the token being processed (the score matrix row), the attention of the model on each other token in the sequence (the score matrix columns). A higher score corresponds to more focus on the token.

A softmax function is applied to the result, giving a final score matrix for each attention head. The matrix product of the score matrix with the value matrix is then taken for each attention head. The outputs from the attention heads are then merged. The matrix product with a stored projection matrix is taken, to give the output of the attention layer.

This output is taken as input to a first addition and layer normalisation module, in which an element wise addition is performed with the input matrix and a layer normalisation performed on the result. The feed forward neural network is then applied. Each row (corresponding to a token) from the output of the addition and layer normalisation module is taken as input separately to the neural network, so that a sequence of vectors is output from the neural network. A nonlinear activation is applied in the feed forward layer. The output from the neural network module is taken as input to the second addition and layer normalisation module, which performs an element-wise addition with the input to the feed forward neural network module, and then a layer normalisation. The output of the second addition and layer normalisation module is formed into an input matrix and taken into the next transformer block.

Each row in the final matrix output from the repeated transformer block 184 corresponds to the encoder output for the corresponding input token, where the first row corresponds to the encoder output for the first token in the input text sequence, the second row corresponds to the encoder output for the second token in the input text sequence and so on.

An example method of training the encoder structure will be described. However, various other methods may be used. Furthermore, various pre-trained large language models are known and available, such as BERT based language models, and these may be used without further training.

Various datasets for training language models are known. For example, the language model may be trained using a dataset comprising text data taken from a large number of web pages. The dataset may further comprise data from other text sources as well. The training data is general text data.

During the training process in this example, two training processes are used—a masked token prediction based process and a next sentence prediction based process.

In the masked token prediction based training process, the encoder output (the output of the repeated transformer block 184) is taken as input to a classification layer, comprising a fully connected layer using a GELU activation function. For each sequence of input tokens taken from a training data-set comprising a large number of input sequences, some percentage of the tokens are randomly replaced with a mask token. The training objective is to predict the token from the vocabulary corresponding to each masked token. The sequence of tokens including the mask tokens is processed in the same manner as described above, where the output from the repeated transformer block comprises a vector corresponding to each of the input sequence of tokens. Each of these is taken as input in turn to the fully connected layer. The weights of this layer are trainable parameters. The matrix product of the vector output from the fully connected layer with a matrix of the stored token representations is taken. The result corresponds to a score for each token in the vocabulary. A softmax function is applied, to produce a vector of probability values, each value corresponding to a token in the vocabulary. This represents the probability that the token in the sequence corresponds to each token in the vocabulary. The loss function is based on the prediction of the masked tokens only.

In the next sentence prediction based training process, the input text sequences in the training data set each comprises a pair of sentences. For some sequences in the training dataset, the second sentence is the subsequent sentence following the first sentence in the original source material. For other sequences, the second sentence is a random sentence. The training objective is to predict whether the second sentence is the correct subsequent sentence. The sequence of tokens is processed in the same manner as described above, where the output from the repeated transformer block comprises a vector corresponding to each of the input sequence of tokens. The vector corresponding to the first token in the sequence (a start token) is taken as input to a classifier layer, which outputs a 2 element vector. The weights of this layer are trainable parameters. A softmax is applied to give a probability that the second sequence is the correct subsequent sequence.

Using the above described processes, the token representation vector values, the position representation vector values, the segment representation vector values, the attention layer weights and the neural network layer weights of the encoder may be learned.

The second language model 165 described above may receive requests from the digital coach module 130 via the LM interface 140 in order to perform similarity measurements (for example, as part of the dynamic skill assessment process to be described below).

The LLM interface 140 is provided as a versatile, adaptable system that can accept multiple inputs and requests, interface with an LLM and provide output tailored to the request that has been input in a manner that optimises system performance without sacrificing accuracy of text analysis and generation. In addition, the same LLM interface 140 is provided for use by multiple task modules within the digital coach module 130 that are described below. The LLM system is easily upgraded to accommodate newly developed LLMs or existing LLMs. As such, it is not necessary to tear down and rebuild an entire system architecture to switch the system between the performance of different tasks or subtasks. The operation of each of the task modules, and the interaction with the LLM interface 140, will be provided below.

As indicated above, the LM interface 140 includes a prompt engineering module 145 that is configured to generate prompts to pass to the LM module 150. The language models used may not be specifically trained toward the functionality of the digital coach module 130, and are instead pre-trained language models such as GPT models. The prompt thus provides context and guidance to the interaction between the user 102 and the language model to ensure that the responses provided by the language model are tailored to the user for the specific skill to be learned and for the skill level for the user.

A custom prompt is generated by the prompt engineering module 145 for each input received from the user, to be passed to the language model 155. Thus, the prompt includes the text input by the user and additional context information. The additional context information includes the skill level of the user, and other information such as embeddings, the averages of statistical model parameters of questions previously answered by a user, and other inputs as described herein. The prompt may also include user details, such as average time spent in the app and the consistency of their usage, including streaks and frequency of engagement. The prompt can also include additional information that may provide context regarding the proficiency of the user, such as job-related data. For example, the prompt can include a user's job title, or detail regarding the qualifications of a user (e.g. the fact that a user has a Bachelor's degree in Mathematics, or is a Mathematics Lecturer).

For example, a user may input the query in a learning session to learn the skill Calculus: “How is the contribution margin calculated, and what does it indicate?”. The prompt engineering module will receive the query and generate the prompt:
“The user is learning the skill “Accounting”. They have a proficiency level in this skill of “Beginner”. They have the following proficiency levels in the following topics: “cost-profit analysis basics=Intermediate”; “cost-profit analysis application=Beginner”; “Break even analysis=Intermediate”. Write a response to the query “How is the contribution margin calculated, and what does it indicate?””

In response to the above query, the LLM might output the answer:
“The contribution margin is calculated by subtracting the variable costs from the sales revenue. It indicates the portion of each sale that is available to cover the company's fixed costs and contribute towards profitability, representing the revenue available for generating profit after accounting for variable costs.”

In the above generated prompt, the prompt is created from a template, which the parts in quotation marks are fields that can be populated by the prompt engineering module 145. For example, the prompt before population may look like:
“The user is learning the skill < >. They have a proficiency level in this skill of < >. They have the following proficiency levels in the following topics: < >; < >; < >. Write a response to the query < >

The prompt engineering module 145 thus receives the input information, and populates the fields to generate the final, customised prompt. The above prompt is merely an example, and other prompt templates may exist. The database 160 may include a large number of prompt templates, and the prompt engineering module 145 selects which template based on selection information. The selection information may be generated by the digital coach module and included in request 1002, may be retrieved by the prompt engineering module 145 prior to generating the prompt, or may be provided by other means. For example, selection information may include different prompts for different skill levels. Beginner skill levels may include additional text within the prompt, such as “word your explanation as if explaining it to a high school student”. The selection information may indicate that the prompt include a request for additional resources or content. For example, “display a learning resource for this query and present questions and answers for the user based on the learning resource”.

It is to be noted that the LLM used by the digital coach module 130 is stateless, indicating that it does not retain a history of prior queries. To address this, the digital coach module may implement a history management system for previous interactions between the user and the language model (for example, a record is kept of the last K user messages and the corresponding responses of the language model). These previous messages and responses can be embedded in the prompt to provide the LLM with information from the preceding conversation.

As mentioned above, in addition to skill updates performed by the skill assessment module 120, the digital coach module 130 is also configured to perform dynamic skill proficiency updates during a digital coaching session. This allows the content of the digital coaching session to stay current without requiring the user to interrupt their engage in a separate skill assessment by the skill assessment module 120. The digital coach module 130 performs skill assessment updates using similar statistical models as those described above for the skill assessment process for the user. For example, the dynamic skill assessment process uses a Bayesian inference model to calculate a posterior skill proficiency probability. Alternatively, or additionally, the digital coach module 130 may perform BKT using the model described above.

As described above, the dynamic updating of the proficiency level information may be performed by generating proficiency update questions, providing the proficiency update questions to the user, and analysing answers of the user. The analysis of the answers of the user are used by the digital coach module 130 as an input to a statistical model or skill proficiency update model. The parameters for the models may be stored in a database (e.g. database 160) and retrieved by the digital coach to perform the dynamic skill proficiency update. The model parameters retrieved from the database may be model parameters contained within the user record referenced by the skill assessment system 120, thus closely associated with the particular user engaging in the digital coaching session. As described above, the skill assessment module 120 may estimate and store parameters based on questions presented to the user during historic skill assessment process, and in some embodiments these estimated parameters are retrieved by the digital coach module 130 for use in performing dynamic skill assessment. By the digital coach module 130 retrieving the same parameters used by the skill assessment module 120 (or the parameters estimated by the skill assessment module 120), there can be improved consistency between the skill assessment processes.

In some embodiments, the parameters for the models may be determined by the digital coach module using a similarity measurement between the user answer and model answer for a proficiency update question.

In one embodiment, the skill proficiency update model is a Bayesian posterior probability inference model. Similar to that described above, the posterior probability P(AID) is determined as:

$$P ( θ \vert D ) = \frac{P ( D \vert θ ) \cdot P ( θ )}{P ( D )}$$

In this model, P(θ₀) is the initial probability of mastery (i.e. between 0 and 1, and representing the skill proficiency level), P(D) is the probability of generating the data, and P(D|θ) is the probability of the user providing a response given mastery of the skill by the user. The Bayesian posterior probability inference model may comprises multiple parameters X(i), including:
X(1)=P(D_{correct}|θ)=likelihood of correct response given mastery;
X(2)=P(D_{incorrect}|θ)=likelihood of incorrect response given mastery;
X(3)=P(D_{correct}|¬θ)=likelihood of correct response given non-mastery;
X(4)=P(D_{incorrect}|¬θ)=likelihood of incorrect response given non-mastery;

These parameters may be used to determine revised skill proficiency level by determining the posterior probability calculation. For example, when a user answers a question correctly, P(θ₁|D) can be determined as:

$$P ( {θ}_{1} \vert {D}_{correct} ) = \frac{P ( {D}_{correct} \vert θ ) \cdot P ( {θ}_{0} )}{P ( {D}_{correct 1} )}$$

Where P(D_{correct1})=P(D_{correct}|θ)*P(θ₀)+P(D_{correct}|¬θ)*P(¬θ₀).

When a user answers a question incorrectly, P(θ₁|D) can be determined as:

$$P ( {θ}_{1} \vert {D}_{incorrect} ) = \frac{P ( {D}_{incorrect} \vert θ ) \cdot P ( {θ}_{0} )}{P ( {D}_{incorrect 1} )}$$

Where P(D_{incorrect1})=P(D_{incorrect}|θ)*P(θ₀)+P(D_{incorrect}|¬θ)*P(|¬θ₀).

Based on an indication for whether the user has answered the question correctly or not, the revised skill proficiency level is determined as either P(θ₁|D_{correct}) or P(θ₁|D_{incorrect}) based on values for each of the above parameters of the proficiency update model.

Based on the answers provided by the user, the questions may be determined as “correct” or “incorrect” by the digital coach module 130 (i.e. in a similar manner to the user answering questions at the skill assessment module 120), and the user responses (proficiency update answers) can be represented as a series of Boolean values. The Boolean values can be used as the above-mentioned indication for whether the user has answered each question correctly or not. Thus, for a plurality of question responses provided by the user, the digital coach module may iteratively update the estimate for θ based on the model above for each question, with the probability of mastery updated based on the answer to one question being the initial probability of mastery used to perform an update based on the answer to a subsequent question. As such, the above Bayesian posterior probability inference model performs knowledge tracing in a similar manner to the BKT model described above.

As mentioned above, the parameters X for the proficiency update model may be initialized from parameter values stored in a database. The parameters may be different for each question and generated when the question is generated, or may be fixed at generalised values to be applied across all questions (e.g. assuming the same likelihood probabilities for all questions).

In one example, the Bayesian posterior probability inference model is a BKT model as defined above. In this example, P(θ₀)=P(L₀), the likelihood of an incorrect response given mastery is a probability of slippage (i.e. P(S)), and the likelihood of a correct response given mastery is 1−P(S). The likelihood of correct response given non-mastery is a guessing probability (i.e. P(G)), and likelihood of an incorrect response given non-mastery is 1−P(G). P(S) and P(G) values may be values generated for each question, may be retrieved from a database as described above, or may be generalised values (e.g. assume a 10% chance of slippage for every question and a guessing probability is determined for each question as 1/N, with N being the total number of available answers for a multiple-choice question). The transition probability P(T) may be applied to generate a skill proficiency estimate from P(θ₁|D_{correct})+(1−P(θ₁|D_{correct}))*P(T). P(T) can again be a general value taken from a database, or a value generated for each question.

Where the initial mastery/skill proficiency level is given as a probability distribution, the above processes may be performed across the distribution for each θ value to produce a new probability distribution. The final θ score may then be determined using the functions described above (e.g. maximum likelihood, taking the expected value, etc).

The above-described dynamic skill proficiency update is performed on the basis of “closed form” questions (such as those described above in connection with the skill assessment module 120), where the answer provided by the user can be objectively identified as “correct” or “incorrect” by the system (given that user selects from multiple answers, and the system knows the correct answer(s)). In addition, in some embodiments, the dynamic skill proficiency update may be performed based on analysis of answers to “open form” questions, where the user is requested to provide a written answer more detailed than a “yes” or “no”. When open-form questions are used, the answers of the user must be assessed in order to derive a “yes” or “no” answer. In these embodiments, the digital coach module 130 analyses the user answers by performing a similarity measurement between the answer of the user and the model answer generated by the LM 155 during the digital coaching session. The similarity measurement may then be used by the proficiency update model.

Different forms of similarity scoring may be performed. For example, keyword matching between the texts to be compared may be performed. Another example of similarity measurement could be using similarity scoring between the user's response and the correct answer based on their embeddings. This can be achieved using techniques like cosine similarity or other similarity measures. The higher the similarity score, the closer the user's response is to the correct answer. By calculating a similarity score based on embeddings, a more accurate similarity score is provided than a straightforward comparison of text, such as through keyword matching. For example, by comparing embeddings, semantic comparison is included within the text similarity. Additionally, any language barrier present in the answer of a user may be accounted for (such as when the vocabulary of a user in a given language is not as advanced as the vocabulary used in a the model answer, a high similarity score may nevertheless be calculated due to the intended meaning being determined from the embeddings).

To generate the simility measurement using embeddings, a language model may be provided with a prompt including the response of the user to a question together with a correct/model answer (e.g. previously generated by the language model alongside the question) and a request that a similarity measurement be performed between them. In a similarity measurement, the language model may tokenise and generate embeddings for two sets of input text to compare, and perform cosine similarity to assess the similarity between the two sets of input text. The similarity assessment may output a score between 0 and 1, indicating the level of similarity. For example, the similarity score may be generated by providing a request to an encoder-based LLM such as model 165 described above. Alternatively, the texts may be provided to a GPT model such as LM 155 with a request for text similarity be performed.

Once the digital coach module 130 has obtained the similarity score, the digital coach module can perform the dynamic skill proficiency estimation using a proficiency update model, based on the similarity score. In some examples, the proficiency update model uses the similarity sore as a parameter in the proficiency update model and/or determines one or more parameters based on the similarity score. Existing parameters for the proficiency update model already stored in the database 160 may be updated/revised based on the similarity score.

For example, the similarity score can be taken as a quantitative measure of how similar the user's answer is to the “perfect” answer, with higher scores indicate greater similarity.

When the similarity score is high, it suggests that the user's answer is very close to the correct answer. This reduces the likelihood that the correct answer was guessed. Similarly, a high similarity score suggests that the user understood the material well, reducing the likelihood that a mistake was made due to a slip.

Thus, in the Bayesian posterior probability inference model described above, the similarity score, s, may be used as P(D_{correct}|θ), i.e. the likelihood of correct response given mastery. The likelihood of an incorrect response given mastery (i.e. P(D_{incorrect}|θ)) may thus be taken as 1−s.

The similarity score can be used to modify other parameters, such as the guessing, P(G), and slipping P(S), probabilities. For example, when the user answers the question correctly, a higher similarity score would indicate a lower probability of guessing and slipping, thus providing a more accurate update of the mastery probability. When the user answers a question incorrectly, a higher similarity score would indicate a higher probability of guessing and a higher probability of slipping. Thus, the similarity score can be used to increase or decrease the BKT model parameters depending on the answer to the question by the user. For example, for a correct answer, P(G) can be adjusted as P(G)=P(G)*(1−s), and P(S) can be adjusted as P(S)=P(S)*(1−s). So for example, if the cosine similarity score is 0.8, the initial P(G) is 0.25 and initial P(S) is 0.1, then the adjusted P(G) is 0.25*(1−0.8)=0.05; and the adjusted P(S)=0.1*(1−0.8)=0.02.

The BKT parameters may be repeatedly updated as BKT is performed. That is, in a BKT process providing sequential skill proficiency update in a plurality of steps, for each step a skill proficiency level may be updated from a previous level from the previous step to a new level and at least one parameter may be updated from a previous value from the previous step to a new value. Thus, the BKT parameters will evolve with the user's understanding of the subject-matter, the estimation of the skill proficiency of the user is therefore more precise and can be arrived at more quickly.

In the above-described examples where one or more parameters of the skill proficiency update model are updated, the adjustment to one or more parameters may include a small positive bias value (e.g. 0.001 or 0.01). The small positive bias value is to ensure that the adjusted parameter does not become zero, which may prevent the model being correctly applied. In some embodiments, the parameters for the model are periodically reset to the initial model parameters (e.g. at the end of a set of questions).

In these examples, the similarity scores can be implemented by the proficiency update model to refine the parameters of the proficiency update model to improve the accuracy of skill proficiency update calculations.

In the above proficiency update models, the skill proficiency update is performed based on the model parameters and an indication that the user has answered the question correctly or not. In “open form” questions, whether a user has answered a question correctly may depend on a degree of correspondence between the model answer and the answer of the user. Thus, the similarity score may also be used to determine whether the user has answered the question correctly. For example, the digital coach module 130 may receive the similarity measurement, compare it to a threshold, and identify a similarity above the threshold as indicating the answer is “correct”. Thus, the digital coach module 130 is able to determine, for each question, if the answer is correct or not, even for open-form questions. The threshold may be, for example, 0.7, 0.8 or 0.9. Therefore, the similarity score is used both for user answer assessment but also for dynamically determining a skill proficiency update.

The above examples describe how the digital coach module can perform a dynamic skill update itself through analysis of the responses of the user. In some embodiments, the proficiency update answers are provided to the skill assessment module 120 so that the skill assessment module 120 can perform a skill proficiency update as described previously. In these embodiments, the skill assessment module 120 performs as described above, but instead of the answers being collected from the user in response to questions being provided to the user in a skill assessment session, the answers are those provided by the user during the dialogue session.

In these embodiments, the questions may be generated by the LM 155 to include parameters a, b, and c (for IRT models) or to include BKT probabilities (for BKT models). Alternatively, the skill assessment module 120 may simultaneously estimate the skill proficiency value θ and the item parameters for the new questions in the manner described above. The estimation of the theta values or the mastery values will depend on the parameters of the statistical model being used. For example, in the Rasch model, the difficulty parameter b, or in IRT the parameters a, b and c, and in BKT, the parameters P(T), P(S) and P(G). When the assessments are generated by the LM model for the dynamic skill proficiency update, the LM also generates the associated parameters and outputs them with each associated question.

Alternatively, the analysing of the proficiency update can be performed by the LM 155 based on a tailored prompt provided by the digital coach. For example, the digital coach generates a further language model prompt and provides the further prompt to the LM 155. The prompt includes the current proficiency level of the user for the identified skill, the proficiency update answers, a definition of a statistical model including parameters of the statistical model, and a request to analyse the proficiency update answers based on the statistical model to generate the revised proficiency level update. The statistical model provided to the LM 155 may be the models described above (e.g. BKT model or logistic model).

In the dynamic skill assessment update process, the skill assessment module 120 is provided with questions, correct answers and user responses that have been generated during the dialogue session and stored within record 212. The dynamic skill update may be performed using any one statistical model, or may be performed using a plurality of models. For example, a first skill proficiency update may be performed using the Bayesian posterior probability inference model for a first number of questions, and then BKT for a second number of questions. Alternatively, or additionally, a skill proficiency level may be determined using two different models and the two scores combined in a weighted average to result in a final skill proficiency update level.

Using a skill proficiency update model to perform the dynamic skill updates as described above provide improvements in accuracy and precision in performing skill updates ‘on-the-fly’, allowing for a more tailored user interaction with the digital coaching module 130. The content provided to the user is more targeted to the user's evolving skill, thus requiring fewer interactions with the digital coach module 130 and, correspondingly, the LLM. The skill proficiency update models that may be used are not limited to the particular examples described above, and alternative skill proficiency update models, algorithms, statistical models or computational models may be deployed that produce a revised skill assessment update based on an initial skill proficiency level and model parameters, where those model parameters may be determined or adjusted based on a degree of similarity between the answer of a user and a model answer to a proficiency update question.

As set out above, the skill proficiency may be updated at two stages in the performance of a dialogue method. First, the skill proficiency may be estimated using the skill assessment module 120 during a skill assessment operation 204 that is performed separately to the digital coaching session (this skill proficiency estimation identified as the ‘structured proficiency’ θ_{S}). Second, the skill proficiency may be estimated using the digital coach module 130 (which may query the skill assessment module 120 to perform the assessment) during a dynamic skill assessment performed during the digital coaching session, where LM-generated questions are used to update the skill proficiency ‘on-the-fly’ (this skill proficiency estimation is identified as the ‘dynamic proficiency’ θ_{D}). In some embodiments, the structured proficiency is simply replaced with the newly calculated dynamic proficiency level once it has been estimated, for example if the dynamic proficiency is understood to be as reliable an estimate as the structured proficiency (which may assumed given the questions generated by the LM are of high quality due to the customised prompt engineering methods to generate the questions).

In some embodiments, cross-module calibration is performed in which the dynamic proficiency and the structured proficiency are combined in a weighted manner. For example, a calibrated proficiency θ_{C} may be determined, where θ_{C}=w_{S}θ_{S}+w_{D}o_{D}, and where w_{S} are w_{D} are weights assigned to the structured proficiency and dynamic proficiency respectively. The weights may be assigned based on how reliable the measurements are considered to be. For example, if the Structured Proficiency process is considered to be more reliable, the weight w_{S} is higher than w_{D}. Alternatively, the weights may be allocated according to how recently either the dynamic or structured skill proficiency estimations have taken place. The calibrated proficiency level is stored within the database and used for digital coaching sessions in the same manner as described for the structured and dynamic proficiency levels as described herein.

An example dynamic skill proficiency update is set out below:
1. Initial Setup: User C is identified as having an intermediate proficiency level in the skill “project management”.
2. Dynamic Question Generation: During the digital coaching session, the LLM generates the question, “How do you handle conflicting deadlines in a project?”. The LLM also generates an ideal response, “I assess the impact of each task, consult with the team for insights, and adjust priorities based on project goals.”
3. User Response: User C responds, “I discuss with the team and stakeholders to determine which tasks are most critical.”
4. Embedding Similarity (for example, performed by an LLM):
   Convert both responses into vector embeddings.
   Calculate the similarity score between User C's response and the ideal response.
5. Bayesian Update:
   Initial proficiency distribution (centered around intermediate) is updated based on the similarity score, resulting in a posterior distribution with a higher probability towards the advanced level if the similarity is high.
6. Expectation Value: Calculate the expectation value from the posterior distribution, determining User C is now at an “intermediate-advanced” level.
7. Perform cross-module calibration to weight/adjust the skill proficiency level.
8. Database Update: Save the updated proficiency level, refining User C's profile for future coaching sessions.

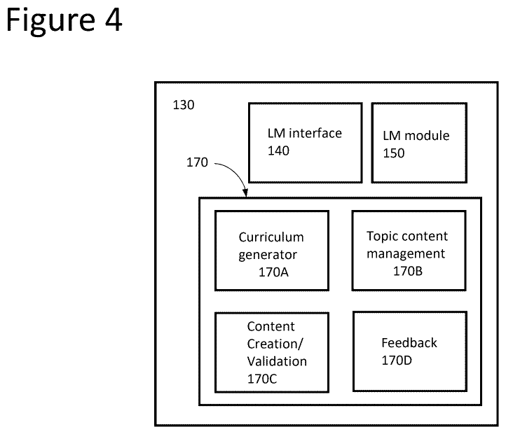

As shown in FIG. 4, the digital coach module 130 comprises one or more task modules 170. Each task module is configured to interact with the LM interface 140, and may also be configured to interact with each other. The task modules 170 are provided to generate, retrieve, provide or assess user input, existing content and knowledge or other information processed by the system in a manner to be described below in connection with each module. Each task module is configured to receive input information (for example from the user input) and is configured to prove an output, for example to user output. The input and output may additionally be provided from/to another task module of the plurality of task modules 170. The modularity of the dialogue system 100 allows for targeted queries to be forwarded to the LLM interface 140 by each module, thus providing flexibility and resource usage efficiency when performing the requested tasks.

Each task module may be represented in the form of interchangeable physical hardware, may be physically separate to each other and from other components of the dialogue system 100, and include one or more processors that execute program instructions to perform required tasks. Alternatively, each task module may represent a software module that is executed by the same core processor/processors of a single component. The steps taken by each task module described herein, as well as the LM interface 140, may be embodied in the form of computer-executable instructions that are performed when executed by a processor of a computing device. Each module may access or write to a database. These may be separate databases maintained for use by each module, or may refer to the same database (e.g. database 160).

Each task module is configured to generate a request for completion of a task that is passed to the LLM interface 140, which will process the request to format the request into a prompt for the LLM to extract the required response. For example, transformer-based LLMs are configured to accept natural language text blocks as input, and generate an output based on the text input. The prompt engineering module 145 may be configured to perform prompt engineering for any of the task modules, to prepare the prompts for that task module. As described above, pre-existing prompt schemas may be deployed to generate the prompts. Such prompt schemas may be pre-validated and curated using expert knowledge. Example prompts may include information extraction prompts (such as performing named entity recognition, or to extract token embeddings, or to perform text similarity), or a question-answer prompt, where an answer is requested in response to a question.

The dialogue system, the digital coach module 130, the LM interface 140 and each the task modules 170 are configured to perform internal communication operations synchronously or asynchronously. Asynchronous operation is used when there is an unconstrained response time from or between components, and different tasks may be processed at different times.

The one or more task modules 170 may include a curriculum generator module 170A that generates a curriculum for a given skill (such as a list of topics), a topic content management module 170B that identifies content (e.g. resources, questions and model answers) for a given topic for use in a digital coaching session, a content creation/validation module 170C to acquire content (either generating content using a language model or receive content from validators) to be used for a digital coaching session (including learning resources, questions and model answers), and a feedback module 170D (configured to generate feedback for presenting to the user). The content creation/validation module 170C is also configured to perform content validation procedures.

The curriculum generator 170A is configured to identify a curriculum for a skill to be learned by a user. The generated curriculum includes a plurality of topics associated with the question. Each topic may be generated with a proficiency level/difficulty level. The acquired curriculum may be presented to a user of the dialogue system 100, or may be utilized by the digital coach module 130 during execution of a digital coaching session 200 as described above. The skills curriculum generation can be performed asynchronously with other operations of the dialogue system 100.

The topics in a generated curriculum may be arranged in a step-by-step order as a structured learning pathway (e.g. a sequence of topics to be presented to the user, such as during the interactive coaching session as described above). The topics that are selected as part of a curriculum are the topics required to learn a particular skill with a desired proficiency level. For example, information defining the structured learning pathway may be included in the question selection data previously described.

The curriculum may be generated by an LLM or may be retrieved from a database. When the curriculum is to be generated by an LLM, the curriculum generation module 170A is configured to communicate with the LLM interface 110, through prompt engineering methods, to retrieve a topic list needed to acquire a particular skill.

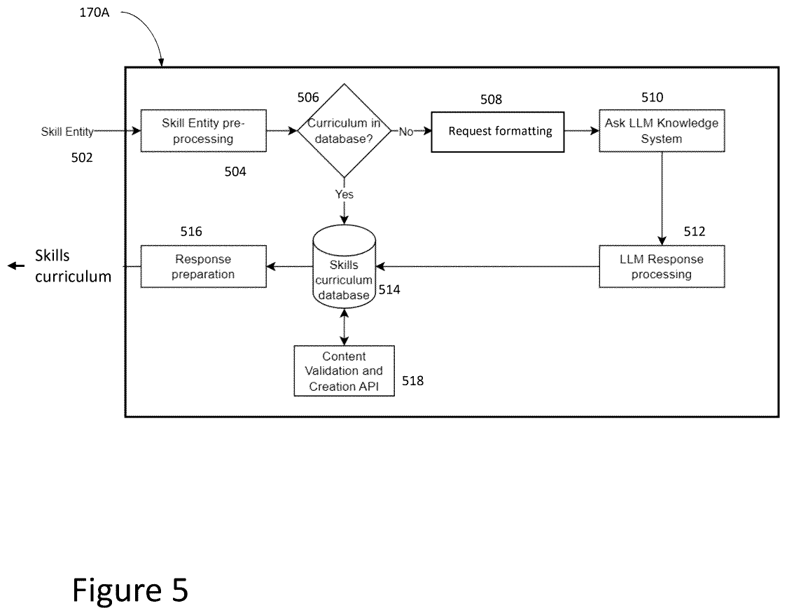

FIG. 5 illustrates a process of the curriculum acquisition module 170A, in accordance with some embodiments. The curriculum acquisition module 170A is configured to receive an input 502. The input 502 may be received from the user, or may be received from another component of the digital coach 130, such as another task module of the one or more task modules 170. The input 502 includes skill information that identifies a ‘skill entity’, being a skill that is to be learned by the user. Skill information may include skill name (e.g. “Cost Accounting”) and/or Skill Embedding. Skill Embedding allows for accurate identification of a skill when a skill name is ambiguous and/or depends on a skill context.

At step 504, the curriculum generator 170A is configured to pre-process the skill information. The preprocessing may include processing to clean and format the text, such as correcting grammar, correcting typos, removing line or page breaks.

At step 506, the curriculum generator 170A is further configured to determine whether a curriculum for the skill is already in a database 514 accessible by the curriculum generator 170A. For example, the curriculum generator 170A may execute a text matching algorithm to determine if the text defining the skill entity in the input 502 matches a text entry defining a skill curriculum in the database. If a curriculum does already exist, the curriculum can be immediately retrieved without using the LM interface 140. By using an existing curriculum, the system's latency can be reduced and required computing resources can be minimised.

At step 508, the curriculum acquisition module 170A is further configured to perform request formatting. In this step, a request may be prepared for sending to the LM interface 140, and formatted for processing by the LM interface 140. For example, the request may be prepared to include information on the skill, and information to indicate a curriculum is to be created. This information allows the prompt engineering module 145 to create a prompt for presentation to an LM to generate the curriculum.

At step 510, the curriculum acquisition module 170A is further configured to send the request to the LM interface 140. The request acts as an input to the LM interface 140, which functions as described above in connection with FIG. 3. This stage of the curriculum acquisition module 170A is an interaction point with the LM interface 140, where the curriculum acquisition module 170A sends a request and waits asynchronously for the response. An example interaction with an LLM is given below:
Example prompt:
“What learning path can you recommend to learn Cost Accounting? Extract skills only and add difficulty level for each skill.”
Response:
“Certainly! Here are the skills required to learn cost accounting, along with
their corresponding difficulty levels:
Cost Terminology and Concepts—Easy
Cost Classification—Easy to Moderate
Cost Behavior Analysis—Moderate
Cost-Volume-Profit (CVP) Analysis—Moderate
Cost Estimation and Costing Methods—Moderate to Difficult
Job Costing—Moderate to Difficult
Process Costing—Moderate to Difficult
Activity-Based Costing (ABC)—Moderate to Difficult
Standard Costing—Moderate to Difficult
Variance Analysis—Moderate to Difficult
Cost Allocation—Moderate to Difficult
Cost Control and Cost Reduction—Moderate
Decision-Making using Cost Information—Moderate to Difficult

At step 512, the curriculum acquisition module 170A is further configured to receive the output of the LLM from the LM interface 140 and process the LLM output. In this step, the response from the LM interface 140 is processed in order to adhere to the Skills Curriculum Database format. For example, an LLM can output too verbose responses. Thus, parsing or cleaning may be performed. Semantic analysis may also be needed to match generated topic names with existing ones.

Following processing, at step 512 the list of topics and associate skill levels are inserted into skills curriculum database 514 in a format that defines an association with a particular skill. The curriculum database 514 may the same database 160 as described previously, may form a part of that database, or may be a separate database. The insertion into the skills curriculum database 514 may include the generation of a new entry and/or may include the update of an existing entry. For example, if the LLM outputs that a particular topic is required for learning of a skill, but the skills curriculum database 514 already lists that topic as related to another skill, the skills curriculum database 514 may be updated to list the topic as required for both skills.

The skills curriculum database 514 is configured to store and retrieve the skills curriculum.

The following information may be stored in a skills curriculum entry:
Topic name
Topic difficulty/proficiency level
Topic relation with a skill. This may be a many-to-many relation.
Meta-data including generation time, method and other diagnostic information.

As the curriculum database 514 contains only many-to-many relations with properties, it can be implemented using graph structure type. Example graph databases include: Neo4j, Amazon Neptune or MemGraph.

At step 516, the curriculum acquisition module 170A is configured to generate a response to the initial input as an output of the acquisition module 170A. The response includes the curriculum generated by the LLM, or retrieved from the database if the curriculum has already been generated.

The curriculum generator module 170A may further comprise an additional input/output interface, such as a content validation and creation API 518. The interface provides access (e.g. Create-Read-Update-Delete-like (CRUD-like) access) to the skills curriculum database 514 from an external component. It facilitates visualization of skills curriculum and allows for creating, moving, deleting, voting, editing the structure. For example, through API 518, the content creation/validation module 170C may access the skills curriculum database 514 to allow content creators to modify the structure of the skills curriculum, and/or to allow validators to validate the skills curriculum database (including validation of the topic names) in a manner that will be described below.

The question selection data may include a generated skills curriculum, which includes a list of topics in defined order as a structured learning pathway. Once the proficiency level of the user for a topic has reached a first threshold, the digital coach module 130 may then mark the topic as completed and move onto the next topic in the curriculum as indicated in the structured learning pathway. The continued use of the dialogue system 100 allows for ongoing monitoring of user proficiency level, and the user may be presented questions (either the same questions previously asked or new questions) in connection with a previously completed topic and revise the skill proficiency level, which may lead to a drop in the skill proficiency level. If the skill proficiency level of a completed topic subsequently drops below the threshold, the digital coach module 130 may then update the status of the completed topic as incomplete and then once more present questions and resources regarding the previous incomplete topic.

During subsequent interactions with the user, the generated curriculum may be referred to by the skill assessment module 120 and the digital coach 130 to guide the order in which assessments are provided and/or the progress of a digital coaching session.

As indicated above, the skill proficiency of a user can be determined for a collection of topics. In the embodiments where the digital coach module 130 selects questions based on the learning pathway of the skills curriculum, the skill proficiency calculation can be based upon the completion of the topics listed in the skills curriculum. In these embodiments, the weighted calculations described previously are calculated across the list of topics given in the skills curriculum (including those provided for the different proficiency levels). The overall skill proficiency level of the user is thus based on how much of the learning pathway has been completed, and the proficiency with which the user has completed each stage of the learning pathway.

The topic content management module 170B is configured to acquire and save resources for topics and skills. A resource may be a single piece of information in the form of articles, multimedia, diagrams, flashcards etc. A resource may be provided to a user as part of a digital coaching session in connection with an identified skill and topic. Content (including questions presented during the digital coaching session) presented to the user may be related to a presented resource. In this manner, the evaluation that may be performed by the digital coach module 170B of answers to provided questions includes the evaluation of the user's internalization level of a particular resource that is associated with a particular topic and/or skill.

Each topic may have a group of related resources. The resources may include two types of resource—a base resource and an additional resource. A base resource is a textual representation of the dialogue system's knowledge about a particular topic. It acts as a main source during coaching session interaction and can provide a context for prompts, including questions and answers. The base resource can be presented to the user as a whole, or can be divided into chunks or portions to avoid presenting too much information for the user at once. An additional resource includes multimedia content used to enhance the learning process. An additional resource can include a picture, diagram, video, audio clip and/or a link to external resources. The questions for a topic may be related to the base resource by associating one or more questions with a single resource portion or chunk of the base resource or one or more additional resources. In this manner, in a single iteration of the coaching session the user is only presented with questions and resources that are related to each other.

To assist the user in the coaching session, important terms, persons or dates may be highlighted in the resource as highlighted entities. The highlighted entities can be determined by a Named Entity Recognition, for example. The highlighted entities can be stored in a user profile, to present current knowledge in a form of word cloud.

FIG. 6 illustrates a process of the topic content management module 170B, in accordance with some embodiments. The topic content management module 170B is configured to receive an input 602. The input 602 may be received from the input 140A or may be received from another task module of the one or more task modules 130. The input may include topic information that identifies a topic for which content is to be acquired as part of the digital coaching session. Other input information may include information that identifies the subject-matter for which the content is to be provided (e.g. skill or a specific resource for which supplementary material is required, such as questions relating to a resource). Topic information may include a topic name (e.g. “Cost Terminology and Concepts”) and/or topic embedding. Topic embedding allows for accurate identification of a topic when a topic name is ambiguous and/or depends on a topic context. The content to be acquired may be one or more of a resource for the topic, a question related to the topic (and optionally also related to the resource for the topic), and an answer to the question.

At step 604, the topic content management module 170B is configured to pre-process the topic information. The preprocessing may include processing to clean and format the text, such as correcting grammar, correcting typos, removing line or page breaks.

At step 606, the topic content management module 170B is further configured to determine whether a resource for the topic is already in a topic content database 614. If a resource does already exist, the resource can be immediately retrieved without using the LM interface 140. By using an existing resource, the system's latency can be reduced and requiring computing resources can be minimised. The topic content database 614 may be the same database as the curriculum database 514 described above.

At step 608, the content management module 170B is further configured to perform request formatting. In this step, a request may be prepared for sending to the LM interface 140, and formatted for processing by the LM interface 140. For example, the request may be prepared to include the topic information, and information to indicate that content is to be created (e.g. questions/answers or learning resources). This information allows the prompt engineering module 145 to create a prompt for presentation to an LM to generate the curriculum. The request sent to the LM interface 140 may further comprise a skill proficiency level or difficulty level for the requested resource, thus allowing generation of content for a variety of difficulty levels to “plug the gap” in any skill curriculum.

At step 610, the topic content management module 170B is further configured to send the request to the LM interface 140. The request acts as an input to the LM interface 140, which functions as described above in connection with FIG. 3. This stage of the topic content management module 170B is an interaction point with the LM interface 140, where the topic content management module 170B sends a request with a prompt and waits asynchronously for the response. An example interaction with an LLM is given below:
PROMPT: You are an experienced teacher. You are asked to write a lesson about accounting which helps your student understand the topic on an intermediate level. Do it in a first-person form using a simple language.

LLM:

Hi there! I'm delighted to be your teacher and guide you through the fascinating world of accounting. Today, we will embark on a journey to understand the basics of accounting and lay a strong foundation for your intermediate-level learning. So, let's dive in!

What is Accounting?

Accounting is the language of business. It helps us keep track of financial information, make informed decisions, and understand the financial health of an organization. In simple terms, accounting involves recording, summarizing, analyzing, and reporting financial transactions.

The Accounting Equation:

To get started, let's explore the fundamental concept of the accounting equation. It's like the building block of accounting. The equation is:

$$Assets = Liabilities + Equity$$

Assets are the things a company owns, like cash, buildings, equipment, or inventory. Liabilities represent the company's debts or obligations to others, such as loans or accounts payable. Equity represents the owners' claim on the assets, and it's the residual interest after deducting liabilities from assets.

Types of Accounts:

Now, let's discuss the different types of accounts in accounting. We have three main categories:

Assets: These are resources owned by a company. They can be tangible, like cash or inventory, or intangible, like patents or copyrights.

Liabilities: These are the obligations a company owes to others, such as loans or accounts payable.

Equity: Equity represents the owners' investment in the business. It includes capital contributed by owners and retained earnings, which are the profits the company has earned and kept.

Double-Entry Bookkeeping:

Accounting uses a system called double-entry bookkeeping to record transactions accurately. This system ensures that every transaction has at least two entries: a debit and a credit.

Debits: Debits increase assets and decrease liabilities and equity accounts.

Credits: Credits decrease assets and increase liabilities and equity accounts.

Remember, every transaction must maintain the accounting equation balance, which means the total debits must equal the total credits.

Financial Statements:

Financial statements are the end results of the accounting process. They provide a summary of a company's financial position and performance. The main financial statements are:

Balance Sheet: This statement shows the company's assets, liabilities, and equity at a specific point in time.

Income Statement: It summarizes the company's revenues, expenses, and net income or loss over a specific period.

Cash Flow Statement: This statement tracks the inflows and outflows of cash, helping us understand the cash position of the company.

Key Ratios and Analysis:

Lastly, let's touch upon financial analysis. Ratios and analysis help us interpret financial information and evaluate a company's performance. Some important ratios include:

Profitability ratios: Measure the company's ability to generate profits.

Liquidity ratios: Indicate the company's ability to meet short-term obligations.

Solvency ratios: Assess the company's long-term financial health and ability to repay debts.

Conclusion:

Congratulations! You've completed your first lesson on intermediate-level accounting. Today, we covered the basics, including the accounting equation, types of accounts, double-entry bookkeeping, financial statements, and key ratios for analysis. Understanding these core concepts will serve as a solid foundation as we delve deeper into the exciting world of accounting. Stay curious and keep learning!

PROMPT: Ask 10 questions to evaluate the understanding of this topic and give exemplary answers

LLM:

What is the accounting equation, and why is it important?

Example answer: The accounting equation is Assets=Liabilities+Equity. It is important because it provides the foundation for recording and balancing financial transactions, ensuring that the equation remains in balance.

Name the three main types of accounts in accounting and provide an example for each. Example answer: The three main types of accounts are assets (e.g., cash, inventory), liabilities (e.g., loans, accounts payable), and equity (e.g., owner's capital, retained earnings).

Explain the concept of double-entry bookkeeping.

Example answer: Double-entry bookkeeping is a system in which every transaction is recorded with at least two entries: a debit and a credit. This system ensures that the accounting equation remains in balance.

How does a debit entry affect asset and liability accounts?

Example answer: A debit entry increases asset accounts and decreases liability accounts.

What is the purpose of the balance sheet in financial statements?

Example answer: The balance sheet provides a snapshot of a company's financial position at a specific point in time, showing its assets, liabilities, and equity.

Define the income statement and its purpose.

Example answer: The income statement summarizes a company's revenues, expenses, and net income or loss over a specific period. Its purpose is to show the profitability of the business.

What does the cash flow statement track, and why is it important?

Example answer: The cash flow statement tracks the inflows and outflows of cash in a company. It is important because it helps assess the company's liquidity and cash position.

Name one profitability ratio and explain its significance.

Example answer: One profitability ratio is the gross profit margin. It measures the percentage of revenue that remains after subtracting the cost of goods sold. A higher gross profit margin indicates better profitability.

What do liquidity ratios measure, and why are they important for a company?

Example answer: Liquidity ratios measure a company's ability to meet short-term obligations. They are important because they show the company's liquidity and its ability to pay its bills and debts on time.

Explain the purpose of solvency ratios and provide an example.

Example answer: Solvency ratios assess a company's long-term financial health and its ability to repay debts. One example is the debt-to-equity ratio, which measures the proportion of debt financing relative to equity. A higher ratio may indicate higher financial risk.

At step 612, the topic content management module 170B is further configured to receive the output of the LLM from the LM interface 140 and process the LLM output. In this step, the response from the LM interface is processed in order to adhere to a content presentation format. For example, an LLM can output too verbose responses. Thus, parsing or cleaning may be performed. The LLM may retrieve and output the resource itself, or may indicate a location where the resource may be found. Where a resource location is identified instead of the resource being reproduced, the topic content management module 170B may retrieve the resource from the location. Following processing, the content is inserted into the topic content database.

The insertion into the topic resource database 614 may include the generation of a new entry and/or may include the update of an existing entry. For example, if the LLM outputs that a new resource for the topic, a new entry may be created, but if a newer version of an existing resource is created, the existing resource entry may be updated/replaced.

At step 616, the topic content management module 170B is configured to generate a response to the initial input as an output of the topic content management module 170B. The response includes the acquired resource, and is prepared with error handling and monitoring.

The topic content management module 170B may further comprise an input/output interface, such as a content validation and creation API 618. The interface provides access (e.g. Create-Read-Update-Delete-like (CRUD-like) access) to the topic resource database. It facilitates visualization of the topic content and allows for creating, moving, deleting, voting, editing the structure. For example, through API 618, the content creation/validation module 170C may access the topic content database 614 to allow content creators to modify the database entries, and/or to allow validators to validate the topic content database in a manner that will be described below. Thus, any topic information (e.g. topic name) input may therefore be validated before being input into the topic content management module 170B are validated.

In some embodiments, the topic content management module 170B may receive a request to create personalised resources for a user during that user's digital coaching session. The personalised content may include learning resources and/or personalised questions and answers. The personalised content is tailored to the current skill and proficiency level of the user and/or based on the previous interactions of the user during the digital coaching session. In these embodiments, the request 602 includes a request for generation of personalised content together with user skill proficiency information or a data record of previous dialogue interactions between the user and the digital coach 130. The user skill proficiency information may include the current skill level of the user, the skill level percentile of the user (among the population of users), but can also include sets of parameters for the statistical module used to assess the questions that the user has previously answered in the skill assessment module. For example, the parameters can include the average difficulty, average discrimination and average guessing of the assessments the student has already taken. The prompt engineering module 145 generates a personalised prompt including the above information and provides it to the LM as a language model request. As a result, the language model returns a response including the requested personalised resources. For example, this method may be used to generate the assessment questions that are to be provided to the user during the dynamic skill assessment process. The assessment questions generated this way are therefore generated to be tailored to target the current skill level of the user, thus resulting in more accurate dynamic assessments of the user during the digital coaching session.

In some embodiments, the topic content management module 170B is in communication with the skill curriculum acquisition module 170A. For example, the topic name input as part of the request 602 may be a topic identified in a skills curriculum. In some embodiments, in response to a new topic being added to a skill curriculum, the curriculum generator module 170A transmits a resource request to the topic resource management module 170B, to generate a topic resource database entry for the newly added topic. In some embodiments, the topic resource management module 170B is regularly provided with requests from the dialogue system 100 to update the topic resources.

The content creation/validation module 170C is configured to generate resources, questions and answers for presentation to the user by the digital coaching module 170C.

The content creation/validation module 170C may comprise a database or storage means in which content may be stored for access by the dialogue system 100. For example, the database may be accessible by the topic content management module 130C, such that the content retrieved and placed inside the topic content database, as described above, are retrieved from the database of the content creation module 170C. Thus, the content stored in the topic content database may be generated “on the fly” during a digital coaching session, using the topic content management module 130C, or may have been previously generated by the content creation module 170C. The database may be the shared database 160.

The modules 170A and 170B of the dialogue system 100 together provide the means to generate a full skills curriculum including a list of topics in a learning pathway, with generated resources, questions and model answers for each topic.

The content creation/validation module 170C may also be used to generate resources and answers to the questions for presentation to the one or more LLMs, to improve the accuracy of the output of a selected LLM when processing requests related to a topic related to the resource. For example, the accuracy of an LLM-generated answer to a question may be improved by providing resources to the LLM to aid the LLM in generating the answer. For example, this is performed as part of a knowledge retrieval mechanism, where the content is provided alongside a prompt to the LLM as context for the prompt.

The knowledge retrieval mechanism approach has the advantage of providing content traceability, where it is possible to monitor the usage of a particular resource. It is also possible to directly evaluate the content being used in each prompt and diagnose any associated errors. In addition, by storing the resources in the database, it is not necessary to use LLM for every presentation of the content to the user. This reduces latency, and resource consumption resulting from use of an external LLM API.

In the knowledge retrieval mechanism, the resource may also be retrieved from the database by the digital coach module 130 during execution of a coaching session. For example, when subject-matter for a skill/topic is selected during the digital coaching session, the digital coach module 130 queries the database to identify if there is an associated resource and retrieves the associated resource. The retrieved resource may then be provided by the digital coach module 130 as part of a prompt provided to the LM 155 as additional context for that request. For example, the retrieved resource may form part of request 1002 in FIG. 3 and the prompt engineering module 145 may incorporate the retrieved resource into the prompt through selection of a prompt template with a field that can be populated by a resource.

Alternatively, or additionally, the retrieved resource be presented to the user via the output 140B as part of the digital coaching session in the manner described above.

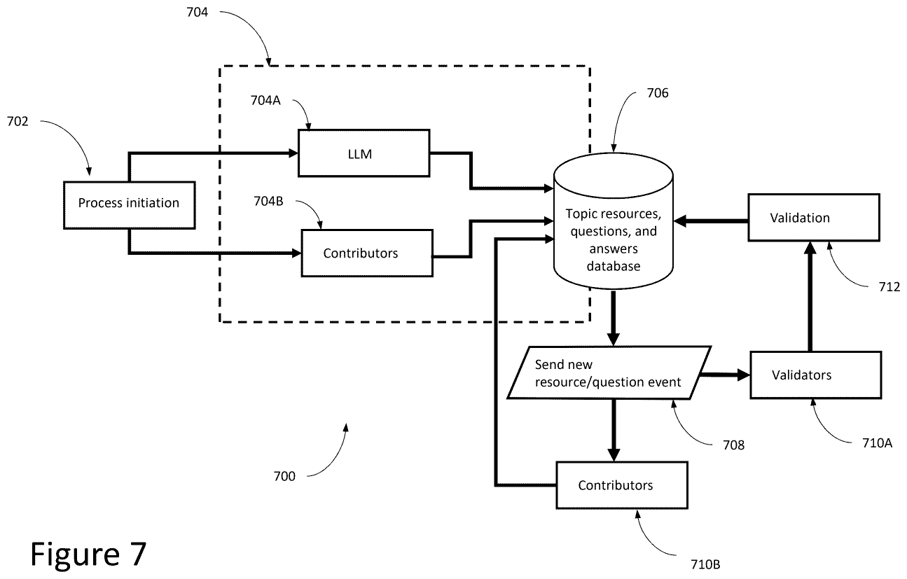

FIG. 7 illustrates a process of the content generation module 170C for resource generation, in accordance with some embodiments. At step 702 the resource generation process is initiated. The resource generation process may be initiated in response to a new topic being created in the skills curriculum. In alternative embodiments, the process may be initiated in response to a prompt from a user specifying a topic, or the process may be initiated in response to a topic being identified that does not have an associated resource or that a topic requires a resource. The process is performed automatically without direct user interaction, with the resources preferably being prepared before the user begins any interactive coaching session with the digital coach module 130. However, in other implementations, the digital coach module 130 may initiate resource creation during a coaching session (such as when the digital coach module 130 identifies that a topic is missing a resource, or an additional resource is required such as a resource to be provided as feedback to the user).

At step 704, resources are generated or acquired and stored in a topic resources, questions and answers database 706. In step 704A, a resource is generated by an LLM, via a content generation request forwarded to the LM interface 140. For example, resources can be generated using module 170B as described above. Alternative versions of the same resource can be submitted depending on the user's learning style. Prompts like “Explain to me like I'm ten years old” or “Explain to me as I am the professional engineer” can be used to get various styles and complexity for the generated resource. Such additional prompts may be included in the prompt templates referenced by the prompt engineering module, or may be specified by module 170B or 170C. Requests to generate the same resource in different languages may also be used, or requests to include illustrations or resources with accompanying audio. Additionally, an external text-to-image language model can be used to generate images. Models like DALL-E can be used for this purpose. Those images can be stored in the resource database for future reference to limit external API usage.

Along with generation of a resource, the LLM may calculate vector embeddings of generated resource and store the vector embeddings in a Vector Database that forms part of the database 706. The embeddings may then be used for a future similarity search.

At step 704B, resources may instead be generated by contributors to the system, and inserted into the database 706. Content created by contributors may also be provided to the LM interface 140 as part of a prompt to generate supplementary material or alternative versions of the content such as those described above.

Generated resources may be divided into “chunks” or smaller constituent parts. This may be useful to isolate certain context within a larger resource to enhance prompt performance, but also to conduct more interactive coaching sessions (e.g. when a larger resource is divided into parts, and each part is presented to a user in order with associated questions). In the situation where the resource creation was initiated by the digital coach module 130 during the coaching session, the resource may be output to the digital coach module 130 during the same coaching session. Thus, module 170C allows for resource creation “on-the-fly” during the coaching session.

A data entry in the database may be created that connects a particular topic name with a database entry containing all relevant information to acquire a particular topic. Each entry may include a unique identifier, author information, usage information and voting points from validators.

In some embodiments, the content generation module 170C may be configured to perform version control, in which validators are queried to validate newly added knowledge. The version control process comprises step 708, in which an event is sent from the content generation module 170C to other components of the dialogue system 100 and to external devices of validators 710A as a notification that a new resource has been created and added to the system. A notification may alternatively or additionally be sent when a new topic has been created, inviting the validators to validate resources already present in the database in association with the topic.

The content generation module 170C is also configured to create questions for resources. The process for creating questions follows the same steps as the process for creating resources, as illustrated in FIG. 7. In some embodiments, the process for creating questions may be initiated upon creation of a new resource and/or upon creation of a new topic. Alternatively, the process may be initiated by a user or a contributor specifying an existing resource for question creation. The process may also be initiated by the digital coach module 130 during execution of a coaching session (for example, upon identification of a topic or a resource for which there are currently no questions or where additional questions are desired).

At step 704, the process comprises generating 704A a question by prompting the LM interface 140. Example prompts for generating answers are provided above in connection with topic content management module 130C. In addition, when communicating with the LM interface 140, the content creation module may take the resource and prompts LLM for questions about a particular resource's chunk. Example: “You are a teacher. Ask 10 questions about the following text: [resource chunk here]”. The prompt may include a request to generate the questions at a required complexity/proficiency level. The generated questions may thus include information about the required proficiency level of the question.

At step 704B, questions may instead be generated by contributors to the system, and inserted into the database 706. Questions created by contributors may also be provided to the LM interface 140 as part of a prompt to generate supplementary questions or alternative versions of the content such as those described above.

Each generated question is stored in the database 706. The generated question may be stored with an identifier indicating that it is associated to the resource for which it has been generated and/or with a topic to which it is to be associated. The identifier may also indicate that the question is to be associated with other resources that are stored in the database 706. The resources that are associated with the generated question may be presented to the user alongside the question during a coaching session and/or may be presented alongside the question and the user's answer to establish additional context. In the situation where the question creation was initiated by the digital coach module 130A during the coaching session, the question may be output to the digital coach module 130A during the same coaching session. Thus, module 170C allows for question creation “on-the-fly” during the coaching session.

In a manner similar to the resource creation, the content generation module 170C may be configured to perform version control for the generated questions, in which validators are queried to validate newly added questions. The version control process comprises step 708, in which an event is sent from the content generation module 170C to other components of the dialogue system 100 and to external devices of validators 710A as a notification that a new question has been created and added to the system. A notification may alternatively or additionally be sent when a new topic has been created, inviting the validators to validate questions already present in the database in association with the topic.

The above-described question creation and validation process may be applied to both closed-form and open-form question types.

The content generation module 170C is also configured to create answers to questions. The process for creating questions follows the same steps as the process for creating resources, as illustrated in FIG. 7. In some embodiments, the process for creating answers may be initiated upon creation of a new question. Alternatively, the process may be initiated by a user or a contributor specifying an existing question for which an answer is required. The process may also be initiated by the digital coach module 130 during execution of a coaching session in reply to a user question or user input.

At step 704, the process comprises generating 704A an answer by either prompting the LM interface 140. When communicating with the LM interface 140, the content creation module prompts LLM in the same manner as described above in connection with FIG. 2. Example prompts for generating answers are provided above in connection with topic content management module 170B.

At step 704B, answers may instead be generated by contributors to the system, and inserted into the database 706. Answers created by contributors may also be provided to the LM interface 140 as part of the prompt to request an answer to the question.

Each generated answer is stored in the database 706. The generated answer may be stored with an identifier indicating that it is associated to the question that was asked to generate the answer. The identifier may also indicate that the answer is to be associated with resources that are stored in the database 706. The resources that are associated with the generated answer may be presented to the user alongside the answer during feedback in a coaching session.

In a manner similar to the resource creation, the content generation module 170C may be configured to perform version control for the generated answers, in which validators are queried to validate newly added answers. The version control process comprises step 708, in which an event is sent from the content generation module 170C to other components of the dialogue system 100 and to external devices of validators 710A as a notification that a new answer has been created and added to the system.

The content generation module 170C is also configured to create a skills curriculum. A skills curriculum is as described above, and can include a list of topics. The process for creating a skills curriculum follows the same steps as the process for creating resources, as illustrated in FIG. 7. In some embodiments, the process for creating a skills curriculum may be initiated upon creation of a new skill entity in the dialogue system 100. Alternatively, the process may be initiated by a user or a contributor specifying an existing skill entity for which a skills curriculum is required. The process may also be initiated by the digital coach module 130 during execution of a coaching session in reply to a user input naming or selecting the skill entity.

At step 704, the process comprises generating 704A a skills curriculum, for example through use of the module 170A.

At step 704B, a skills curriculum may instead be generated by contributors to the system, and inserted into the database 706. One or more skills curricula created by contributors may also be provided to the LM interface 140 as part of the prompt to request a skills curriculum.

Each generated skills curriculum is stored in the database 706. The generated skills curriculum may be stored with an identifier indicating that it is associated to the skill entity that was asked to generate the skills curriculum.

In a manner similar to the resource creation, the content generation module 170C may be configured to perform version control for the generated skills curricula, in which validators are queried to validate newly added curricula. The version control process comprises step 708, in which an event is sent from the content generation module 170C to other components of the dialogue system 100 and to external devices of validators 710A as a notification that a new skills curriculum has been created and added to the system.

A validator is a user of the system who may submit validation responses to the dialogue system 100. A validator may be an individual registered as an expert in the topic related to the resource. Validators 710A may access the resources, questions, answers and curricula present within the database 706 (including resources, questions, answers and curricula generated by the module 130C) and evaluate each resource, question, curriculum and/or answer using a voting system as part of a validation process 712. The validators 710B can see the generated curriculum, resources and questions and are able to conduct a test coaching session of the digital coach module 130A to see the performance of the system in a real learning setup. In the voting system, each validator is able to indicate a score for the resource, question, curriculum and/or answer to assess its suitability. The score may be a binary score (e.g. ‘0’=unsuitable; ‘1’=suitable), or may be a continuous score indicating the degree of suitability (e.g. on a scale from 0 to 1). The validators may also indicate their vote for the skill level for the resource, question and/or answer. In this manner, the proficiency level of each resource question and/or answer is also validated to ensure that the validated content of the appropriate difficulty/skill level is used in digital coaching sessions for a user of a given proficiency level. If enough votes indicate the resource/question/answer/curriculum as being unsuitable (e.g. the average vote fails to reach a specified threshold), then the resource/question/answer/curriculum is not made available to the digital coach module 130A.

In addition, contributors 710A may be invited to make modifications to the newly created resource, question, curriculum and/or answer (or any other resource, question, curriculum and/or answer in the database 706). Step 708 may further comprise sending an event to the external devices of registered contributors of the dialogue system 100. Contributors can edit the resource, question, curriculum and/or answer by adding a new resource/question/answer version to the system. This version may also be assessed by validators in a process as described above. There can be multiple versions of the same resource, question, curriculum and/or answer in the system, each with a certain amount of “votes”. For each resource, question, curriculum and/or answer, the highest voted version is the “official” one and is used during coaching session.

When there exists multiple resources for the same topic, the resource/question/answer with the highest score is marked as the “base resource” and thus selected for use within coaching sessions of the dialogue system 100. When an authorised resource/question/answer is used during a coaching session, its usage information in the database is updated.

The origin of a resource/question/answer/curriculum may be flagged by the module 170C. For example, the origin may be flagged as LLM-created; contributor-created; LLM-created and contributor-edited.

When contributor content is used, content may only be accepted from contributors authorised to contribute to the system. For example, each contributor has a list of skills with a proficiency level assigned to them. The list grants access to a Content Creator platform.

The content creator platform is configured to allow interaction with authorised contributor. For example, when accessing the platform an authorised contributor is presented with a list of skills assigned to them. The list contains proficiency level and information about knowledge completeness of the system, number of topics, resources etc. Each skill contains a topic list with an indicator of quantity and quality of the material currently stored in the system. Contributors can add, remove and rearrange topics and its content—every change is logged for approval through a version control process as described above. Each topic has one main resource—the knowledge source for the system. Additional resources may also be added. Additionally, each topic has list of questions to be asked during the learning process. The contributor also has access to a “test session” to check and validate the changes.

When validators are used, contributions to the validation process may be only be accepted by authorised validators. For example, each validator has a list of skills with a proficiency level assigned to them. The list grants access to a validation platform. The validation platform is configured to allow interaction with authorised contributor. For example, when accessing the platform a validator operates on the changes of the resource and questions database. The change can occur when a contributor or LLM commits changes to the database. The validator may be presented with a list containing skills and topics to be validated.

Validators can perform trial coaching sessions to validate a particular topic. Along the coaching session, source materials (resources) can be presented and the validator can review them in the form of a comment. Validators can vote for rejection or approval of the resource, as well as evaluate the coaching session to give feedback to the authorised contributors that have contributed to the topic. The validators may be provided one vote per topic. Validators can be reminded about a new topic which corresponds to the validator's competences. Validators can be provided with the option to insert messages relating to the content into a data record, to be reviewed by the contributor.

In some embodiments, as a result of using the dialogue system 100 to increase proficiency in a chosen skill, a user of the dialogue system 100 can be invited to become a contributor and/or a validator. For example, the list of skills and proficiency provided in the user profile that is used by the digital coach module 130A may also be referenced by the content creation platform and validation platform as a list to authorise access. Access as a contributor may be authorised by comparison of the user proficiency level(s) meeting a first criterion (e.g. a first threshold value), and access as a validator may be authorised by comparison of the user proficiency level(s) meeting a second criterion (e.g. a second threshold value). The threshold to become a validator may be higher than the threshold to become a contributor.

The resource generation process may be performed prior to the initiation of a coaching session, so that resources required by the coaching session are ready to be accessed by the digital coach module 130A during the coaching session without delay. In some embodiments, the resource generation process may be initiated during the coaching session in response to a request from the digital coach module 130A. For example, if it is identified that a selected question or the topic of a selected question does not have an associated resource, the digital coach module 130A may send a request to the content creation and validation module to create and validate the resource. The resource creation and validation may occur in parallel with a coaching session, and the generated and validated resources may be accessible for future coaching sessions.

The module 130D of the dialogue system 100 thus provide the means to generate a full and validated skills curriculum including a list of topics in a validated learning pathway, with validated resources, questions and model answers for each topic in the learning pathway.

As mentioned above, the dialogue system 100 is configured to generate prompts as part of requests being forwarded to the LLM query system. These prompts may be generated with prompt engineering based on pre-existing prompt schemas that have been created and are maintained in a database. Different prompt schemas may be provided for different tasks to be performed by the system. The tasks modules described herein, when generating prompts, may refer to the database of pre-determined prompt schemas and generate a prompt based on a chosen schema.

Prompt engineering methods may include the following: Context Setting: Prefaced prompts with context such as “As a career coach, . . . ” to guide the model.

Question Structuring: Using a structured format for questions to limit answer scope.

Answer Format: Specified the desired format for answers.

Multi-Step Prompts: Use chained prompts for more complex queries.

An example is provided below for an objective of the digital Coach to prepare a list of questions and potential answers for an upcoming coaching session.

Step 1: Context Setting

The Digital Coach Engine automatically generates a context-setting statement to guide the LLM:

“As a career coaching expert, what are the key questions a person might ask about preparing for a job interview?”

Step 2: Question Structuring

To provide a structured set of questions, the prompt could be: “List the top 5 questions individuals usually ask when seeking advice on job interviews.”

Step 3: Answer Format

The engine specifies the desired format for the generated list:

“Provide the questions in the format of a numbered list.”

Step 4: Multi-Step Prompts (Optional)

After generating the list of questions, the Digital Coach Engine could follow up with another prompt to prepare answers:

“For each of the top 5 questions, provide well-structured answers that individuals can easily understand. Format these as a set of numbered Q&A pairs.”

Final Engine-Prompt to LLM:

“As a career coaching expert, list the top 5 questions individuals usually ask when seeking advice on job interviews. Provide the questions in the format of a numbered list. Then, for each question, provide well-structured answers that individuals can easily understand. Format these as a set of numbered Q&A pairs.”

Using a prompt engineered in this fashion, the LLM would then generate a list of questions and corresponding answers based on this refined prompt. This prepared content would serve as a basis for the upcoming digital coaching session, ensuring that the Digital Coach is well-equipped to address common queries from the user.

A prompt schema created in prompt engineering may include contextual examples within the prompt to assist the language model in generation of content (a “few-shot” approach). The contextual examples may include the resource, or a portion of the resource, for which a question/answer is to be generated. Other contextual examples may be validated questions, and/or answers, including validated question-answer pairs in the database. The validated questions and answers may be provided alongside the related resource as part of the contextual information. Different groups or types of resource/questions/answers that are provided as part of the few-shot approach can be selected to be part of the prompt schema validation. For example, the prompt schema may specify that content (e.g. resources/questions/answers) at the same proficiency level as the content to be generated should be provided with the prompt. Additionally or alternatively, the selected content may be content for topics within the same learning pathway, for specific topics, for the same topic, or for content related to the same skill entity. Validating the prompt schemas may include validation of the particular resources, questions and/or answers that may be used for inclusion within the prompt, and/or validation of groups of resources, questions and/or answers. Using few-shot methods to guide the language model are more computationally efficient than a fine-tuning approach (e.g. in which a pre-trained LLM is selectively trained on a specific task to adjust weights in a targeted manner)

In some embodiments, said prompt schemas are determined by the dialogue system 100 through interaction with users, such as via the content creation/validation module 130B. In these embodiments, the content generation module 130D is also configured to create prompt schemas/prompt templates. The process for creating questions follows the same steps as the process for creating resources, as illustrated in FIG. 7. In some embodiments, the process for creating a schema may be initiated upon creation of a new question, a new topic or a new resource. Alternatively, the process may be initiated by a user or a contributor upon request. The process may also be initiated by the digital coach module 130A during execution of a coaching session in reply to a user question or user input.

At step 704, the process comprises generating 704A a schema by either prompting the LLM interface (for example, using module 130B) or generating 704B the schema by contributors to the system, and inserted into the database 706. Answers created by contributors may also be provided to the LLM query system 110 as part of the prompt to request an answer to the question. Each generated schema is stored in a prompt schema database, which may form part of database 706. The generated schema may be stored with an identifier indicating that it is associated to a particular skill or topic. In a manner similar to the resource creation, the content generation module 130D may be configured to perform version control for the generated schemas, in which validators are queried to validate newly added schema. The version control process comprises step 708, in which an event is sent from the content generation module 130D to other components of the dialogue system 100 and to external devices of validators 710A as a notification that a new schema has been created and added to the system.

As also described above in connection with resource generation, contributors 710A may be invited to make modifications to the newly created schema (or any other schema present in the database). Step 708 may further comprise sending an event to the external devices of registered contributors of the dialogue system 100. Contributors can edit the schema by adding a new schema version to the system. This version may also be assessed by validators in a process as described above. There can be multiple versions of the same schema, each with a certain amount of “votes”. For each schema, the highest voted version is the “official” one and is used in prompt preparation.

As described above, during a digital coaching session, the digital coach module 130 is configured to converse with the user via a chat interface, in which the user is able to input answers to questions provided by the digital coach module 130, and is also able to pose questions to the digital coach module 130. As described above, during the resource generation process of FIG. 7, a vector embedding is calculated for each resource and stored in a vector database of the resource database 706. These vector embeddings may be queried during a coaching session to identify resources for the coaching session in a free-form knowledge retrieval method, in response to a user posing a question to the digital coach module 130.

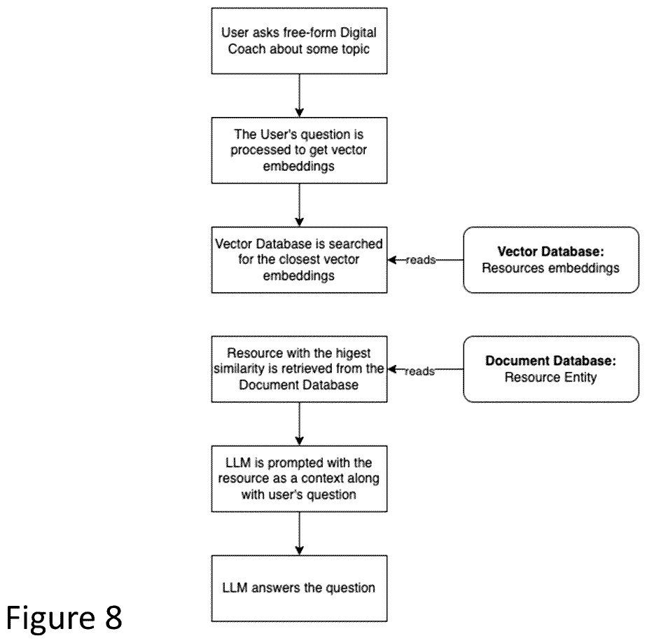

Free-form knowledge retrieval is useful when a user asks a question without a particular context, so the huge knowledge database has to be searched. For many user questions, the LLM itself knows the answer. However, the LLM answer may not be an answer validated by the system, so the answer may be vulnerable to hallucinations. It is therefore preferable to generate an answer using resources that have been validated by validators of the system. For every resource, a vector embedding is calculated and inserted into the Vector Database along with a link to a document in the Document Database. When the user provides the question, a similarity search is executed and documents with the highest similarity are retrieved. They are included in the LLM prompt and used as a context for generated answers. An example free-form knowledge retrieval method is shown in FIG. 8.

As shown in FIG. 8, the process begins with a user asking a question regarding a topic. For example, the user may ask a question to the dialogue system 100 via the input. The question of the user is then processed to generate vector embeddings (this may be done by generating a request for the LM interface 140, which forwards a prompt to the LLM system 155). The digital coach module 130A may then search the vector embeddings stored in the vector database of the resource database 706 for a vector embedding that has the highest similarity to the embeddings of the question of the user. Once the vector embedding that has the highest degree of similarity is found, the resource from which the vector embedding was generated can be retrieved. This resource may then be presented to the user via the output. The digital coach module 130 may also generate a language model request for the LLM query module, the request comprising a prompt including question of the user, a request for an answer to the question and the resource retrieved from comparing the vector embedding as context.

This technique may be called Retrieval Augmented Generation (RAG), which is an LLM technique that combines information retrieval and language generation. It addresses the limitations of traditional language models by using a retrieval component, allowing them to access and utilize external knowledge sources during the generation process. RAG employs a two-step approach: first, it retrieves relevant information or context from a large knowledge base (the vector database and document database) using a retrieval model, and then it generates coherent and context-aware responses using a language generation model. By leveraging external knowledge, RAG enhances the quality and accuracy of the generated text, enabling it to provide more informed and contextually relevant responses in a wide range of applications such as chatbots, question answering systems, and content generation platforms.

RAG is thus able to combine external knowledge source (like topic resources) with LLM responses. From this perspective, the term “teaching LLM” or “coaching the digital coach” is a metaphor, where there is no internal intervention on the LLM. In this case the knowledge is gathered in a document database and supplied to the LLM as needed using context derived from the topic or similarity search. It can be compared to having a huge, well-indexed library at hand, rather than memorizing every book. It also ensures privacy as “the library” is private and only used for the knowledge retrieval step. RAG may be provided as a beneficial alternative to other methods of “teaching the LLM” such as fine-tuning a pre-trained LLM, which requires large amounts of data. Furthermore, the purpose of fine-tuning is different—it is used for altering the logic and of a particular LLM responses. For example, fine-tuning can be used to train LLM to evaluate answers proficiency following some exact protocol, which would make LLM specialized in this particular task on a large examples dataset. Thus, RAG allows for a greater degree of flexibility in LLM queries, since the same, pre-trained LLM can be used for multiple specialised queries (instead of having to fine-tune an LLM for each question context).

The embodiments described above include the execution of a digital coaching session based on questions, resources and answers that are stored in a database and retrieved during the digital coaching session. To provide accuracy and reliability of the stored questions, resources and answers, each is validated in a validation process as described above.

By using a language model to generate the content for use in the digital coaching session, the dialogue system may be more flexible, simpler and quicker to use. Greater flexibility may be provided in the range of questions and resources that may be presented to the user as part of the coaching session. The dialogue system 100 is furthermore not limited to the specific content already stored in the database, allowing for extended digital coaching sessions or for variety in questions and resources. In addition, existing questions may be rephrased, allowing for variation in the experience of the user.

As mentioned above, during the resource generation process of FIG. 7, a vector embedding is calculated for each resource and stored in a vector database of the resource database 706. However, large language models have a finite context window, which dictates the maximum input characters or tokens that can be included within a prompt. For example, GPT-3.5-turbo has a context window of 4,000 tokens, whereas the enhanced GPT-3.5-turbo-16k extends it to 16,000 tokens. The latest model, GPT-4, provides a larger context window of up to 40,000 tokens.

Some resources (e.g. lengthy PDFs spanning multiple pages) can surpass the token limit in the context window, meaning the entire document cannot be included within a prompt to request embedding generation. To address this, the resource (e.g. base resource) can be partitioned into N chunks, ensuring that each chunk contains fewer tokens than the context window size of the LLM 155 deployed within the dialogue system 100. This process entails taking the entire document text (e.g. the entire base resource), segmenting it into fixed-sized chunks, and confirming that each chunk is smaller than the LLM's context window size. As a result, each N chunk aligns with the model's window size. Subsequently, vector embeddings are generated for these N chunks using OpenAI embeddings and store these embeddings for subsequent processing.

After creating the vector embeddings, the embeddings are stored for later retrieval when responding to runtime queries as described above. For example ChromaDB is integrated as a data store, and acts as the platform through which data can be effectively searched and retrieved from the vector store.

Upon setting up a vector store, an index of embeddings is established. This addresses the situation where multiple documents encompass pertinent text, and the possibility of numerous relevant answers to a given question arises. Thus, in some embodiments, rather than directly reading the embeddings during runtime, the index is instead queried.

To retrieve the document from the stored embeddings, various techniques may be deployed:
Similarity score threshold retrieval

As described above, a retrieval method may be used that computes similarity scores between the user query and the embeddings in the vector store. The retrieval method defines a threshold for similarity scores, meaning that only documents surpassing this threshold are returned.
Maximum Marginal Relevance (mmr)

In one alternative, the MaxMarginalRelevanceExampleSelector selects resources by evaluating their embeddings' similarity to the inputs while also aiming to enhance diversity. This process entails identifying resources whose embeddings demonstrate the highest cosine similarity to the inputs. Following this, the resources are added iteratively. In some embodiments, each resource with a high cosine similarity is compared to resources that have already been picked with a further similarity measurement. Newly identified resources that demonstrate a high degree of similarity with resources that have already been chosen (e.g. above a threshold value) are not added. This strikes a balance between similarity and diversity in the selection process. mmr is available in langchain library.
Specifying top k

In another alternative, we can also set search parameters, including specifying the value of k, to be applied during retrieval (where k is the number of most relevant items to be retrieved). This ensures that when retrieving from our indexed vector store, the top K chunks are chosen. Top k ensures that only the k closest resources to the search query are chosen.
ContextualCompressionRetriever

In some examples, there may be a degree of uncertainty of the specific queries that the document storage system will encounter during data ingestion. This suggests that relevant information for a query may be embedded within a document containing substantial irrelevant text. Processing such entire documents in your application can lead to more expensive calls to large language models (LLMs) and less optimal responses.

In some embodiments, contextual compression is applied to address this. In contextual compression, instead of directly presenting retrieved documents, the documents can be compressed using the context of the given query, ensuring that only relevant information is returned. In this context, “compressing” involves both reducing the content within individual documents and filtering out entire documents.

The contextual Compression Retriever comprises a base retriever and a Document Compressor. The Contextual Compression Retriever directs queries to the base retriever, processes the initial documents, and then utilises the Document Compressor.

The Document Compressor, in turn, analyses the documents and trims down the list of documents by either condensing the content within documents or excluding specific documents entirely. By summarizing content and filtering out irrelevant documents entirely, the system delivers only the most relevant information, making answers more concise and efficient. The package ContextualCompressionRetriever is available under langchain library
Conversation Buffer Window

As described above, a record may be kept of the most recent interactions between the user and the LM 155. The buffer maintains a record of the conversation interactions over time, utilising only the most recent K interactions. K may be adjusted to a given size that prevents the buffer from becoming excessively large, but long enough to maintain a dynamic window of the latest interactions. By reducing K, the number of embeddings that may be provided in a user query is reduced, thereby providing more targeted resources for the most recent queries of the user.

The one or more task modules 170 may comprise a feedback module 170D. The feedback module is configured to generate feedback to the user to update the user on their progress. The feedback may be provided at any stage (such as at the conclusion of a skill estimation process), or may be requested by the user via the interface 110. For example, the feedback may include the results of the on-going learning performed by the user 102. For example, the dialogue system 100 is configured to generate feedback as a result of the skill assessment performed by the skill assessment module 120. This may be, for example, an answer accuracy score for the assessment questions that have been answered by the user, or a skill proficiency score calculated by the skill assessment module 120. The feedback may also include text generated in a human-like form, giving written feedback on the answer of the user. In this example, the feedback module 170D may submit a request to the LM interface 140 to generate feedback text. To generate the feedback text, the prompt generation module 145 generates a prompt including the information to be fed back to the user and a request to generate text for output to the user.

The feedback can also include any text generated by the LLM 155 during a digital coaching session to guide the user on improved answers to assessment questions or for areas of study in a subsequent digital coaching session. The feedback may also include one or more progress bars updated in real-time, the progress bars indicating the updated user skill proficiency level, the total progress the user has made through the available questions of the topic and/or skill, and accuracy scores for each topic. The feedback may also include the display of a resource related to the question to assist the user in improving their knowledge. The feedback may include an elaborative review and a repeat display of the resource that was presented to the user that was relevant to a question that the user answered incorrectly during an assessment.

Feedback that may be provided to the user can include recommendations, such as identifying areas of strength and development, suggesting personalised study plans, offering motivational feedback, and highlighting achievements. These insights are presented to the user in a concise and straightforward manner, allowing them to grasp key takeaways from the session. Users can easily understand their strengths, areas for improvement, and receive concise recommendations on how to enhance their skills. In instances where a user may feel demotivated, the digital coach 130, via the feedback module 170D, can provide motivational feedback, emphasising both areas for improvement and shining strengths, keeping the user motivated and informed about their performance.

An example use case for the dialogue system 100 is described below, in relation to assessment of a user's skill in “data analysis”.

Initially, the skill assessment module 120 estimates the examinee's data analytics ability, starting at a mid-level or using prior data (like past scores or demographic information) to set a more informed starting point. The examinee receives a question matched to their estimated ability. For instance, they answer a medium-difficulty data analytics question correctly. The system, utilizing Bayesian methods, updates the ability estimate, suggesting a higher skill level.

The next question is slightly more challenging, aligning with the updated skill estimate. If the examinee continues to perform well, the system further adjusts its estimation, now leaning towards a high proficiency in programming. The process iterates, with each response refining the ability to estimate. If the examinee encounters difficulties, the system adapts, presenting less challenging questions until it finds the appropriate difficulty level that reveals the most about the examinee's true skills.

Once the assessment concludes, it meets predetermined criteria, like a set number of questions or a specific confidence level in the ability estimate, ensuring a precise and personalized assessment of the examinee's data analytics skills.

Once an initial assessment is performed, the test taker then enters into as knowledge personalization phase of skill estimation. Bayesian Knowledge Tracing (BKT) tracks the learner's mastery over time by predicting individual learning behaviours during ongoing use of the dialogue system 100. BKT will enable predictions on whether a learner already possesses a skill if they will acquire a skill in their next practice, if they might correctly answer questions without knowing the skill, and if they might err despite having the knowledge. Essentially, BKT will continuously monitor a learner's performance to forecast their future task performance, tailoring learning experiences to their changing knowledge state.

For instance, if the assessment scores report reveals proficiency in basic data analytics concepts but struggles in advanced areas, BKT continuously monitors the learner's progress in these advanced topics during coaching sessions. Each interaction updates the learner's mastery probability, enabling the digital coach to tailor future content and exercises, ensuring the learner receives focused guidance on areas needing improvement, additional support, or instructions.

Furthermore, the solution also predicts whether a user will learn a new skill in their next practice session. This will act as an additional support factor and enable the creation of individualized learning plans based on the user's unique needs and abilities. This approach allows for a more dynamic and responsive coaching experience, adapting to the learner's evolving understanding and skill acquisition.

To ensure the high quality and relevance of test items and learning materials generated through advanced prompt engineering techniques, the dialogue system 100 may engage a diverse group of Subject Matter Experts (SMEs) in a streamlined validation process, as described above. These experts will anonymously review and refine test items and learning materials for accuracy, clarity, and cultural sensitivity, ensuring alignment with learner skill levels and objectives. This iterative feedback process, combined with assessments of item difficulty and cultural relevance, guarantees that the final test assessment meets the highest standards of fairness and educational value.

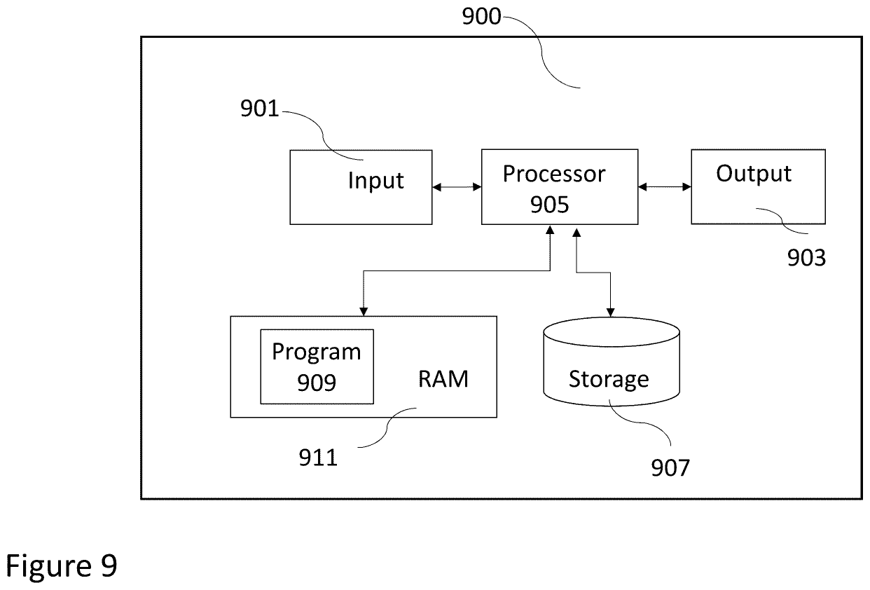

FIG. 9 is a schematic illustration of a dialogue system 900 in accordance with an embodiment. The system 900 comprises an input 901, a processor 905, working memory comprising RAM 911, an output 903, and non-volatile storage 907.

In this example, the system 900 is a server device. The system 900 receives an input originating from another device (e.g. user device). The input includes information as previously described (e.g. text information). The information is received at the input 901 of the system 900. The input 901 is a receiver for receiving input data (for example speech or text data) from a user. In particular, the receiver receives data from a communication network, such as the Internet, where the data is sent from a user device to the server via the communication network.

The processor 905 accesses the input module 901. The processor 905 is coupled to the storage 907 and also accesses the working memory 911. The processor 905 may comprise logic circuitry that responds to and processes the instructions in code stored in the working memory 911. In particular, when executed, a program 909 is represented as a software product stored in the working memory 911. Execution of the program 909 by the processor 905 causes embodiments as described herein to be implemented. In this way, implementations of the embodiments described herein can be realized using one or more modules of computer program instructions. In particular, the program 909 may comprise computer program code 85 implementing the functionality of various functional components of the dialogue system described above, such as the digital coach and the LM query module for example. In particular, the program 909 may comprise computer program code 85 implementing the steps of the method of FIG. 2A or 2B performed on the dialogue system.

The processor 905 is also configured to communicate with the non-volatile storage 907. As illustrated, the storage 907 is local memory that is contained in the system 900. Alternatively however, the storage 907 may be wholly or partly located remotely from the system 900, for example, using cloud based memory that can be accessed remotely via a communication network such as the Internet. The program 909 is stored in the storage 907. The program 909 is placed in working memory when executed.

The processor 905 also accesses the output module 903. The output module 903 provides a response generated by the processor 905 to a communication network such as the Internet. The output module 903 outputs output data (for example, speech or text data) to a user device via the communication network.

The input and output modules 901, 903 may be a single component or may be divided into a separate input interface 901 and a separate output interface 903.

As illustrated, the system 900 comprises a single processor. However, the program 909 may be executed across multiple processing components, which may be located remotely, for example, using cloud based processing. For example, the system 900 may comprise at least one graphical processing unit (GPU) and a general central processing unit (CPU), where various operations described in relation to the methods above are implemented by the GPU, and other operations are implemented by the CPU.

As described above, the system 900 is a service device. However, in other examples, the system may be an end-user device such as a personal computer or mobile device. In this case, the input 901 may comprise a microphone, keyboard or touchscreen for example. The output 903 may comprise a speaker or display.

The processor 905 may be configured to perform the above-described operations for each of the systems, components and modules described above. Alternatively, the module functionalities may be divided between a subset of processors. These processors may form part of a multi-processor unit within one system, such as system 900, or may be distributed across multiple systems.

Usual procedures for the loading of software into memory and the storage of data in the storage unit 907 apply. In particular, the program 909 can be embedded in original equipment, or can be provided, as a whole or in part, after manufacture. For instance, the program 909 can be introduced, as a whole, as a computer program product, which may be in the form of a download, or can be introduced via a computer program storage medium, such as an optical disk. Alternatively, modifications to existing software can be made by an update, or plug-in, to provide features of the described embodiments.

In the above described example, the system 900 comprises a server device which receives input originating from a user device. However, alternatively, the dialogue system 900 may be an end-user computer device, such as a laptop, tablet, smartwatch, or smartphone. The output module 903 provides the response generated by the processor 905 to an output such as a speaker or a screen. The output may comprise an audible message that is played on a speaker, or a message that is displayed to the user on a screen. It will also be appreciated that in some the examples, parts of the program 909 may be executed on a user device whilst other parts of the program may be executed on a server device, with data being transmitted between the two devices.

While it will be appreciated that the embodiments described herein could be implemented using any computing system, the example dialogue system 900 illustrated in FIG. 9 provides means capable of putting an embodiment, as described herein, into effect. In use, the dialogue system 900 receives, by way of input 901, an input file. The program 909, executed on processor 905, performs a method and provides an output in the manner described with reference to the above figures. The system 900 outputs data by way of the output 903.

While certain embodiments have been described, these embodiments have been presented by way of example only and are not intended to limit the scope of the invention. Indeed, the novel methods, devices and systems described herein may be embodied in a variety of forms; furthermore, various omissions, substitutions and changes in the form of the methods and systems described herein may be made without departing from the scope of the invention as claimed.

1. A dialogue system, comprising:
an input, configured to receive input data from a user, wherein the input data comprises one or more of text data, speech data, image data and motion data;
an output, configured to output data to the user; and
one or more processors, configured to:
obtain information identifying a skill and obtain information identifying a proficiency level of the user for the identified skill from stored proficiency level information; and
execute at least one iteration of a coaching session, each iteration comprising performing one or more dialogue interactions, wherein each dialogue interaction comprises:
receiving first input data from the user via the input;
generating a first language model prompt and providing the first language model prompt to a language model, said first language model prompt comprising the first input data, the information identifying a skill, the information identifying a proficiency level of the user for the identified skill and a request to generate coaching information based on the first input data, the information identifying a skill and the information identifying a proficiency level; and
generating first output data based on a first language model response to the first language model prompt and outputting, via the output, the first output data to the user;
wherein the at least one iteration of the coaching session further comprises, after the one or more dialogue interactions:
generating a second language model prompt and providing the second language model prompt to the language model, said second language model prompt comprising the information identifying a skill, the information identifying a proficiency level of the user for the identified skill, the first input data and the first output data, and a request to generate at least one proficiency update assessment based on the first input data, the first output data, the identified skill and the information identifying a proficiency level;
generating second output data based on a second language model response to the second language model prompt and outputting, via the output, the second output data to the user;
receiving second input data from the user via the input;
determining a revised proficiency level of the user for the identified skill based on the second input data; and
updating the stored proficiency level information based on the revised proficiency level.

2. The dialogue system of claim 1, wherein the at least one proficiency update assessment includes at least one proficiency update question and a template response for each proficiency update question, and wherein determining the revised proficiency level of the user comprises analysing the second input data, the analysing comprising:
determining, from the second input data, a user response to each proficiency update question; and
performing a similarity measurement between the user response to each proficiency update question and the template response for the respective proficiency update question.

3. The dialogue system of claim 2, wherein performing the similarity measurement comprises generating a third language model prompt and providing the third language model prompt to a language model, the third language model prompt comprising the user response to a proficiency update question, the template response for the proficiency update question and a request that a similarity measurement be performed for the user response and the template response.

4. The dialogue system of claim 2, wherein the determining the revised proficiency level of the user is based on a current proficiency level of the user and a skill proficiency update model, wherein one or more parameters of the skill proficiency update model are determined based on the result of the similarity measurement.

5. The dialogue system of claim 1, wherein the at least one proficiency update assessment includes at least one proficiency update question and a template response for each proficiency update question;
wherein the determining the revised proficiency level of the user comprises analysing the second input data, the analysing comprising determining, from the second input data, a user response to each proficiency update question; and
wherein the determining the revised proficiency level of the user comprises applying a skill proficiency update model based on a current proficiency level of the user, at least one user response to a respective proficiency update question, and one or more parameters of the skill proficiency update model.

6. The dialogue system of claim 5, wherein the one or more parameters of the skill proficiency update model are identified from a stored user information record.

7. The dialogue system of claim 5, wherein the skill proficiency update model is a Bayesian Knowledge Tracing model and wherein the one or more parameters are Bayesian Knowledge Tracing model parameters.

8. The dialogue system of claim 7, wherein the one or more processors are further configured to:
perform a similarity measurement between the user response to each proficiency update question and a template response for the respective proficiency update question; and
adjust the one or more parameters of the Bayesian Knowledge Tracing model based on the result of the similarity measurement.

9. The dialogue system of claim 1, wherein the second language model prompt further comprises a request to generate at least one template response for each proficiency update question
wherein the determining a revised proficiency level of the user comprises analysing the second input data, the analysing comprising generating a fourth language model prompt and providing the fourth language model prompt to the language model, the fourth language model prompt including the information identifying a proficiency level of the user for the identified skill, the second input data, a definition of a statistical model including parameters of the statistical model, and a request to generate a revised proficiency level based on the second input data and the statistical model.

10. The dialogue system of claim 1, wherein obtaining the information identifying a proficiency level of the user from stored proficiency level information comprises performing one or more testing processes, wherein each testing process comprises:
identifying a current proficiency level of the user from the stored proficiency level information, wherein the stored proficiency level information is stored in a database;
selecting one or more questions from a plurality of questions stored in the database based on the information identifying a skill and the current proficiency level;
outputting, via the output, the one or more questions to the user;
receiving, via the input, a response to the one or more questions from the user;
analysing the response to determine an updated proficiency level of the user;
updating the stored proficiency level information based on the updated proficiency level; and
obtaining the information identifying a proficiency level of the user for the identified skill from the updated stored proficiency level information.

11. The dialogue system of claim 10, wherein the analysing the response to determine an updated proficiency level of the user comprises performing Bayesian inference to determine an updated proficiency of the user based on an initial probability distribution for the proficiency of the user and a probability of the user providing the response to the one or more questions, wherein the probability of the user providing the response one or more questions is modelled as a logistic function of the probability of the user having a skill proficiency level providing a response that corresponding to a template response to the one or more questions, the template response being stored in the database.

12. The dialogue system of claim 10, wherein the analysing of the response to determine an updated proficiency level of the user comprises applying Bayesian Knowledge Tracing to the current proficiency level determine the updated user proficiency level.

13. The dialogue system of claim 1, wherein the coaching session further comprises outputting one or more resources to the user during the coaching session.

14. The dialogue system of claim 1, wherein the first language model prompt further comprises a text resource for the identified skill and a request that the coaching information be based on the resource.

15. The dialogue system of claim 14, wherein a dialogue interaction further comprises generating vector embeddings from the first input data;
performing a similarity measurement between the vector embeddings and each of a plurality of stored vector embeddings, wherein each stored vector embedding corresponds to a resource;
selecting a stored vector embedding based on the similarity score and retrieving the resource corresponding to the selected stored vector embedding, wherein the retrieved resource is the text resource.

16. The dialogue system of claim 13, wherein the one or more processors are further configured to:
generate a fifth language model prompt and provide the fifth language model prompt to the language model, the fifth language model prompt including a request that the one or more resources be generated; create the one or more resources from a fifth language model response to the fifth language model prompt and storing the one or more resources in a database.

17. The dialogue system of claim 16, wherein the one more processors are further configured to determine, from the stored proficiency level information, whether the proficiency level of the user meets a first criterion, and, responsive to determining that the proficiency level of the user meets the first criterion:
output an notification to the user that the resource has been generated;
receive from the user an updated version of the resource; and
store the updated resource in the database.

18. The dialogue system of claim 13, wherein the one more processors are further configured to determine, from the stored proficiency level information, whether the proficiency level of the user meets a second criterion, and, responsive to determining that the user proficiency level of the user meets the second criterion:
output a notification that the resource has been generated; and
receive, from the user, validation information for the resource.

19. The dialogue system of claim 18, wherein the one more processors are further configured to:
calculate a validation score from validation information received from the user and one or more other users; and
in response to the validation score meeting a validation criterion, authorising the at least one resource for use in a coaching session.

20. A computer-implemented dialogue method, the method comprising:
obtaining information identifying a skill and obtain information identifying a proficiency level of the user for the identified skill from stored proficiency level information; and
executing at least one iteration of a coaching session, each iteration comprising performing one or more dialogue interactions, wherein each dialogue interaction comprises:
receiving first input data from the user via an input, wherein the input data comprises one or more of text data, speech data, image data and motion data;
generating a first language model prompt and providing the first language model prompt to a language model, said first language model prompt comprising the first input data, the information identifying a skill, the information identifying a proficiency level of the user for the identified skill and a request to generate coaching information based on the first input data, the information identifying a skill and the information identifying a proficiency level; and
generating first output data based on a first language model response to the first language model prompt and outputting, via an output, the first output data to the user;
wherein the at least one iteration of the coaching session further comprises, after the one or more dialogue interactions:
generating a second language model prompt and providing the second language model prompt to the language model, said second language model prompt comprising the information identifying a skill, the information identifying a proficiency level of the user for the identified skill, the first input data and the first output data, and a request to generate at least one proficiency update assessment based on the first input data, the first output data, the identified skill and the information identifying a proficiency level;
generating second output data based on a second language model response to the second language model prompt and outputting, via the output, the second output data to the user;
receiving second input data from the user via the input;
determining a revised proficiency level of the user for the identified skill based on the second input data; and
updating the stored proficiency level information based on the revised proficiency level.

21. A computer program comprising instructions that, when executed by one or more processors, cause the one or more processors to perform the method of claim 20.

22. A non-transitory computer readable storage medium comprising computer readable code configured to cause a computer to perform the method of claim 20.
